(19) United States
(12) Patent Application Publication
(10) Pub. No.: US 2016/0205409 A1
(43) Pub. Date: Jul. 14, 2016

(54) SCREEN IMAGE ENCODING METHOD AND APPARATUS THEREFOR, AND SCREEN IMAGE DECODING METHOD AND APPARATUS THEREFOR

(71) Applicant: SAMSUNG ELECTRONICS CO., LTD., Suwon-si, Gyeonggi-do (KR)

(72) Inventors: Min-woo PARK, Yongin-si (KR); Dae-hee KIM, Suwon-si (KR); Sung-bum PARK, Seongnam-si (KR); Pil-kyu PARK, Seongnam-si (KR); Jae-won YOON, Seoul (KR); Dai-woong CHOI, Seoul (KR); Dae-sung CHO, Seoul (KR)

(73) Assignee: SAMSUNG ELECTRONICS CO., LTD., Suwon-si (KR)

(21) Appl. No.: 14/916,794

(22) PCT Filed: Sep. 4, 2014
(86) PCT No.: PCT/KR2014/008347

§ 371 Date: Mar. 4, 2016

Related U.S. Application Data
(60) Provisional application No. 61/873,499, filed on Sep. 4, 2013.

(51) Int. Cl. H04N 19/503; H04N 19/105; H04N 19/44; H04N 19/176

(52) U.S. Cl. CPC H04N 19/503; H04N 19/176; H04N 19/105; H04N 19/44

(57) ABSTRACT

A screen image encoding method includes: obtaining and storing one or more candidate blocks, which are spatially co-located with a current block, from images encoded prior to a current image; determining whether a reference block used to encode the current block exists in the stored one or more candidate blocks; and encoding at least one of index information indicating the reference block, prediction information used to encode the current block from the reference block, and information about the current block, based on a result of the determining.

### TECHNICAL FIELD

The present invention relates to a method of encoding or decoding a screen image.

### BACKGROUND ART

As hardware for reproducing and storing high resolution or high quality video content is being developed and supplied, a need for a video codec for effectively encoding or decoding the high resolution or high quality video content is increasing. According to a conventional video codec, a video is encoded according to a limited encoding method based on a macro block with a predetermined size.

A video codec reduces a data amount using a prediction technique using a feature that video images have high correlativity in terms of time or space. According to the prediction technique, in order to predict a current image using a surrounding image, image information is recorded using a temporal distance or a spatial distance between images, a prediction error, etc.

### DETAILED DESCRIPTION OF THE INVENTION

### Technical Problem

A method of efficiently encoding or decoding a screen image may be provided.

### Technical Solution

A screen image encoding method according to various embodiments of the present invention may include: obtaining and storing one or more candidate blocks, which are spatially co-located with a current block, from images encoded prior to a current image; determining whether a reference block used to encode the current block exists in the stored one or more candidate blocks; and encoding at least one of index information indicating the reference block, prediction information used to encode the current block from the reference block, and information about the current block, based on a result of the determining.

### Advantageous Effects of the Invention

A method and apparatus for efficiently encoding or decoding a screen image may be provided.

### DESCRIPTION OF THE DRAWINGS

FIG. 1A is a block diagram of an image encoding apparatus for encoding a screen image according to an embodiment.

FIG. 1B is a block diagram of an encoder for encoding a screen image according to an embodiment.

FIG. 1C is a flowchart of a method of encoding a screen image according to an embodiment.

FIG. 2A is a block diagram of an image decoding apparatus for decoding a screen image according to an embodiment.

FIG. 2B is a block diagram of a decoder for decoding a screen image according to an embodiment.

FIG. 2C is a flowchart of a method of decoding a screen image according to an embodiment.

FIG. 2D is a flowchart for explaining a method of updating a candidate block buffer according to an embodiment.

FIG. 3A is a view for explaining a method of encoding or decoding a screen image according to an embodiment.

FIG. 3B is a view for explaining a method of storing a candidate block according to an embodiment.

FIG. 3C is a view for explaining a method of storing a candidate block according to an embodiment.

FIG. 3D is a view for explaining a method of storing a candidate block according to an embodiment.

FIG. 3E is a view for explaining a method of storing a candidate block according to an embodiment.

FIG. 4A is a block diagram of an image encoding apparatus for encoding a screen image according to an embodiment.

FIG. 4B is a block diagram of the image encoding apparatus for encoding a screen image according to another embodiment.

FIG. 4C is a flowchart of a method of encoding a screen image according to an embodiment.

FIG. 4D is a block diagram of an image decoding apparatus for decoding a screen image according to an embodiment.

FIG. 4E is a block diagram of the image decoding apparatus for decoding a screen image according to another embodiment.

FIG. 4F is a flowchart of a method of decoding a screen image according to an embodiment.

FIG. 5A is a view for explaining a screen image according to an embodiment.

FIG. 5B is a view for explaining an image showing a program that is being executed according to an embodiment.

FIG. 5C is a view for explaining a screen image according to an embodiment.

FIG. 5D is a view for explaining a screen image according to an embodiment.

FIG. 5E is a view for explaining an extraction image of an area that is displayed on a screen image from among all areas of an execution image according to an embodiment.

FIG. 5F is a view for explaining an extraction image of an area that is displayed on a screen image from among all areas of an execution image according to an embodiment.

FIG. 5G is a view for explaining a method of forming an entire screen image by using an extraction image of an area that is displayed on the screen image from among all areas of an execution image according to an embodiment.

FIG. 6A is a block diagram of an image encoding apparatus for encoding a screen image according to an embodiment.

FIG. 6B is a flowchart of a method of encoding a screen image according to an embodiment.

FIG. 6C is a block diagram of an image decoding apparatus for decoding a screen image according to an embodiment.

FIG. 6D is a flowchart of a method of decoding a screen image according to an embodiment.

FIG. 7A is a flowchart of a method of encoding a screen image according to an embodiment.

FIG. 7B is a flowchart of a method of decoding a screen image according to an embodiment.

FIG. 7C is a diagram for explaining a method of determining a method of encoding a screen image according to an embodiment.

FIG. 7D is a diagram for explaining a method of encoding a screen image according to an embodiment.

FIG. 8 is a block diagram of a video encoding apparatus based on coding units according to a tree structure according to an embodiment.

FIG. 9 is a block diagram of a video decoding apparatus based on coding units according to a tree structure according to an embodiment.

FIG. 10 is a diagram for explaining a concept of coding units according to an embodiment of the present invention.

FIG. 11 is a block diagram of an image encoder based on coding units according to an embodiment of the present invention.

FIG. 12 is a block diagram of an image decoder based on coding units according to an embodiment of the present invention.

FIG. 13 is a diagram illustrating deeper coding units according to depths and partitions according to an embodiment of the present invention.

FIG. 14 is a diagram for explaining a relationship between a coding unit and transformation units according to an embodiment of the present invention.

FIG. 15 is a diagram for explaining encoding information of coding units corresponding to a depth according to an embodiment of the present invention.

FIG. 16 is a diagram of deeper coding units according to depths according to an embodiment of the present invention.

FIGS. 17, 18, and 19 are diagrams for explaining a relationship between coding units, prediction units, and transformation units according to an embodiment of the present invention.

FIG. 20 is a diagram for explaining a relationship between a coding unit, a prediction unit, and a transformation unit, according to encoding mode information of Table 1.

FIG. 21 is a diagram of a physical structure of a disc in which a program is stored according to an embodiment.

FIG. 22 is a diagram of a disc drive for recording and reading a program by using a disc.

FIG. 23 is a diagram of an overall structure of a content supply system for providing a content distribution service.

FIGS. 24 and 25 are diagrams respectively of an external structure and an internal structure of a mobile phone to which a video encoding method and a video decoding method of the present invention are applied according to an embodiment of the present invention.

FIG. 26 is a diagram of a digital broadcast system to which a communication system is applied according to the present invention.

FIG. 27 is a diagram illustrating a network structure of a cloud computing system using a video encoding apparatus and a video decoding apparatus according to an embodiment of the present invention.

### BEST MODE

The present invention provides a method of encoding or decoding a screen image.

A screen image encoding method according to various embodiments of the present invention may include: obtaining and storing one or more candidate blocks, which are spatially co-located with a current block, from images encoded prior to a current image; determining whether a reference block used to encode the current block exists in the stored one or more candidate blocks; and encoding at least one of index information indicating the reference block, prediction information used to encode the current block from the reference block, and information about the current block, based on a result of the determining.

Also, the encoding may include, when a substitute candidate block that is the same as the current block exists in the stored one or more candidate blocks, omitting the encoding of the information about the current block and encoding index information indicating the substitute candidate block.

Also, the encoding may include: when the reference block used to encode the current block exists in the stored one or more candidate blocks, encoding the index information indicating the reference block; and encoding the prediction information used to decode the current block from the reference block.

Also, the encoding may include, when the reference block used to encode the current block does not exist in the stored one or more candidate blocks, encoding the information about the current block.

Also, the determining whether the reference block exists may include: determining a candidate block representative value of each of the one or more candidate blocks based on a pixel value included in the candidate block; determining a current block representative value of the current block based on a pixel value included in the current block; and when a difference between the candidate block representative value and the current block representative value is equal to or less than a preset critical value, determining the candidate block as the reference block.

Also, the determining whether the reference block exists may include: obtaining a sum of absolute difference (SAD) between each of the one or more candidate blocks and the candidate block and the current block; and determining a candidate block having a SAD that is equal to or less than a preset critical value as the reference block.

Also, the obtaining and storing of the one or more candidate blocks may include storing the obtained one or more candidate blocks in a candidate block buffer, wherein the screen image encoding method further includes, when a number of the candidate blocks stored in the candidate block buffer is equal to or greater than a preset number, deleting a candidate block determined by using a preset method from the candidate block buffer.

The deleting of the candidate block determined by using the preset method from the candidate block buffer may include, when a number of the candidate blocks stored in the candidate block buffer is equal to or greater than a preset number, deleting a candidate block corresponding to a pre-determined index from the candidate block buffer.

A screen image decoding method according to various embodiments of the present invention may include: obtaining and storing one or more candidate blocks, which are spatially co-located with a current block, from images encoded prior to a current image; receiving information about whether a reference block used to decode the current block exists in the stored one or more candidate blocks; and decoding the current block by using at least one of index information indicating the reference block, prediction information used to decode the current block from the reference block, and information about the current block, based on the received information.

Also, the decoding may include: when a substitute candidate block that is capable of being replaced with the current block exists in the stored one or more candidate blocks, omitting the decoding of the information about the current block and decoding index information indicating the substitute the candidate block; and decoding the current block by using the index information.

Also, the decoding may include: when the reference block used to decode the current block exists in the stored one or more candidate blocks, decoding the index information indicating the reference block; decoding the prediction information used to decode the current block from the reference block; and decoding the current block by using the index information and the prediction information.

Also, the decoding may include, when the reference block used to decode the current block does not exist in the stored one or more candidate blocks, obtaining the current block by decoding the information about the current block.

Also, the obtaining and storing of the one or more candidate blocks may include storing the obtained one or more candidate blocks in a candidate block buffer, wherein the screen image decoding method includes, when a number of the candidate blocks stored in the candidate block buffer is equal to or greater than a preset number, deleting a candidate block determined by using a preset method from the candidate block buffer.

Also, the deleting of the candidate block determined by using the preset method from the candidate block buffer may include, when a number of the candidate blocks stored in the candidate block buffer is equal to or greater than a preset number, deleting a candidate block corresponding to a pre-determined index from the candidate block buffer.

An image encoding apparatus according to various embodiments of the present invention may include: a candidate block buffer configured to store one or more candidate blocks, which are spatially co-located with a current block, from images encoded prior to a current image; and an encoder configured to determine whether a reference block used to encode the current block exists in the one or more candidate blocks and to encode at least one of index information indicating the reference block, prediction information used to encode the current block from the reference block, and information about the current block, based on a result of the determining.

An image decoding apparatus according to various embodiments of the present invention may include: a candidate block buffer configured to store one or more candidate blocks, which are spatially co-located with a current block, from images decoded prior to a current image; and a decoder configured to receive information about whether a reference block used to decode the current block exists in the one or more candidate blocks, and to decode the current block by using at least one of index information indicating the reference block, prediction information used to decode the current block from the reference block, and information about the current block, based on the received information.

A screen image encoding method according to various embodiments of the present invention may include: obtaining an execution image that is an image showing a program that is being executed; obtaining an extraction image of an area that is displayed on a screen image from among all areas of the execution image; and encoding the extraction image by using an encoding method corresponding to the extraction image.

Also, the obtaining of the extraction image may further include obtaining a non-extraction image that is an image of an external area of the extraction image and has a pixel value determined by using a preset method, and the encoding may include encoding the non-extraction image by using a preset method.

Also, the encoding of the non-extraction image by using the preset method may include encoding the non-extraction image by using an encoding method corresponding to the extraction image.

Also, the obtaining of the extraction image may include: obtaining instruction information for discriminating an area corresponding to the extraction image from an area corresponding to the non-extraction image on the screen image; and obtaining the extraction image and the non-extraction image from the screen image based on the instruction information.

Also, the instruction information may be information obtained for each pixel.

Also, the instruction information may be information obtained for each block with a preset size.

Also, the encoding may include: determining whether the execution image is for a still image; and encoding the extraction image by using an encoding method determined based on a result of the determining.

A screen image decoding method according to various embodiments of the present invention may include: obtaining information about an extraction image of an area that is displayed on a screen image from among all areas of an execution image that is an image showing a program that is being executed; and decoding the extraction image by using a decoding method corresponding to the extraction image.

Also, the obtaining of the information about the extraction image may further include obtaining information about a non-extraction image that is an image of an external area of the extraction image and has a pixel value determined by using a preset method, and the decoding may include decoding the information about the non-extraction image by using a preset method.

Also, the decoding of the information about the non-extraction image by using the preset method may include decoding the non-extraction image by using a decoding method corresponding to the extraction image.

Also, the obtaining of the information about the extraction image may include: obtaining instruction information for discriminating an area corresponding to the extraction image from an area corresponding to the non-extraction image on the screen image; and obtaining the extraction image and the non-extraction image based on the instruction information.

Also, the instruction information may be information obtained for each pixel.

Also, the instruction information may be information obtained for each block with a preset size.

Also, the decoding may include: determining whether the execution image is for a still image; and decoding the extraction image by using a decoding method determined based on a result of the determining.

A screen image encoding apparatus according to various embodiments of the present invention may include: an image obtainer configured to obtain an execution image that is an image showing a program that is being executed; and an encoder configured to obtain an extraction image of an area that is displayed on a screen image from among all areas of the execution image and to encode the extraction image by using an encoding method corresponding to the extraction image.

A screen image decoding apparatus according to various embodiments of the present invention may include: an image information obtainer configured to obtain information about an extraction information of an area that is displayed on a screen image from among all areas of an execution image that is an image showing a program that is being executed; and decoding the extraction image by using a decoding method corresponding to the extraction image.

A screen image encoding method according to various embodiments of the present invention may include: obtaining pixel value combinations including a plurality of pixel values used to display pixels from pixels included in a current block; obtaining an index table in which different indices correspond to the pixel value combinations; and obtaining an index map in which indices indicating pixel value combinations used to display the pixel correspond to the pixels.

Also, the screen image encoding method may further include obtaining reference pixel value combinations including a plurality of reference pixel values used to display a reference pixel from each of reference pixels included in a reference block encoded prior to the current block, and the index table may be obtained by using the pixel value combinations and the reference pixel value combinations.

Also, the screen image encoding method may further include encoding the index table and the index map.

Also, the screen image encoding method may be performed when encoding is performed by using a preset encoding method.

Also, the preset method may include at least one of a pulse code modulation (PCM) method and a lossless encoding method.

Also, the plurality of pixel values may include at least one of a red sample value, a green sample value, and a blue sample value of each of the pixels.

Also, the plurality of pixel values may include at least one of a luminance value and a chrominance value of each of the pixels.

A screen image decoding method according to various embodiments of the present invention may include: obtaining pixel value combinations including a plurality of pixel values used to display pixels from pixels included in a current block; obtaining an index table in which different indices correspond to the pixel value combinations; and obtaining an index map in which indices indicating pixel value combinations used to display the pixels correspond to the pixels.

Also, the screen image decoding method may further include obtaining reference pixel value combinations including a plurality of reference pixel values used to display a reference pixel from each of reference pixels included in a reference block decoded prior to the current block, and the index table may be obtained by using the pixel value combinations and the reference pixel value combinations.

Also, the screen image decoding method may further include decoding the index table and the index map.

Also, the screen image decoding method may be performed when decoding is performed by using a preset decoding method.

Also, the preset method may include a pulse code modulation (PCM) method and a lossless decoding method.

Also, the plurality of pixel values may include at least one of a red sample value, and a green sample value, and a blue sample value of each of the pixels.

Also, the plurality of pixel values may include at least one of a luminance value and a chrominance value of each of the pixels.

A screen image encoding apparatus according to various embodiments of the present invention may include: a pixel value combination obtainer configured to obtain pixel value combinations including a plurality of pixel values used to display pixels from pixels included in a current block; an index table obtainer configured to obtain an index table in which different indices correspond to the pixel value combinations; and an index map obtainer configured to obtain an index map in which indices indicating pixel value combinations used to display the pixel correspond to the pixels.

A screen image decoding apparatus according to various embodiments of the present invention may include: a pixel value combination obtainer configured to obtain pixel value combinations including a plurality of pixel values used to display pixels from pixels included in a current block; an index table obtainer configured to obtain an index table in which different indices correspond to the pixel value combinations; and an index map obtainer configured to obtain an index map in which indices indicating pixel value combinations used to display pixels corresponds to the pixels.

Provided is a computer-readable recording medium having embodied thereon a program for executing a screen image encoding and decoding method according to various embodiments of the present invention.

Provided is a computer program stored in a recording medium for executing a screen image encoding and decoding method according to various embodiments of the present invention.

### MODE OF THE INVENTION

The terminology used herein is for the purpose of describing embodiments only and is not intended to be limiting of embodiments. As used herein, the singular forms “a”, “an”, and “the” are intended to include the plural forms as well, unless the context clearly indicates otherwise. It will be further understood that the terms “comprises” and/or “comprising” used herein specify the presence of stated elements or steps, but do not preclude the presence or addition of one or more other elements or steps.

Hereinafter, in the below-described various embodiments, the term ‘image’ may comprehensively denote not only a still image, but also a moving picture such as a video.

Hereinafter, the term ‘sample’ refers to data assigned to a sampling location of an image to be processed. For example, pixels in an image of a spatial domain may be samples. Alternatively, residuals corresponding to pixels in an image of a spatial domain may be samples.

Hereinafter, a block may be square or rectangular, or may have an arbitrary geometric shape. A block is not limited to a data unit with a predetermined size. For example, a block may have a size of 8×8.

Hereinafter, signaling may refer to transmitting or receiving a signal. For example, when image data is encoded, signaling may refer to transmitting an encoded signal. Alternatively, when image data is decoded, signaling may refer to receiving a decoded signal.

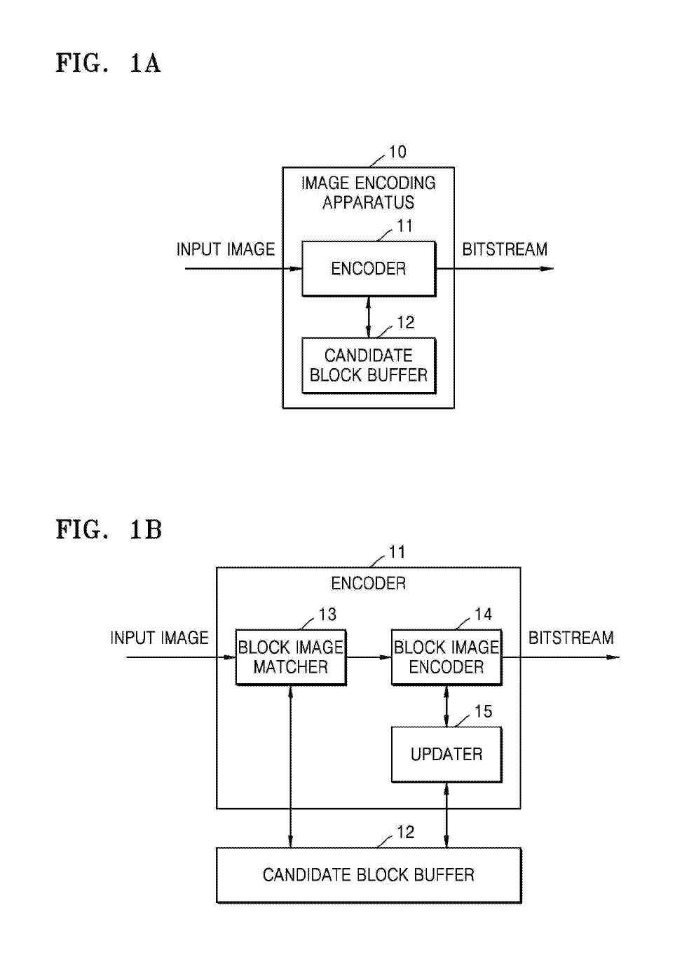

Hereinafter, a method and apparatus for encoding a screen image and a method and apparatus for decoding a screen image according to various embodiments will now be described with reference to FIGS. 1A through 7D.

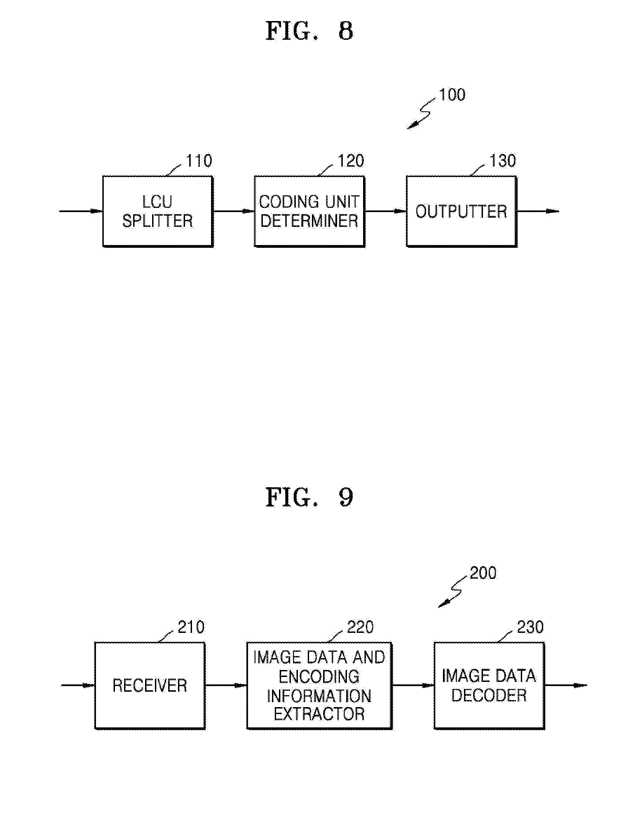

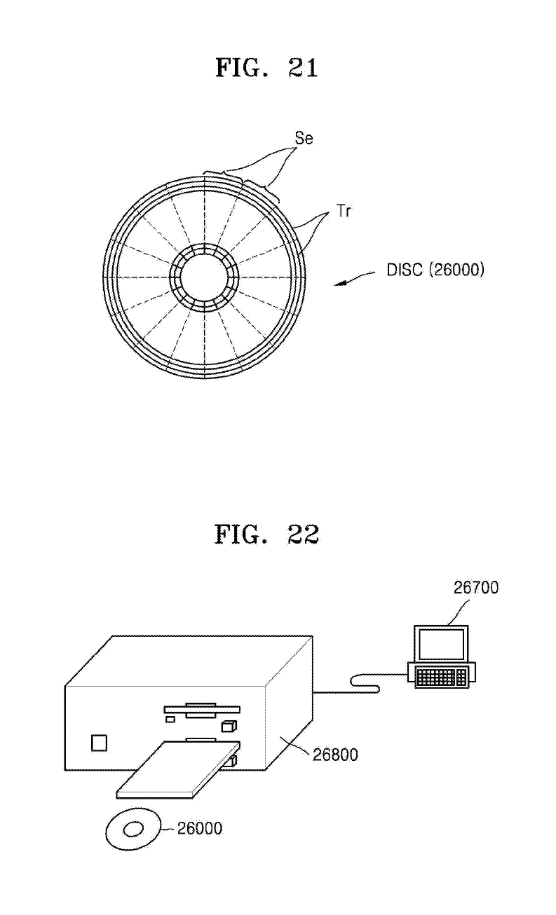

Also, a video encoding method and a video decoding method based on coding units of a tree structure according to various embodiments which may be applied to the above screen image encoding and decoding methods will be described with reference to FIGS. 8 through 20. Also, various embodiments to which the video encoding method and the video decoding method may be applied will be described with reference to FIGS. 21 through 27.

FIG. 1A is a block diagram of an image encoding apparatus 10 for encoding a screen image according to an embodiment.

As shown in FIG. 1A, the image encoding apparatus 10 may include an encoder 11 and a candidate block buffer 12. However, the image encoding apparatus 10 may include more elements than those illustrated in FIG. 1A or may include fewer elements than those illustrated in FIG. 1A.

The encoder 11 according to an embodiment may receive an input image. For example, the encoder 11 may receive a current block. A current block according to an embodiment may refer to an image of a block that is currently encoded.

The encoder 11 according to an embodiment may obtain and store one or more candidate blocks, which are spatially co-located with a current block, from images encoded prior to a current image.

For example, a block with a size of 3×3 located at the center of a previous image may be a candidate block of a current block with a size of 3×3 located at the center of a current image.

Alternatively, the image encoding apparatus 10 may selectively obtain and store one or more candidate blocks, which are spatially co-located with a current block, from images encoded prior to a current image. The image encoding apparatus 10 according to an embodiment may obtain one or more candidate blocks, which are spatially co-located with a current block, from some of a plurality of images encoded prior to a current image. The image encoding apparatus 10 according to an embodiment may obtain co-located blocks that are spatially co-located with a current block from images encoded prior to a current image, may select some blocks according to a predetermined standard from the co-located blocks, and may determine the selected blocks as candidate blocks.

The encoder 11 according to an embodiment may determine whether a reference block used to encode a current block exists in one or more candidate blocks stored in a candidate block buffer 12. For example, the encoder 11 may obtain a reference block that is identical or similar to a current block by searching the candidate block buffer 12.

A reference block according to an embodiment may refer to a block used to encode a current block. For example, a block that is identical to a current block from among candidate blocks may be a reference block. Alternatively, a block that is similar to a current block by a predetermined degree or more from among candidate blocks may be a reference block.

Whether a candidate block is similar to a current block by a predetermined degree or more may be determined by using a preset method. For example, when a sum of absolute differences (SAD) between a candidate block and a current block is calculated and is equal to or less than a specific critical value, the encoder 11 may determine the candidate block as a reference block. A SAD according to an embodiment may refer to a value obtained by obtaining an absolute value of a difference between two corresponding pixel values included in two blocks for each of all pixels of each block and adding the absolute values. A current block may be an original input image. Alternatively, the encoder 11 may obtain representative values of a candidate block and a current block and may determine whether the candidate block is a reference block based on whether a difference between the representative values is equal to or less than a preset value. The representative values may be determined by using a preset method. For example, the representative value of the current block may be an average of pixel values included in the current block.

The encoder 11 according to an embodiment may determine a candidate block representative value based on a pixel value included in a candidate block, may determine a current block representative value of a current block based on a pixel value included in the current block, and may determine the candidate block as a reference block when a difference between the candidate block representative value and the current block representative value is equal to or less than a preset critical value.

The encoder 11 according to an embodiment may obtain a SAD between each candidate block and a current block and may determine a candidate block having a SAD that is equal to or less than a preset critical value as a reference block.

The encoder 11 according to an embodiment may encode at least one of index information, prediction information used to decode a current block from a reference block, and information about the current block based on whether the reference block exists in the candidate block buffer 12.

The encoder 11 according to an embodiment may determine whether to encode prediction information when a reference block for a current block is stored in the candidate block buffer 12.

For example, when a substitute candidate block that is identical to a current block exits in one or more candidate blocks stored in the candidate block buffer 12, the encoder 11 may omit encoding information about the current block and may encode index information indicating the substitute candidate block. There may be various methods of encoding index information. The encoder 11 according to an embodiment may use variable length coding or arithmetic coding to encode index information. The encoder 11 according to another embodiment may use fixed length coding to encode index information.

Alternatively, when a reference block is stored in the candidate block buffer 12 and is not identical to a current block, the encoder 11 may encode index information indicating the reference block and prediction information used to decode the current block from the reference block. In this case, the encoder 11 may omit encoding information about the current block.

When prediction information is encoded, the encoder 11 may encode all components of the prediction information or may encode only some components of the prediction information. For example, the encoder 11 may encode some of RGB components of prediction information. Alternatively, the encoder 11 may encode some of YUV components of prediction information.

When a reference block is not stored in the candidate block buffer 12, the encoder 11 according to an embodiment may encode information about a current block. In this case, the encoder 11 may omit encoding index information and prediction information. For example, the encoder 11 may perform intra-encoding or inter-encoding on the current block. The encoder 11 may output encoded data to the outside. For example, the encoder 11 may encode current block information and may output encoded data as a bitstream.

The encoder 11 according to an embodiment may encode information about a current block image and may update the candidate block buffer 12 based on the encoded information. There may be various methods of updating the candidate block buffer 12.

For example, when a reference block does not exist in the candidate block buffer 12, the encoder 11 may add information about a current block encoded by using intra-encoding or inter-encoding to the candidate block buffer 12.

When the number of candidate blocks stored in the candidate block buffer 12 is equal to or greater than a preset number, the candidate block buffer 12 may delete a candidate block determined by using a preset method. For example, when the number of candidate blocks stored in the candidate block buffer 12 is equal to or greater than a preset number, the candidate block buffer 12 may delete a candidate block corresponding to a pre-determined index from the candidate block buffer 12.

A process performed by the candidate block buffer 12 to delete a candidate block will now be explained.

The number of candidate blocks that may be stored in the candidate block buffer 12 according to an embodiment may be 32, and indices 0 through 31 may be assigned to the candidate blocks stored in the candidate block buffer 12. In this case, the candidate block buffer 12 storing the 32 candidate blocks may delete the candidate block having the index 31 from among the candidate blocks stored in the candidate block buffer 12 in order to additionally store a candidate block.

When one candidate block has to be deleted, the candidate block buffer 12 according to another embodiment may delete a candidate block with a lowest frequency of use from among candidate blocks stored in the candidate block buffer 12. For example, since a candidate block corresponding to a background image has a high frequency of use, the candidate block may not be deleted from the candidate block buffer 12.

The candidate block buffer 12 according to an embodiment may consider a frequency of use of each of candidate blocks when assigning indices to the candidate blocks stored in the candidate block buffer 12. For example, the candidate block buffer 12 may assign a lower index to a candidate block with a higher access frequency.

The candidate block buffer 12 according to an embodiment may re-set a storage order in which candidate blocks are stored in the candidate block buffer 12. For example, the candidate block buffer 12 may re-set a storage order of candidate blocks by considering frequencies of use of the candidate blocks. Alternatively, the candidate block buffer 12 may determine a storage order of candidate blocks based on an order in which the candidate blocks are recently accessed. Alternatively, the candidate block buffer 12 may determine a storage order of candidate blocks based on a user input.

The candidate block buffer 12 according to an embodiment may set an index of a candidate block corresponding to a current block to 0 when assigning indices to candidate blocks stored in the candidate block buffer 12.

When data of a candidate block corresponding to a current block is updated, the candidate block buffer 12 according to an embodiment may update the data of the candidate block corresponding to the current block by reflecting updated content.

The candidate block buffer 12 may obtain and store one or more candidate blocks, which are spatially co-located with a current block, from images encoded prior to a current image. For example, a block with a size of 3×3 located at the center of a previous image may be a candidate block for a current block with a size of 3×3 located at the center of a current image.

FIG. 1B is a block diagram of the encoder 11 for encoding a screen image according to an embodiment.

As shown in FIG. 1B, the encoder 11 may include a block image matcher 13, a block image encoder 14, and an updater 15.

The block image matcher 13 according to an embodiment may determine whether a reference block used to encode a current block exists in one or more candidate blocks stored in the candidate block buffer 12, which has been described in detail with reference to FIG. 1A.

The block image encoder 14 according to an embodiment may encode at least one of index information indicating a reference block, prediction information used to encode a current block from the reference block, and information about the current block based on whether the reference block exists in the candidate block buffer 12, which has been described in detail with reference to FIG. 1A.

The updater 15 according to an embodiment may encode information about a current block image and may update the candidate block buffer 12 based on the encoded information, which has been described in detail with reference to FIG. 1A.

FIG. 1C is a flowchart of a method of encoding a screen image according to an embodiment.

In operation S11, the image encoding apparatus 10 may obtain and store one or more candidate blocks, which are spatially co-located with a current block, from images encoded prior to a current image. For example, a block with a size of 3×3 located at the center of a previous image may be a candidate block for a current block with a size of 3×3 located at the center of a current image. Alternatively, the image encoding apparatus 10 may selectively obtain and store one or more candidate blocks, which are spatially co-located with a current block, from images encoded prior to a current image.

In operation S12, the image encoding apparatus 10 may determine whether a reference block used to encode the current block exists in the one or more candidate blocks stored in operation S11. For example, the encoder 11 may obtain a reference block that is identical or similar to the current block by searching the candidate block buffer 12.

In operation S13, the image encoding apparatus 10 may encode at least one of index information indicating the reference block, prediction information used to decode the current block from the reference block, and information about the current block based on a result determined in operation S12.

When a reference block for a current block is stored in the candidate block buffer 12, the encoder 11 according to an embodiment may determine whether to encode prediction information.

For example, when a substitute candidate block that is identical to a current block exists in one or more candidate blocks stored in the candidate block buffer 12, the encoder 11 may omit encoding information about the current block and may encode index information indicating the substitute candidate block. There may be various methods of encoding index information. The encoder 11 according to an embodiment may use variable length coding or arithmetic coding to encode index information. The encoder 11 according to another embodiment may use fixed length coding to encode index information.

Alternatively, when a reference block is stored in the candidate block buffer 12 and is not identical to a current block, the encoder 11 may encode index information indicating the reference block and prediction information used to decode the current block from the reference block. In this case, the encoder 11 may omit encoding information about the current block.

When prediction information is encoded, the encoder 11 may encode all components of the prediction information or only some components of the prediction information. For example, the encoder 11 may encode only some of RGB components of prediction information. Alternatively, the encoder 11 may encode only some of YUV components of prediction information.

When a reference block is not stored in the candidate block buffer 12, the encoder 11 according to an embodiment may encode information about a current block. In this case, the encoder 11 may omit encoding index information and prediction information. For example, the encoder 11 may perform intra-encoding or inter-encoding on the current block. The encoder 11 may output encoded data to the outside. For example, the encoder 11 may encode current block information and may output encoded data as a bitstream.

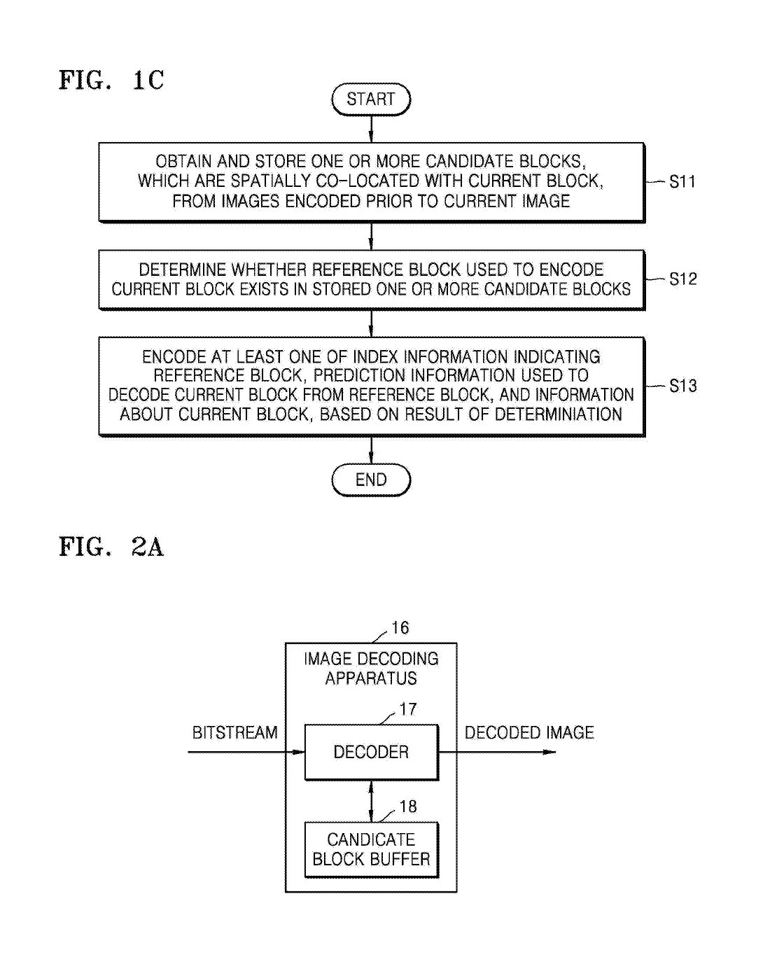

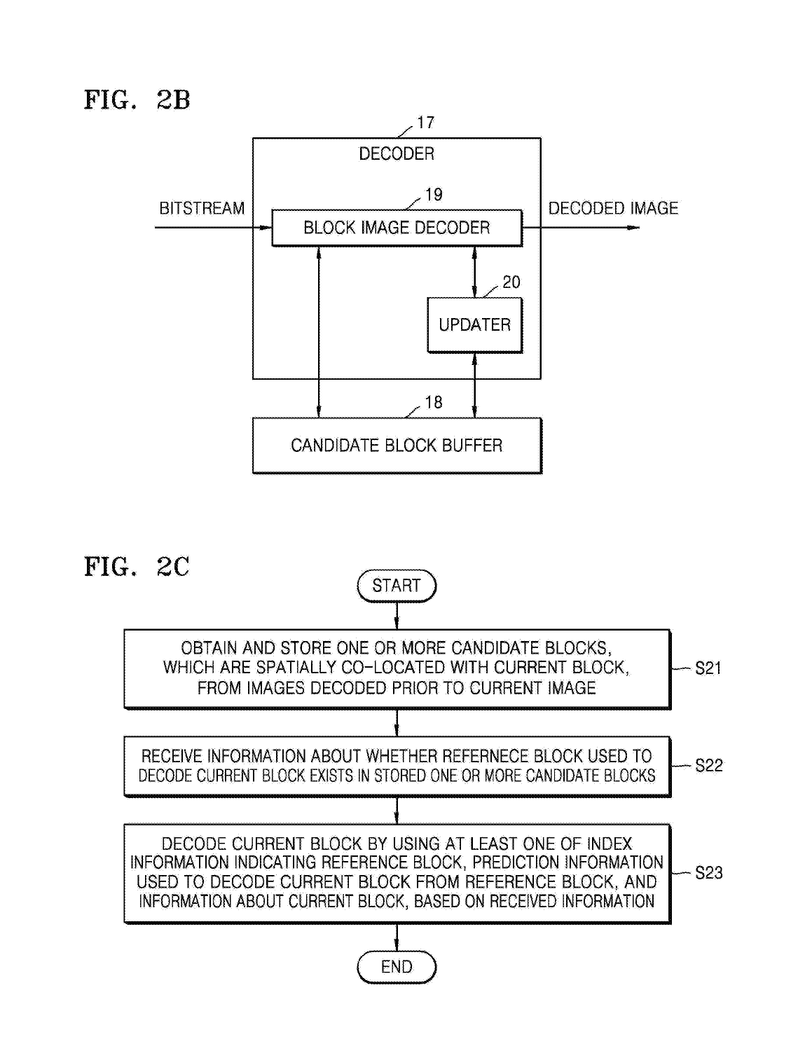

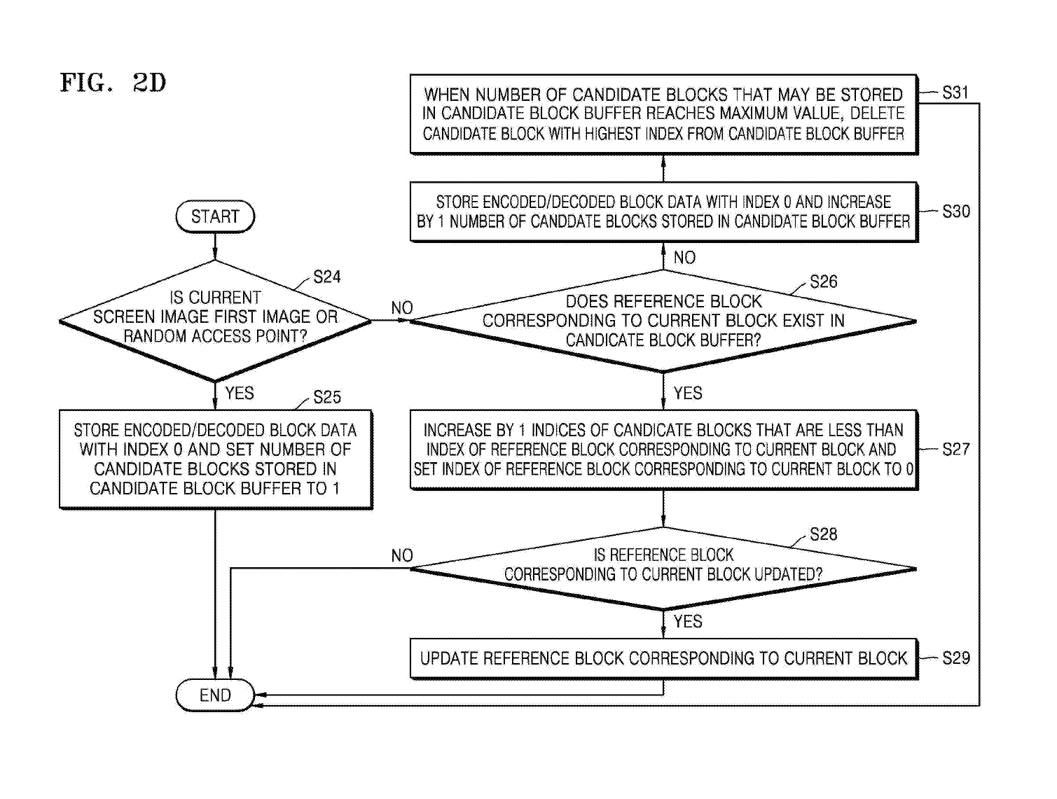

FIG. 2A is a block diagram of an image decoding apparatus 16 for decoding a screen image according to an embodiment. The image decoding apparatus 16 may include a decoder 17 and a candidate block buffer 18. However, the image decoding apparatus 16 may include more elements than those illustrated in FIG. 2A or may include fewer elements than those illustrated in FIG. 2A.

The decoder 17 according to an embodiment may receive a bitstream. For example, the decoder 17 may receive as a bitstream information about a current block that is a block that is currently decoded. A current block according to an embodiment may refer to an image of a block that is currently decoded.

The decoder 17 according to an embodiment may receive information about whether a reference block used to decode a current block exists in one or more candidate blocks stored in the candidate block buffer 18. For example, the decoder 17 may obtain a reference block from the candidate block buffer 189 based on information about whether the reference block exists in the candidate block buffer 18.

A reference block according to an embodiment may refer to a block used to encode a current block. For example, a block that is identical to a current block from among candidate blocks may be a reference block. Alternatively, a block that is similar to a current block by a predetermined degree or more from among candidate blocks may be a reference block.

Whether a candidate block is similar to a current block by a predetermined degree or more may be determined by using a preset method. For example, when a SAD between a candidate block and a current block is calculated and is equal to or less than a specific critical value, the encoder 11 may determine the candidate block as a reference block. A SAD according to an embodiment may refer to a value obtained by obtaining an absolute value of a difference between two corresponding pixel values included in two blocks for each of all pixels of each block and adding the absolute values. A current block may be an original input image. Alternatively, the decoder 17 may obtain representative values of a candidate block and a current block and may determine whether the candidate block is a reference block based on whether a difference between the representative values is equal to or less than a preset value. The representative values may be determined by using a preset method. For example, the representative value of the current block may be an average of pixel values included in the current block.

The decoder 17 according to an embodiment may determine a candidate block representative value based on a pixel value included in a candidate block, may determine a current block representative value of a current block based on a pixel value included in the current block, and may determine the candidate block as a reference block when a difference between the candidate block representative value and the current block representative value is equal to or less than a preset critical value.

The decoder 17 according to an embodiment may decode a current block by using at least one of index information indicating a reference block, prediction information used to decode the current block from the reference block, and information about the current block based on received information.

The decoder 17 according to an embodiment may receive and parse a bitstream generated by the image encoding apparatus 10 and may decode a current block.

For example, when signaling is performed to indicate that a reference block exits in the candidate block buffer 18 and does not need to be updated, the decoder 17 may output the reference block stored in the candidate block buffer 18 as a decoded image.

Alternatively, when signaling is performed to indicate that a reference block exists in the candidate block buffer 18 and needs to be updated, the decoder 17 may decode received update information and may update the reference block stored in the candidate block buffer 18.

Alternatively, when signaling is performed to indicate that a reference block does not exist in the candidate block buffer 18, the decoder 17 may perform intra-decoding or inter-decoding and may output a decoded image.

When a reference block for a current block is stored in the candidate block buffer 18, the decoder 17 according to an embodiment may determine whether to decode prediction information

For example, when a substitute candidate block that is identical to a current block exists in one or more candidate blocks stored in the candidate block buffer 18, the decoder 17 may omit decoding of information about the current block and may decode index information indicating the substitute candidate block. There may be various methods of decoding index information. The decoder 17 according to an embodiment may use variable length decoding or arithmetic decoding to decode index information. The decoder 17 according to another embodiment may use fixed length decoding to decode index information.

Alternatively, when a reference block is stored in the candidate bloc buffer 18 and is not identical to a current block, the decoder 17 may decode index information indicating the reference block and prediction information used to decode the current block from the reference block. In this case, the decoder 17 may omit decoding information about the current block.

When prediction information is decoded, the decoder 17 may decode all components of the prediction information or may decode only some components of the prediction information. For example, the decoder 17 may decode only some of RGB components of prediction information. Alternatively, the decoder 17 may decode only some of YUV components of prediction information.

When a reference block is not stored in the candidate block buffer 18, the decoder 17 according to an embodiment may decode information about a current block. In this case, the decoder 17 may omit decoding index information and prediction diction. For example, the decoder 17 may perform intra-decoding or inter-decoding on the current block. The decoder 17 may output decoded data to the outside. For example, the decoder 17 may decode current block information and may output a reconstructed image.

The decoder 17 according to an embodiment may decode information about a current block image and may update the candidate block buffer 18 based on the decoded information. There may be various methods of updating the candidate block buffer 18.

For example, when a reference block does not exist in the candidate block buffer 18, the decoder 17 may add information about a current block decoded by using inter-decoding or intra-decoding to the candidate block buffer 12.

When the number of candidate blocks stored in the candidate block buffer 18 is equal to or greater than a preset number, the candidate block buffer 18 according to an embodiment may delete a candidate block determined by using a preset method. For example, when the number of candidate blocks stored in the candidate block buffer 18 is equal to or greater than a preset number, a candidate block corresponding to a pre-determined index may be deleted from the candidate block buffer 18.

A process performed by the candidate block buffer 18 to delete a candidate block will now be explained.

The number of candidate blocks that may be stored in the candidate block buffer 18 according to an embodiment may be 32, and indices 0 through 31 may be assigned to the candidate blocks stored in the candidate block buffer 18. In this case, the candidate block buffer 18 storing the 32 candidate blocks may delete the candidate block having the index 31 from among the candidate blocks stored in the candidate block buffer 18 in order to additionally store a candidate block.

When one candidate block has to be deleted, the candidate block 18 according to another embodiment may delete a candidate block with a lowest frequency of use from among candidate blocks stored in the candidate block buffer 18. For example, since a candidate block corresponding to a background image has a high frequency of use, the candidate block may not be deleted from the candidate block buffer 18.

The candidate block buffer 18 according to an embodiment may consider a frequency of use of each of candidate blocks when assigning indices to the candidate blocks stored in the candidate block buffer 18. For example, the candidate block buffer 18 may assign a lower index to a candidate block with a higher access frequency.

The candidate block buffer 18 according to an embodiment may re-set a storage order in which candidate blocks are stored in the candidate block buffer 18. For example, the candidate block buffer 18 may re-set a storage order of candidate blocks by considering frequencies of use of the candidate blocks. Alternatively, the candidate block buffer 18 may determine a storage order of candidate blocks based on an order in which the candidate blocks are recently accessed. Alternatively, the candidate block buffer 18 may determine a storage order of candidate blocks based on a user input.

The candidate block buffer 18 according to an embodiment may set an index of a candidate block corresponding to a current block to 0 when assigning indices to candidate blocks stored in the candidate block buffer 18.

When data of a candidate block corresponding to a current block is updated, the candidate block buffer 18 according to an embodiment may update the data of the candidate block corresponding to the current block by reflecting updated content.

Also, the decoder 17 may process data loss.

The candidate block buffer 18 according to an embodiment may obtain and store one or more candidate blocks, which are spatially co-located with a current block, from images decoded prior to a current image.

The image decoding apparatus 16 according to an embodiment may perform an operation related to data loss.

For example, when an index of a reference block is greater than the number NumOfRefBlock of candidate blocks stored in a candidate block server, the image decoding apparatus 16 may store a candidate block of an index 0 to the index of the reference block. The image decoding apparatus 16 may increase the number NumOfRefBlock by a value obtained by subtracting the number NumOfRefBlock from the index of the reference block. When data loss occurs and a reference block having an index greater than the number NumOfRefBlock is obtained, the image decoding apparatus 16 according to an embodiment may increase the number NumOfRefBlock and may store a candidate block of an index 0 to the index of the reference block.

FIG. 2B is a block diagram of the decoder 17 for decoding a screen image according to an embodiment.

As shown in FIG. 2b, the decoder 17 may include a block image decoder 19 and an updater 20. However, the decoder 17 may include more elements than those illustrated in FIG. 2B or may include fewer elements than those illustrated in FIG. 2B.

The block image decoder 19 according to an embodiment may receive and parse a bitstream generated by the image encoding apparatus 10 and may decode a current block.

For example, when signaling is performed to indicate that a reference block exists in the candidate block buffer 18 and does not need to be updated, the block image decoder 19 may output the reference block stored in the candidate block buffer 18 as a decoded image.

Alternatively, when signaling is performed to indicate that a reference block exists in the candidate block buffer 18 and needs to be updated, the block image decoder 19 may decode received update information and may update the reference block stored in the candidate block buffer 18.

Alternatively, when signaling is performed to indicate that a reference block does not exist in the candidate block buffer 18, the block image decoder 19 may perform intra-decoding or inter-decoding and may output a decoded image.

An operation of the block image decoder 19 has been described in detail with reference to FIG. 2A.

The updater 20 according to an embodiment may decode information about a current block image and may update the candidate block buffer 18 based on the decoded information.

An operation of the updater 20 has been described in detail with reference to FIG. 2A.

FIG. 2C is a flowchart of a method of decoding a screen image according to an embodiment.

In operation S21, the image decoding apparatus 16 may obtain and store one or more candidate blocks, which are spatially co-located with a current block, from images decoded prior to a current image. For example, a block with a size of 3×3 located at the center of a previous image may be a candidate block for a current block with a size of 3×3 located at the center of a current image.

In operation S22, the image decoding apparatus 16 may receive information about whether a reference block used to decode the current block exists in the one or more candidate blocks stored in operation S21.

In operation S23, the image decoding apparatus 16 may decode the current block by using at least one of index information indicating the reference block, prediction information used to decode the current block from the reference block, and information about the current block, based on the information received in operation S22.

FIG. 2D is a flowchart for explaining a method of updating a candidate block buffer according to an embodiment.

In operation S24, the image decoding apparatus 16 may determine whether a current screen image is a first image or a random access point. For example, when a current screen image is an I-picture, the image decoding apparatus 16 may perform operation S25. An I-picture may refer to a picture encoded by using intra-prediction.

In operation S25, an index 0 may be assigned to an encoded or decoded current block and the encoded or decoded block with the index 0 may be stored in a candidate block buffer. The number of candidate blocks stored in the candidate block buffer may be set to 1.

In operation S26, the image decoding apparatus 16 may determine whether a reference block corresponding to the current block exists in the candidate block buffer.

When the reference block corresponding to the current block exists in the candidate block buffer, in operation S27, the image decoding apparatus 16 may increase by 1 indices of candidate blocks that are less than an index of the reference block corresponding to the current block and may set the index of the reference block corresponding to the current block to 0.

In operation S28, the image decoding apparatus 16 may determine whether the reference block corresponding to the current block is updated.

When the reference block corresponding to the current block is updated, in operation S29, the image decoding apparatus 16 may update the reference block corresponding to the current block. A method of updating a reference block has been described in detail with reference to FIG. 2A.

When the reference block corresponding to the current block does not exist in the candidate block buffer, in operation S30, the image decoding apparatus 16 may increase by 1 indices of candidate blocks stored in the candidate block buffer, may assign an index 0 to an encoded or decoded current block, and may store the encoded or decoded current block with the index 0 in the candidate block buffer.

In operation S31, when the number of candidate blocks that may be stored in the candidate block buffer reaches a maximum value, the image decoding apparatus 16 may delete a candidate block with a highest index from the candidate block buffer.

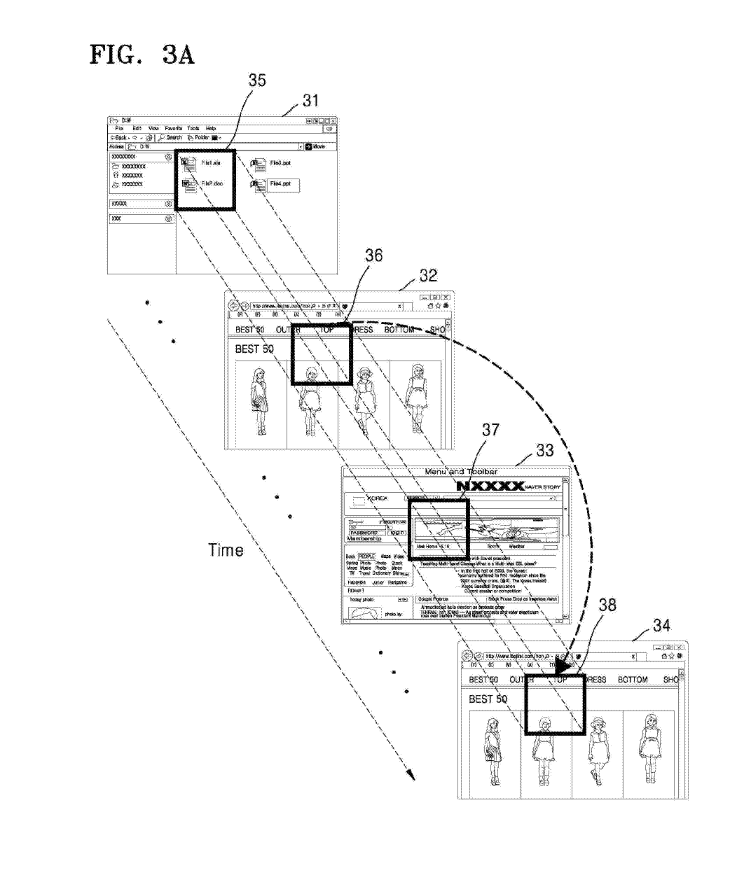

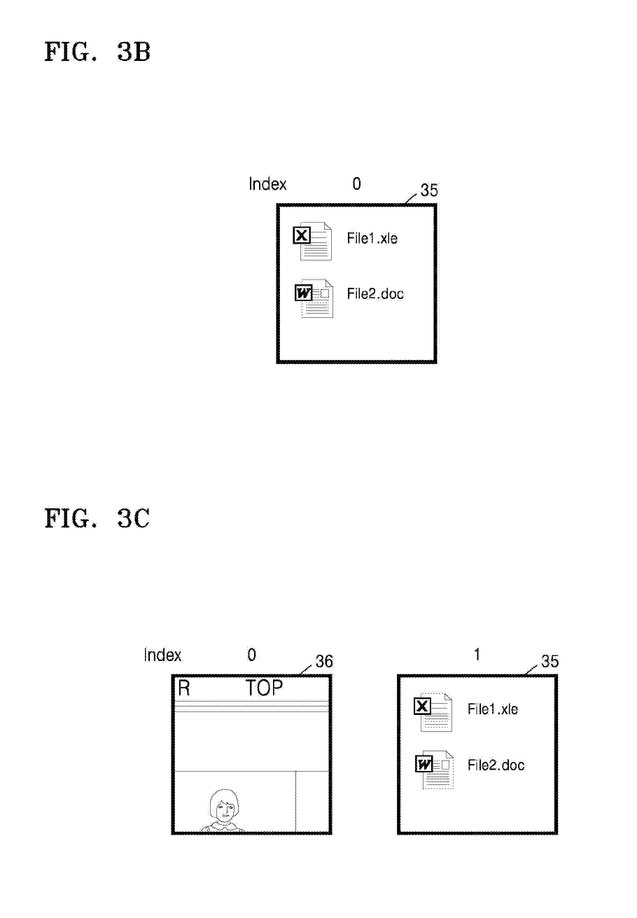

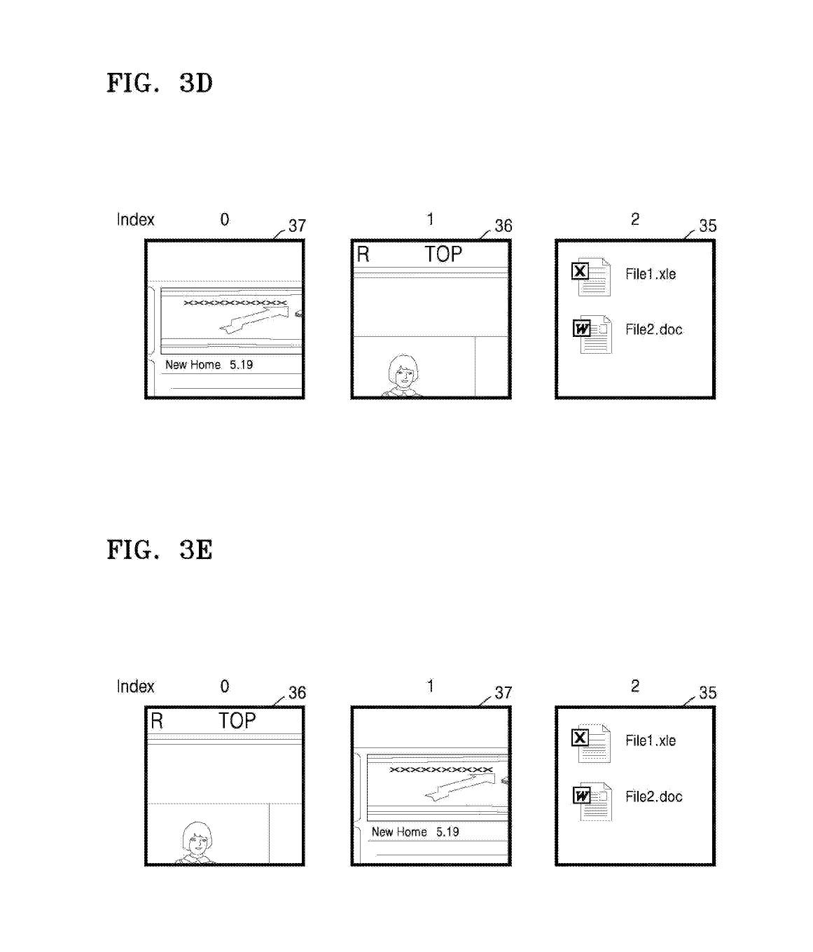

Although various operations performed by the image decoding apparatus 16 have been described with reference to FIGS. 2A through 2D, it will be understood by one of ordinary skill in the art that the method of FIGS. 2A through 3E may be performed by the image encoding apparatus 10.

FIG. 3A is a view for explaining a method of encoding or decoding a screen image according to an embodiment.

For example, FIG. 3A may show a screen image when a user input for switching windows such as alt+tab is continuously input.

As time passes, a first image 31, a second image 32, a third image 33, and a fourth image 345 may be sequentially displayed.

Also, a first block 35, a second block 36, a third block 37, and a fourth block 38 may be spatially co-located with one another.

When the fourth block 38 displayed on the fourth image 34 is to be processed, the image encoding apparatus 10 may use data of the second block 36 that is co-located with the fourth block 38 of the second image 32.

When the fourth block 38 is to be decoded, without needing to compressing or encoding information about the fourth block 38 and to transmit encoded data, information about the second block 36 may be used as prediction information, thereby improving encoding efficiency.

FIG. 3B is a view for explaining a method of storing a candidate block when the first image 31 is displayed according to an embodiment.

When the first image 31 is received, since there is no data in a candidate block buffer, the image encoding apparatus 10 may encode the first block 35 that is input by using intra-encoding, may assign an index 0 to the first block 35 that is an encoded block image, and may store the first block 35 in the candidate block buffer. The image encoding apparatus 10 may set the number of candidate blocks stored in the candidate block buffer to 1.

FIG. 3C is a view for explaining a method of storing a candidate block when the second image 32 is displayed according to an embodiment.

When a screen image is changed to the second image 32 due to a user's input, the image encoding apparatus 10 may determine whether the first block 35 stored in the candidate block buffer is used to encode the second block 36. Since the first block 35 is not identical or similar to the second block 36, the image encoding apparatus 10 may determine that the first block is not used to encode the second block 36. The image encoding apparatus 10 may perform intra-encoding on the second block 36, may change an index of the first block 35 that is stored with an index 0 in the candidate block buffer to an index 1, may assign an index 0 to the second block 36, and may store each candidate block in the candidate block buffer. The image encoding apparatus 10 may set the number of candidate blocks stored in the candidate block buffer to 2.

FIG. 3D is a view for explaining a method of storing a candidate block when the third image 33 is displayed according to an embodiment.

The third image 33 may be displayed on a screen image by a user's input. In this case, since a candidate block corresponding to the received third block is not stored in the candidate block buffer, intra-encoding may be performed on the third block, an index of the first block 35 that is stored with an index 1 in the candidate block buffer may be changed to an index 2, an index of the second block 36 that is stored with an index 0 may be changed to an index 1, an index 0 may be assigned to the third block 37 that is encoded, and thus each candidate block may be stored in the candidate block buffer. The image encoding apparatus 10 may set the number of candidate blocks stored in the candidate block buffer to 3.

FIG. 3E is a view for explaining a method of storing a candidate block when the fourth image 34 is displayed according to an embodiment.

The fourth image 35 may be displayed on a screen image due to a user's input. In this case, the second block 36 that is a candidate block corresponding to the received fourth block 38 is stored in the candidate block buffer. Since the second block 36 and the fourth block 38 are identical to each other, the image encoding apparatus 10 may encode an index of the second block 36. Also, in order to increase a priority of a recently accessed block, the image encoding apparatus 10 may change an index 1 and an index 0 in the candidate block buffer. For example, the image encoding apparatus 10 may assign an index 0 to the second block 36 and may assign an index 1 to the third block 37. In this case, the image encoding apparatus 10 may maintain the number of candidate blocks stored in the candidate block buffer as 3.

Although various operations performed by the image encoding apparatus 10 have been described with reference to FIGS. 3A through 3E, it will be understood by one of ordinary skill in the art that the method of FIGS. 3A through 3E may be performed by the image decoding apparatus 16.

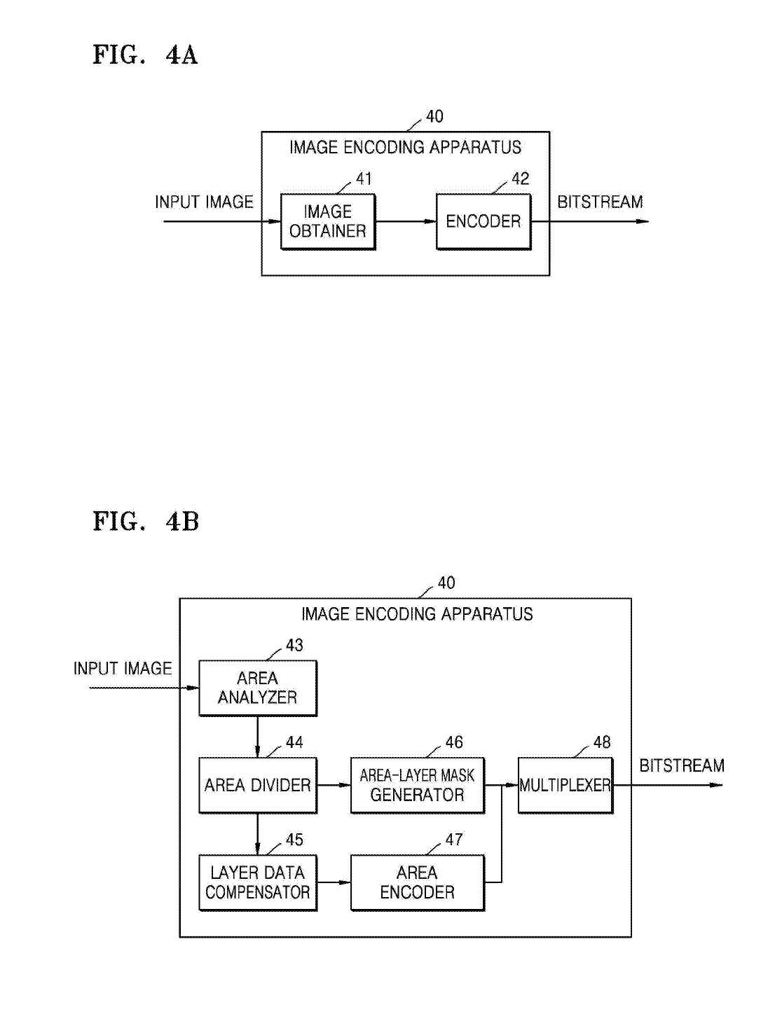

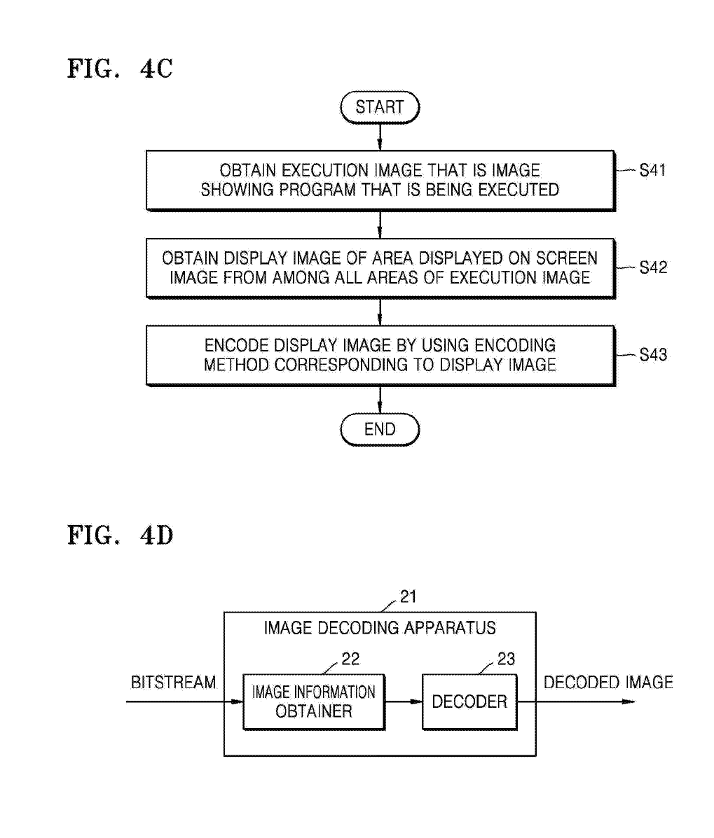

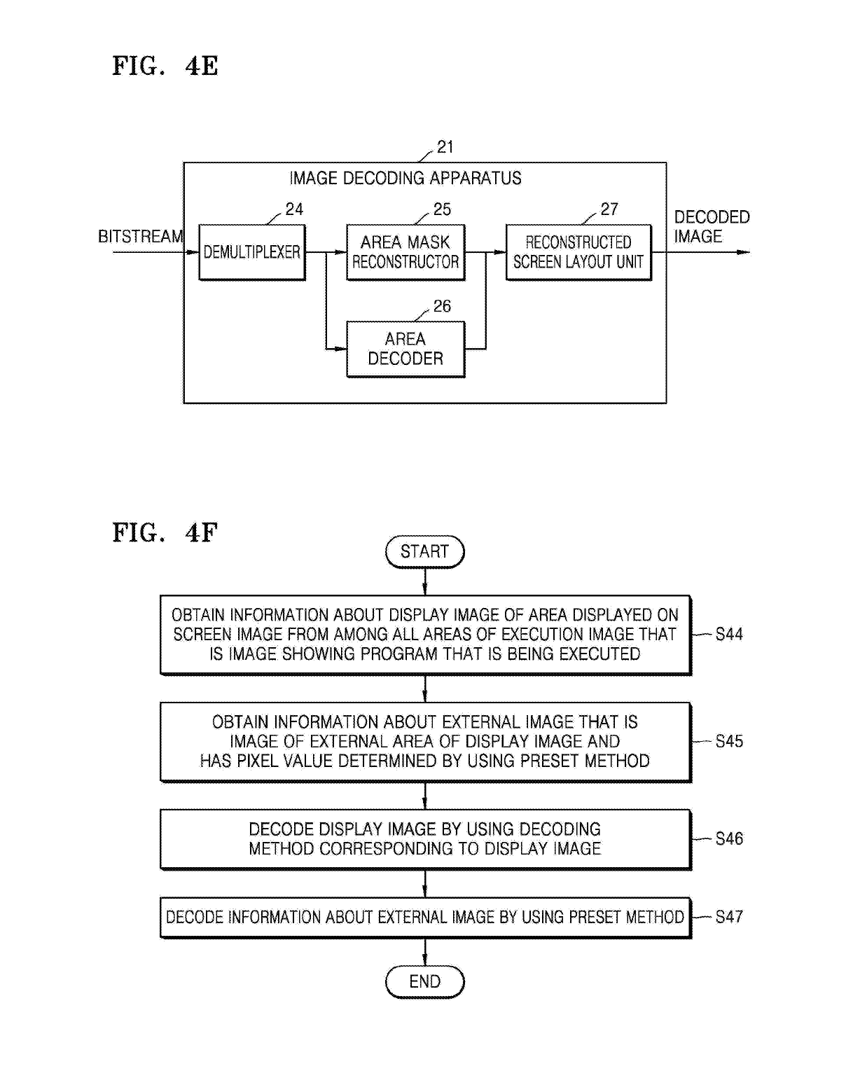

FIG. 4A is a block diagram of an image encoding apparatus 40 for encoding a screen image according to an embodiment.

As shown in FIG. 4A, the image encoding apparatus 40 may include an image obtainer 41 and an encoder 42. However, the image encoding apparatus 40 may include more elements than those illustrated in FIG. 4A or may include fewer elements than those illustrated in FIG. 4A.

The image obtainer 41 according to an embodiment may obtain an execution image that is an image showing a program that is being executed.

An execution image may refer to an image showing a program that is being executed. For example, when a video program is being executed and thus a video is being reproduced, a reproduced image may be an execution image. Alternatively, when a web browser is being executed, a web browser execution window may be an execution image.

Only some of all areas of an execution image may be displayed on a screen area. For example, a first execution image that is an execution image of a video reproduction program and a second execution image that is an execution image of a web browser may overlap each other. In this case, when the first execution image and the second execution image overlap each other, only the execution image that is located more frontward may be displayed.

An extraction image may refer to an image of an area that is actually displayed on a screen image from among all areas of an execution image. An extraction image may be obtained by extracting data of an area that is actually displayed from an execution image. For example, when a first execution image overlaps a second execution image so that the first execution image is located over a second execution image, only the first execution image may be displayed. In this case, when the first execution image is partially overlapped on the second execution image, an extraction image of the second execution image may refer to an image of an area that does not overlap the first execution image and is actually displayed on a screen image from among all areas of the second execution image.

An extraction image may be obtained for each execution image. For example, one screen image may include a combination of a plurality of extraction images.

For example, a first extraction image obtained from a first execution image, a second extraction image obtained from a second execution image, and a third extraction image obtained from a third execution image may be displayed on one screen image.

Also, an extraction image used herein may be referred to as a display image.

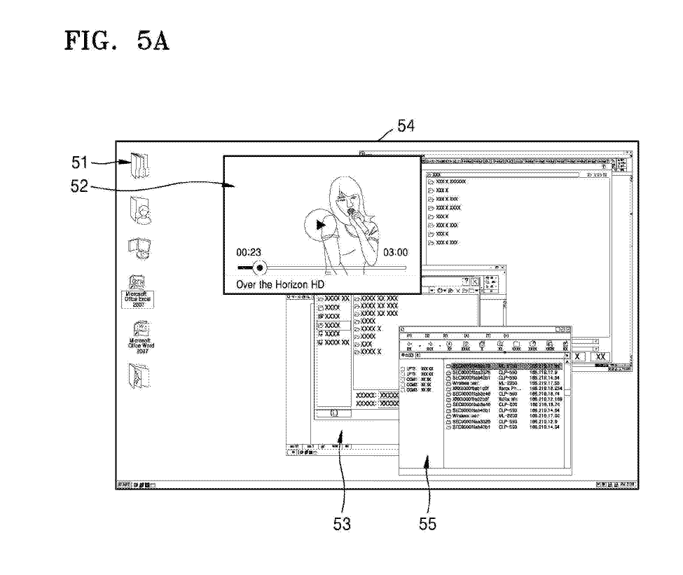

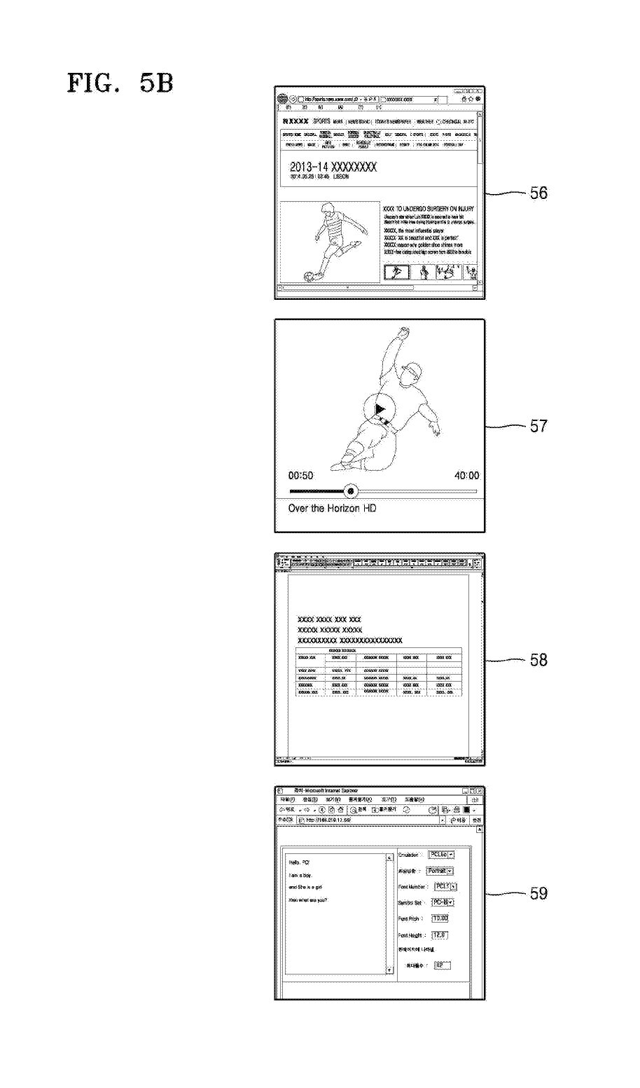

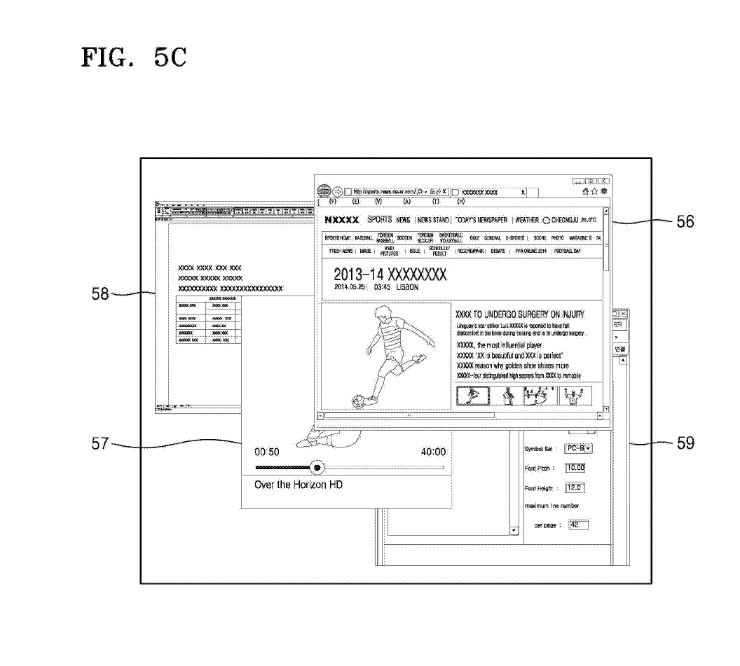

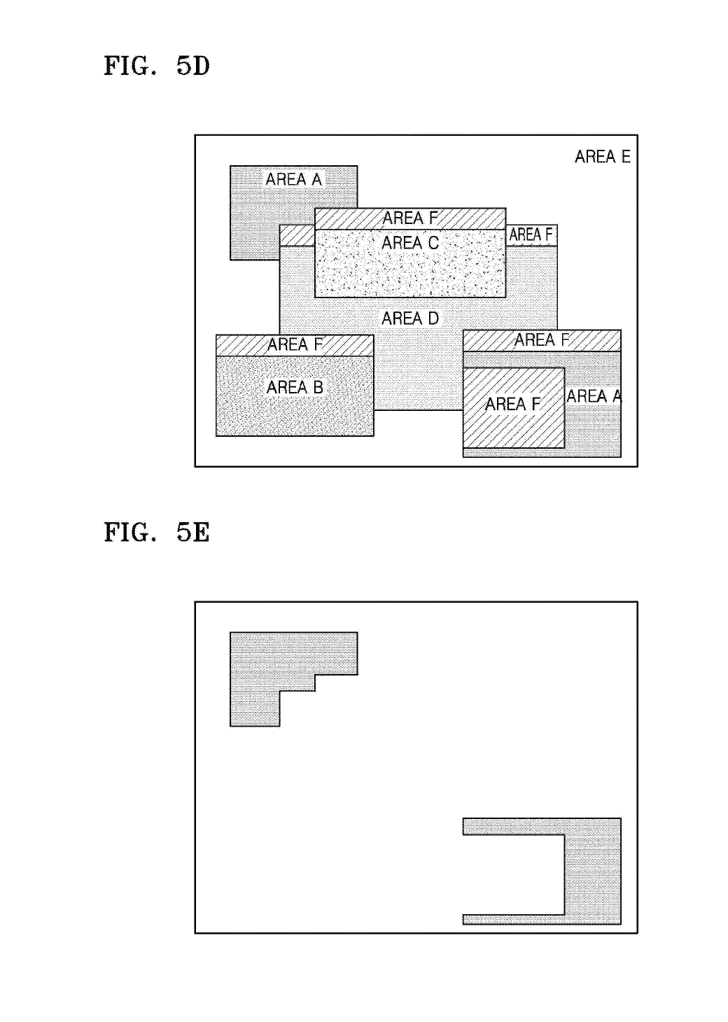

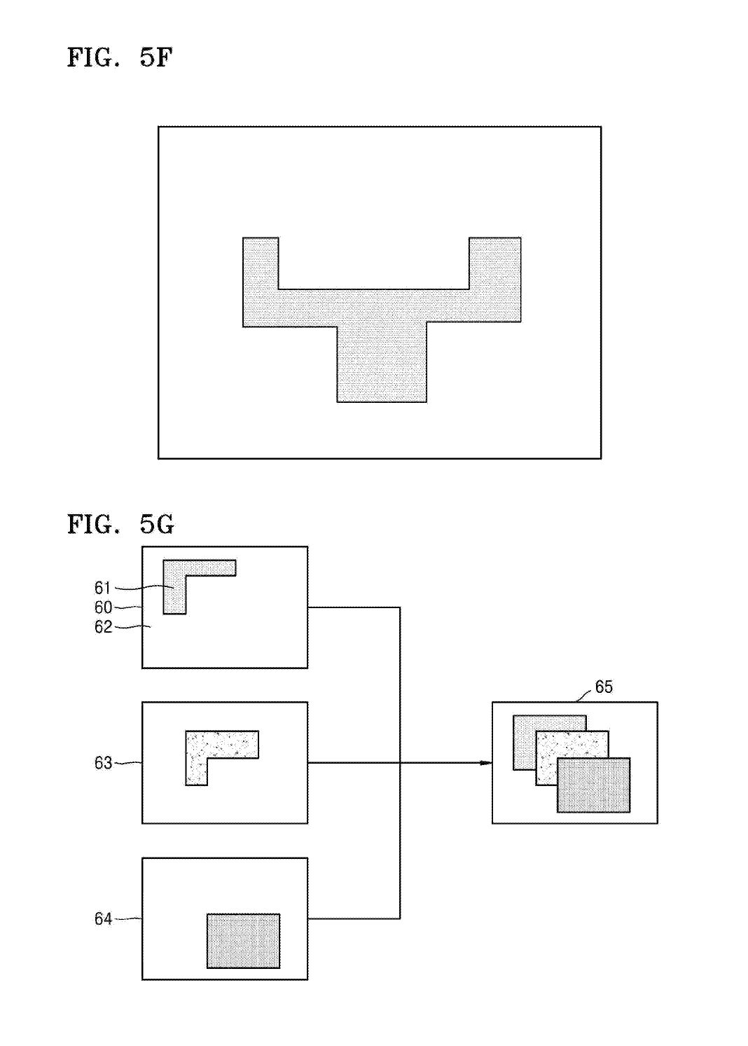

An extraction image will be described below in detail with reference to FIG. 5G.

A non-extraction image may refer to an image of an area other than an extraction image on a screen image. For example, an image of an area where an extraction image is not displayed on an image with a screen image size may be a non-extraction image. A non-extraction image may refer to an image of an area that is not extracted in a layer image. Alternatively, a non-extraction image may refer to an image of an internal area of a screen image and an external area of an extraction image.

Also, a non-extraction image used herein may be referred to as an external image.

A non-extraction image will be described below in detail with reference to FIG. 5G.

A layer image may refer to an image generated by combining an extraction image and a non-extraction image. For example, a layer image may refer to an image with the same size as that of a screen image and including both an extraction image and a non-extraction image. A layer image will be described below in detail with reference to FIG. 5G.

The image obtainer 41 according to an embodiment may obtain an extraction image from each execution image. For example, when three execution windows are displayed on a screen image, the image obtainer 41 may discriminate an area where the three execution windows are actually displayed on a screen from an area where the three execution windows are not actually displayed. The image obtainer 41 according to an embodiment may obtain a first extraction image that is an image of an area actually displayed on a screen from a first execution window, a second extraction image that is an image of an area actually displayed on the screen from a second execution window, and a third extraction image that is an image of an area actually displayed on the screen from a third execution window.

The encoder 42 according to an embodiment may obtain an extraction image of an area displayed on a screen image from among all areas of an execution image, and may encode the extraction image by using an encoding method corresponding to the extraction image.

The encoder 42 according to an embodiment may encode an extraction image based on a type of the extraction image. Accordingly, the encoder 42 may apply an adaptive encoding method to each of a plurality of extraction images constituting one screen image.

For example, when a first extraction image for video reproduction, a second extraction image for a JPEG image, and a third extraction image for a word document are included in a screen image, the encoder 42 may encode the first extraction image by using an encoding method that is suitable to encode a video, may encode the second extraction image by using an encoding method that is suitable to encode a still image, and may encode the third extraction image by using an encoding method that is suitable to encode text. A method of encoding each extraction image may be easily selected by one of ordinary skill in the art.

The encoder 42 according to an embodiment may obtain a non-extraction image. The non-extraction image may have a pixel value determined by using a preset method. The encoder 42 according to an embodiment may obtain a non-extraction image of an area that is an internal area of a screen image and also an external area of an extraction image. In this case, the encoder 42 may encode the non-extraction image by using a preset method. For example, the encoder 42 may encode a non-extraction image by using an encoding method corresponding to an extraction image.

A non-extraction image may be the opposite concept to an extraction image. For example, a non-extraction image may refer to an image of an area where an extraction image is not displayed on a screen image. A plurality of extraction images may be displayed on a screen.

A screen according to an embodiment may display a first extraction image for a first execution window, a second extraction image for a second execution window, and a third extraction image for a third execution window. In this case, an image of an area other than an area occupied by the first extraction image on the screen may be referred to as a non-extraction image of the first extraction image. An image used to encode the first extraction image may be a first image with a screen image size obtained by combining the first extraction image and the non-extraction image of the first extraction image. In this manner, a second image and a third image may be obtained.

An image obtained by combining an extraction image and a non-extraction image may be referred to as a layer image. For example, in the above embodiment, the first image may be a layer image of the first extraction image. A layer image according to an embodiment that is an image with a screen image size may refer to an image obtained by combining an extraction image and a non-extraction image of the extraction image.

A non-extraction image may be determined based on an extraction image. For example, when a first extraction image is a JPEG image, a non-extraction image of the first extraction image may have a pixel value of 128. Alternatively, when a first extraction image is a JPEG image, a pixel value of non-extraction image pixels included in a non-extraction image of the first extraction image may be determined by using a pixel value of the first extraction image that is the most close to each non-extraction image pixel.

A non-extraction image of a second extraction image may be determined based on a type of the second extraction image. Since a non-extraction image is not displayed to a user, encoding or decoding may be simply selected and used. For simple encoding or decoding, a non-extraction image of a second extraction image may be determined according to a type of the second extraction image. For example, when a second extraction image is a video, a method of encoding and decoding a non-extraction image of the second extraction image may be determined in consideration of a level of image quality, whether the second extraction image is coded by using a specific method, whether a ratio of text included in the second extraction image is equal to or greater than a predetermined ratio, and/or whether a ratio of an image included in the second extraction image is equal to or greater than a predetermined ratio.

The encoder 42 according to an embodiment may obtain instruction information for discriminating an area corresponding to an extraction image from an area corresponding to a non-extraction image on a screen image. In this case, the encoder 42 may obtain the extraction image and the non-extraction image from the screen image based on the instruction information.

Instruction information according to an embodiment may be obtained for each pixel or may be obtained for each block with a preset size.

For example, information about whether each of pixels of a layer image is a pixel displayed on a screen may be encoded or decoded as instruction information.

Alternatively, information about whether each of blocks of a layer image is a block displayed on a screen may be encoded or decoded as instruction information.

Instruction information according to an embodiment may be mask information for discriminating an area that is displayed from an area that is not displayed on a layer image.

Also, the image obtainer 41 according to an embodiment may obtain an extraction image from a layer image based on instruction information. For example, the image obtainer 41 may divide a layer image into an extraction image and a non-extraction image based on instruction information.

The image encoding apparatus 40 according to an embodiment may generate instruction information indicating whether an area of a layer image is displayed.

The encoder 42 according to an embodiment may determine whether an execution image is for a still image and may encode an extraction image by using an encoding method determined based on a result of the determination.

The encoder 42 according to an embodiment may encode an extraction image based on a type of the extraction image. Accordingly, the encoder 42 may apply an adaptive encoding method to each of a plurality of extraction images constituting one screen image.

In this case, the encoder 42 may determine an encoding method based on whether an extraction image is for a still image. A still image may refer to a static image excluding text or the like. Even when an extraction image for a video is an image at a pause point, the extraction image may be regarded as a still image.

The encoder 42 according to an embodiment may determine whether an execution image is for a video and may encode an extraction image by using an encoding method determined based on a result of the determination.

The encoder 42 according to an embodiment may encode an extraction image based on whether the extraction image is a video. Accordingly, the encoder 42 may apply an adaptive encoding method to each of a plurality of extraction images constituting one screen image.

The encoder 42 according to an embodiment may separate a codec for a video and a codec for other images and may differently use the codecs to encode an extraction image. Since a video codec is more complex than a codec for images other than a video, the encoder 42 according to an embodiment may encode an extraction image for a video by using a hardware accelerator that is developed for a video codec. The encoder 42 according to an embodiment may encode an extraction image for a video by using a video codec and may encode an extraction image for a still image by using a codec for a still image.

A codec used by the encoder 42 may include at least one of a codec for encoding or decoding a video area, an existing portable network graphics (PNG) codec for encoding graphic data to encode or decode a still image, an existing run-length coding-based codec, and a non-standard codec for encoding or decoding an area other than an image.

FIG. 4B is a block diagram of the image encoding apparatus 40 for encoding a screen image according to another embodiment.

As shown in FIG. 4B, the image encoding apparatus 40 may include an area analyzer 43, an area divider 44, a layer data compensator 45, an area-layer mask generator 46, an area encoder 47, and a multiplexer 48. However, the image encoding apparatus 40 may include more elements than those illustrated in FIG. 4B or may include fewer elements than those illustrated in FIG. 4B.

The area analyzer 43 according to an embodiment may analyze each area of an input screen image and may output an area analysis result. For example, the area analyzer 43 may obtain a plurality of execution images. Alternatively, the area analyzer 43 may obtain a plurality of extraction images.

The area analyzer 43 according to an embodiment may discriminate a plurality of extraction images displayed on a plurality of screen images based on execution windows. The discriminated plurality of extraction images may be included in at least one of a video area, a still image area, a text area, and a graphic data area.

The area analyzer 43 according to an embodiment may divide a screen image into two areas. For example, the area analyzer 43 may group a plurality of extraction images into a video area and a non-video area.

A method used by the area analyzer 43 to analyze an image may be a method using application programming interface (API) information used in a system or a an image analysis method using low-level image processing. Also, the area analyzer 43 may use a combination of a method using API information used in a system and an image analysis method using low-level image processing in order to analyze an image.

The area analyzer 44 according to an embodiment may obtain a plurality of layer images by using a result obtained by the area analyzer 43 after analyzing a screen image.

For example, a screen image may include a first extraction image of an area that is actually displayed from among areas of an image for a video program and a second extraction image of an area that is actually displayed from among areas of an image for a word program.

The area divider 44 according to an embodiment may obtain a first layer image that includes the first extraction image and has the same size as that of a screen image and a second layer image that includes the second extraction image and has the same size as that of the screen image. An area where an extraction image is not displayed on each layer image may be processed by using a preset method. A method of efficiently encoding or decoding a layer image may be pre-determined as the preset method.

The layer data compensator 45 according to an embodiment may generate a non-extraction image that is an image of an area where an extraction image is not displayed on a layer image generated by the area divider 44. For example, the layer data compensator 45 may determine pixel values corresponding to the non-extraction image by using a preset method. The layer data compensator 45 according to an embodiment may use a method with a small calculation amount to determine pixel values corresponding to the non-extraction image. For example, when an extraction image included in a layer image is not text but a still image such as a photograph or a video, since the layer image may be encoded or decoded by using MPEG-2, MPEG-4, H.264, or JPEG, the layer data compensator 45 may set pixel values corresponding to a non-extraction image to 128. Alternatively, when an extraction image included in an layer image is text or a graphic image, since the layer image may be encoded or decoded by using a run-length coding-based codec, the layer data compensator 45 according to an embodiment may consider a pixel value of pixels located around pixels of a non-extraction image to determine a pixel value of the non-extraction image. For example, when a pixel value of a first pixel that is a pixel included in a non-extraction image is to be determined, a value that is the closest to a pixel value of a second pixel located right over the first pixel may be determined as a pixel value of the first pixel.

The layer data compensator 45 according to an embodiment may determine a pixel value included in a non-extraction image of a layer image to improve encoding efficiency of a method of encoding the layer image.

For example, when a layer image is encoded in an intra-prediction mode by using H.264, the layer data compensator 45 may set an intra-prediction mode to a 16×16 block DC mode and a coded bit pattern (CBP) to 0 for a non-extraction image. In this case, for the non-extraction image, transformation and quantization may be omitted.

Alternatively, when a layer image is encoded in an inter-prediction mode by using H.264, the layer data compensator 45 may set a mode used to encode a non-extraction mode to a skip mode. In this case, a process of encoding the non-extraction image may be minimized.

Alternatively, when a layer image is encoded by using a first method, the layer data compensator 45 may generate flag information so that an external area is not encoded by using the first method. In this case, a process of decoding a non-extraction image may be minimized. For example, an encoding process may not be performed for each block of the non-extraction image, and thus a complexity of an encoder may be reduced. Also, a calculation amount for encoding and decoding may be reduced, and thus a complexity of a decoder may also be reduced.

The layer data compensator 45 according to an embodiment may preclude signaling for an external area included in a layer image. In this case, since signaling is not performed for the external area, encoding of the external area may be omitted. Accordingly, a calculation amount during an encoding and decoding process may be reduced.

The layer data compensator 45 according to an embodiment may include data of an extraction image of a second layer image when encoding a first non-extraction image of a first layer image. In this case, an amount of transmitted combination information to combine a plurality of layer images may be reduced.

The area-layer mask generator 46 according to an embodiment may obtain instruction information for discriminating an area where an extraction image is displayed from an area where the extraction image is not displayed on a layer image based on the layer image generated by the area divider 44. Instruction information according to an embodiment may be obtained to correspond to each layer image. Instruction information according to an embodiment may include location information of an extraction image.

Instruction information according to an embodiment may be generated for each encoding unit used to encode each layer image. For example, instruction image may be generated for each block with a size of 16×16 or 8×8. Alternatively, instruction information may be generated for each pixel.

The area encoder 47 according to an embodiment may encode one or more layer images by using an encoding method that is suitable for each layer image and may transmit the encoded layer images to the multiplexer 48.

For example, when an extraction image included in a first layer image is a video, the area encoder 47 may encode the first layer image by using a video encoding method. In this case, a non-extraction image included in the first layer image may also be encoded by using the video encoding method.

In this case, since only images that are actually displayed on a screen image are encoded, a calculation amount for encoding may be less than that for encoding all execution images.

Also, in this case, since only images that are actually displayed on a screen image are encoded, an amount of transmitted data may be less than that when all execution images are encoded.

Also, this case, since only images that are actually displayed on a screen image are encoded, encoding may be performed based on actually displayed image quality. Accordingly, a calculation amount for encoding and an amount of transmitted data may be less than those when all execution images are encoded.

Since location information of an extraction image is included in instruction information, the area encoder 47 may omit encoding information indicating a location of the extraction image.

The multiplexer 48 according to an embodiment may receive instruction information corresponding to each layer image input from the area-layer mask generator. Also, the multiplexer 48 according to an embodiment may receive encoding information about a layer image from the area encoder 47. The multiplexer 48 according to an embodiment may include one bit string including received information. Also, the bit string generated by the multiplexer 48 according to an embodiment may include information about an encoding method.

FIG. 4C is a flowchart of a method of encoding a screen image according to an embodiment.

In operation S41, the image encoding apparatus 40 according to an embodiment may obtain an execution image that is an image showing a program that is being executed.

In operation S42, the image encoding apparatus 40 according to an embodiment may obtain an extraction image of an area that is displayed on a screen image from among all areas of the execution image.

In operation S43, the image encoding apparatus 40 according to an embodiment may encode the extraction image by using an encoding method corresponding to the extraction image.

FIG. 4D is a block diagram of an image decoding apparatus 21 for decoding a screen image according to an embodiment.

As shown in FIG. 4D, the image decoding apparatus 21 may include an image information obtainer 22 and a decoder 23. The image decoding apparatus 21 may include more elements than those illustrated in FIG. 4D or may include fewer elements than those illustrated in FIG. 4D.

The image information obtainer 22 according to an embodiment may obtain information about an extraction image of an area that is displayed on a screen image from among all areas of an execution image that is an image showing a program that is being executed.

An execution image may refer to an image showing a program that is being executed. For example, when a video program is being executed and a video is being reproduced, a reproduced image may be an execution image. Alternatively, when a web browser is being executed, a web browser execution window that is being executed may be an execution image.

Only some of all areas of an execution image may be displayed on a screen area. For example, a first execution image that is an execution image of a video reproduction program and a second execution image that is an execution image of a web browser may overlap each other. In this case, when the first execution image and the second execution image overlap each other, only the execution image that is located more frontward may be displayed.

An extraction image may refer to an image of an area that is actually displayed on a screen image from among all areas of an execution image. For example, when a first execution image overlaps a second execution image so that the first execution image is located over a second execution image, only the first execution image may be displayed. In this case, when the first execution image is partially overlapped on the second execution image, an extraction image of the second execution image may refer to an image of an area that does not overlap the first execution image and is actually displayed on a screen image from among all areas of the second execution image.

The image information obtainer 22 according to an embodiment may obtain an extraction image of each execution image. For example, when three execution windows are displayed on a screen image, the image information obtainer 22 may discriminate an area where the three execution windows are actually displayed on a screen, and may obtain a first extraction image for a first execution window, a second extraction image for a second execution window, and a third extraction image for a third execution window.

The image information obtainer 22 according to an embodiment may obtain information about a non-extraction image that is an image of an external area of an extraction image and has a pixel value determined by using a preset method. In this case, the decoder 23 according to an embodiment may decode the information about the non-extraction image by using a preset method. For example, the decoder 23 may decode the non-extraction image by using a decoding method corresponding to the extraction image.

A non-extraction image may be the opposite concept to an extraction image. For example, a non-extraction image may refer to an image of an area where an extraction image is not displayed on a screen image. A plurality of extraction images may be displayed on a screen.

A screen according to an embodiment may display a first extraction image for a first execution window, a second extraction image for a second execution window, and a third extraction image for a third execution window. In this case, an image of an area other than an area occupied by the first extraction image on the screen may be referred to as a non-extraction image of the first extraction image. An image used to decode the first extraction image may be a first image with a screen image size obtained by combining the first extraction image and the non-extraction image of the first extraction image. In this manner, a second image and a third image may be obtained.

An image obtained by combining an extraction image and a non-extraction image may be referred to as a layer image. For example, in the above embodiment, the first image may be a layer image of the first extraction image. A layer image according to an embodiment may refer to an image with a screen image size obtained by combining an extraction image and a non-extraction image of the extraction image.

A non-extraction image may be determined based on an extraction image. For example, when a first extraction image is a JPEG image, a non-extraction image of the first extraction image may have a pixel value of 128. Alternatively, when a first extraction image is a JPEG image, pixel values of non-extraction image pixels included in a non-extraction image of the first extraction image may be determined by using a pixel value of the first extraction image that is the most close to each non-extraction image pixel.

A non-extraction image of a second extraction image may be determined based on a type of the second extraction image. Since a non-extraction image is not displayed to a user, encoding or decoding may be simply selected and used. For simple encoding or decoding, a non-extraction image of a second extraction image may be determined according to a type of the second extraction image. For example, when a second extraction image is a video, a method of encoding and decoding a non-extraction image of the second extraction image may be determined in consideration of a level of image quality, whether the second extraction image is coded by using a specific method, whether a ratio of text included in the second extraction image is equal to or greater than a predetermined ratio, and/or whether a ratio of an image included in the second extraction image is equal to or greater than a predetermined ratio.

The image information obtainer 22 according to an embodiment may obtain instruction information for discriminating an area corresponding to an extraction image from an area corresponding to a non-extraction image on a screen image, and may obtain the extraction image and the non-extraction image from the screen image based on the instruction information.

Instruction information according to an embodiment may be obtained for each pixel or may be obtained for each block with a preset size.

For example, information about whether each of pixels of a layer image is a pixel displayed on a screen may be encoded or decoded as instruction information.

Alternatively, information about whether each of blocks of a layer image is a block displayed on a screen may be encoded or decoded as instruction information.

Instruction information according to an embodiment may be mask information for discriminating an area that is displayed from an area that is not displayed on a layer image.

Also, the image information obtainer 22 according to an embodiment may obtain an extraction image from a layer image based on instruction information. For example, the image information obtainer 22 may divide a layer image into an extraction image and a non-extraction image based on instruction information. The decoder 23 according to an embodiment may decode an extraction image by using a decoding method corresponding to the extraction image.

The decoder 23 according to an embodiment may decode an extraction image based on a type of the extraction image. Accordingly, the decoder 23 may apply an adaptive decoding method to each of a plurality of extraction images constituting one screen image.

For example, when a first extraction image for video reproduction, a second extraction image for a JPEG image, and a third extraction image for a word document are included in a screen image, the decoder 23 may decode the first extraction image by using a decoding method that is suitable to decode a video, may decode the second extraction image by using a decoding method that is suitable to decode a still image, and may decode the third extraction image by using a decoding method that is suitable to decode text. A method of encoding each extraction image may be easily selected by one of ordinary skill in the art.

The decoder 23 according to an embodiment may determine whether an execution image is for a still image and may decode an extraction image by using a decoding method determined based on a result of the determination.

The decoder 23 according to an embodiment may decode an extraction image based on a type of the extraction image. Accordingly, the decoder 23 may apply an adaptive decoding method to each of a plurality of extraction images constituting one screen image.

In this case, the decoder 23 may determine a decoding method based on whether an extraction image is for a still image. A still image may refer to a static image excluding text or the like. Even when an extraction image for a video is an image at a pause point, the extraction image may be regarded as a still image.

The decoder 23 according to an embodiment may determine whether an execution image is for a video and may decode an extraction image by using a decoding method determined based on a result of the determination.

The decoder 23 according to an embodiment may decode an extraction image based on whether extraction image is a video. Accordingly, the decoder 23 may apply an adaptive decoding method to each of a plurality of extraction images constituting one screen image.

The decoder 23 according to an embodiment may separate a codec for a video and a codec for other images and may differently use the codecs to decode an extraction image. Since a codec for a video is more complex than a codec for an image other than a video, the decoder 23 according to an embodiment may decode an extraction image for a video by using a hardware accelerator that is being developed for a video codec. The decoder 23 according to an embodiment may decode an extraction image for a video by using a video codec and may decode an extraction image for a still image by using a codec for a still image.

A codec used by the decoder 23 may include at least one of a codec for encoding or decoding a video area, an existing PNG codec for encoding graphic data to encode or decode a still image, an existing run-length coding-based codec, and a non-standard codec for encoding or decoding an area other than an image.

FIG. 4E is a block diagram of the image decoding apparatus 21 for decoding a screen image according to another embodiment.

As shown in FIG. 4E, the image decoding apparatus 21 may include a demultiplexer 24, an area mask reconstructor 25, an area decoder 26, and a reconstructed screen layout unit 27. However, the image decoding apparatus 21 may include more elements than those illustrated in FIG. 4E or may include fewer elements than those illustrated in FIG. 4E.

The demultiplexer 24 according to an embodiment may receive a bitstream, may parse instruction information, and may transmit the instruction information to the area mask reconstructor 25. Also, the demultiplexer 24 according to an embodiment may parse codec information used to decode a layer image and encoding data of the layer image from the received bitstream and may transmit the codec information and the encoding data to the area decoder 26.

The area mask reconstructor 25 according to an embodiment may discriminate an area of an extraction image from an area of a non-extraction image on each layer image by using instruction information received from the demultiplexer 24.

The area decoder 26 according to an embodiment may decode layer images according to a decoding method corresponding to each layer image by using codec information used to decode each layer image and encoding data for each layer image received from the demultiplexer 24. A pixel value of an external area of a reconstructed layer image may be a preset value.

The reconstructed screen layout unit 27 according to an embodiment may reconstruct an entire image by using reconstructed instruction information and a reconstructed layer image. For example, the reconstructed screen layout unit 27 may reconstruct an entire image by extracting only a part that is displayed by using instruction information from reconstructed layer images.

FIG. 4F is a flowchart of a method of decoding a screen image according to an embodiment.

In operation S44, the image decoding apparatus 21 according to an embodiment may obtain information about an extraction image of an area that is displayed on a screen image from among all areas of an execution image that is an image showing a program that is being executed.

In operation S45, the image decoding apparatus 21 according to an embodiment may obtain information about a non-extraction image that is an image of an external area of the extraction image and has a pixel value determined by using a preset method.

In operation S46, the image decoding apparatus 21 according to an embodiment may decode the extraction image by using a decoding method corresponding to the extraction image.

In operation S47, the image decoding apparatus 21 according to an embodiment may decode the information about the non-extraction image by using a preset method.

FIG. 5A is a view for explaining a screen image 54 according to an embodiment.

The screen image 54 may include an icon 51, a video execution window 52, a first execution window 53, and a second execution window 55. In this case, the screen image 54 may display only a part of each execution window.

FIG. 5B is a view for explaining an image showing a program that is being executed according to an embodiment.

FIG. 5B illustrates execution images. An execution image may refer to an image showing a program that is being executed. For example, a first execution image 56 may be an image displayed by a web browser program, a second execution image 57 may be an image displayed by a video reproduction program, a third execution image 58 may be an image displayed by an editing program, and a fourth execution image 59 may be an image displayed by a search program.

FIG. 5C is a view for explaining a screen image according to an embodiment.

A screen image may include a plurality of execution images. Also, when the first execution image 56 and the second execution image 57 overlap each other, only a part of the second execution image may be displayed.

When corresponding areas of the first execution image 56 through the fourth execution image 59 overlap one another, only a part of each execution image may be displayed on a screen image.

FIG. 5D is a view for explaining a screen image according to an embodiment.

A screen image may include a plurality of areas. For example, a screen image may include an area A through an area F.

For example, each area may be discriminated based on an encoding or decoding method. For example, a method of encoding or decoding the area A and a method of encoding or decoding the area B may be different from each other. However, methods of encoding or decoding the area A located on an upper left side and the area A located on a lower right side may be the same.

Alternatively, each area may be discriminated based on whether the area relates to the same execution image. Although there are two areas A, the areas A may relate to one execution image. One execution image may be displayed on two or more divided areas.

Alternatively, each area may be discriminated based on a used program. For example, a program for executing the area A and a program for executing the area B may be different from each other. Programs for executing the area A located on the upper left side and the area A located on the lower right side may be the same. A plurality of areas may be displayed by the same program. Although there are two areas A, the areas A may be controlled by one program.

Each area may be divided into a title bar area and a content area. For example, a block located on a lower left side may be divided into the area F on an upper side and the area B located on a lower side. The area F may be a title bar area and the area B may be a content area.

An execution image according to an embodiment may be the same as the area described with reference to FIG. 5D. However, the execution image is not limited thereto.

FIG. 5E is a view for explaining an extraction image of an area that is displayed on a screen image from among all areas of an execution image according to an embodiment.

When each area is an execution image, FIG. 5E illustrates an extraction image of the area A.

A hatched area is a layer image including an image that is actually displayed on a screen image.

FIG. 5F is a view for explaining an extraction image of an area that is displayed on a screen image from among all areas of an execution image according to an embodiment.

When each area is an execution image, FIG. 5F illustrates an extraction image of the area D.

A hatched area is a layer image including an image that is actually displayed on a screen image.

FIG. 5G is a view for explaining a method of forming an entire screen image by using an extraction image of an area that is displayed on a screen image from among all areas of an execution image according to an embodiment.

For example, a screen image may include three areas. In this case, the screen image may be reconstructed from three layer images.

An extraction image according to an embodiment may refer to an image of an area that is displayed on a screen image from among all areas of an execution image. For example, a first extraction image 61 may be an image of an area that is actually displayed on a screen image from among areas of an execution image executed by a video reproduction program.

A non-extraction image according to an embodiment may refer to an image of an area where an extraction image is not displayed on a screen image. For example, a first non-extraction image 62 may refer to an image of an area where the first extraction image 61 is not displayed on a screen image.

A layer image according to an embodiment may refer to an image with a screen image size obtained by combining an extraction image and a non-extraction image. For example, a first layer image 60 may include the first extraction image and the first non-extraction image 62.

The image decoding apparatus 21 according to an embodiment may obtain a reconstructed image 65 by extracting extraction images from the first layer image 60, a second layer image 63, and a third layer image 64 and combining the extraction images.

It will be understood by one of ordinary skill in the art that the description of the encoding method made with reference to FIGS. 4A through 5G may apply to a decoding method corresponding to the encoding method. Also, it will be understood by one of ordinary skill in the art that the description of the decoding method made with reference to FIGS. 4A through 5G may apply to an encoding method corresponding to the decoding method.

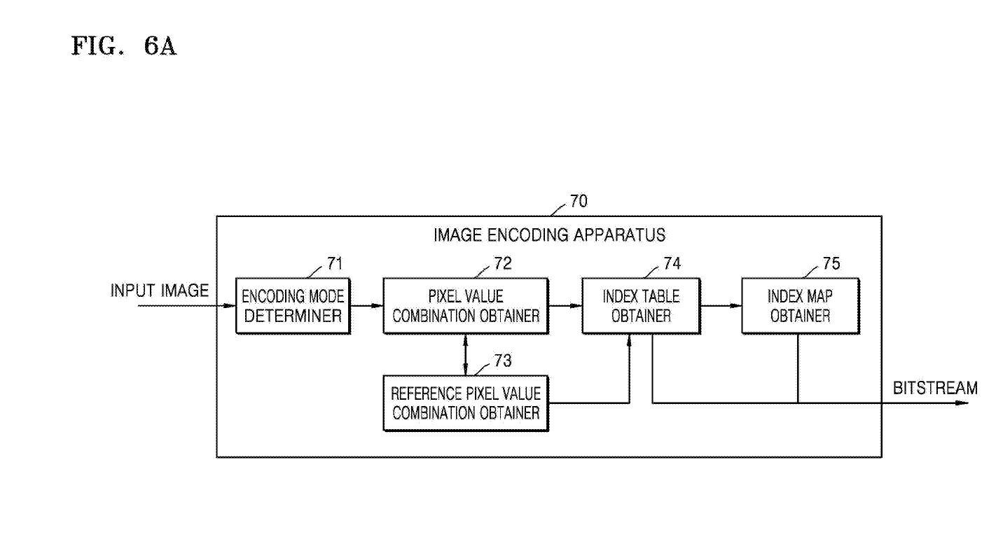

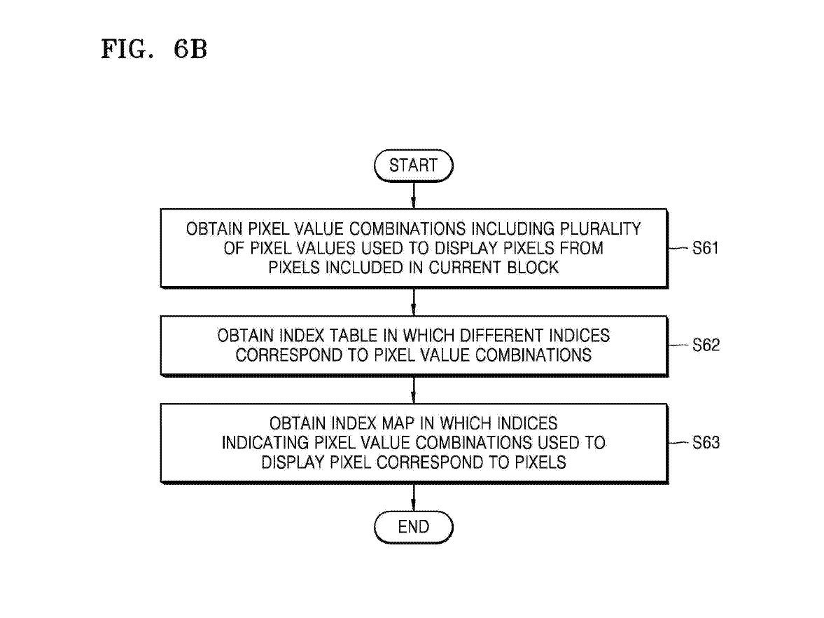

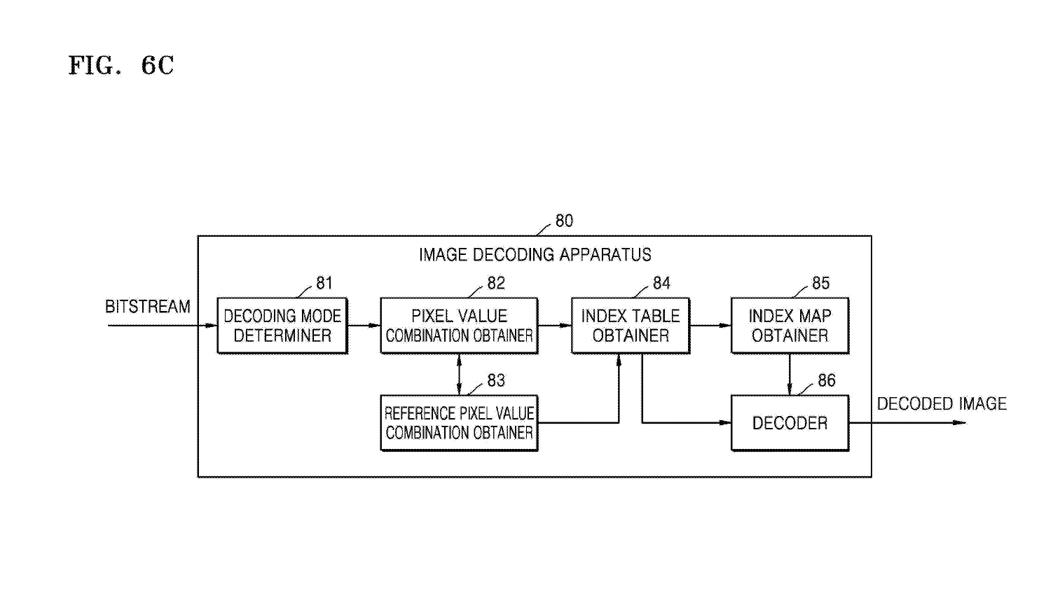

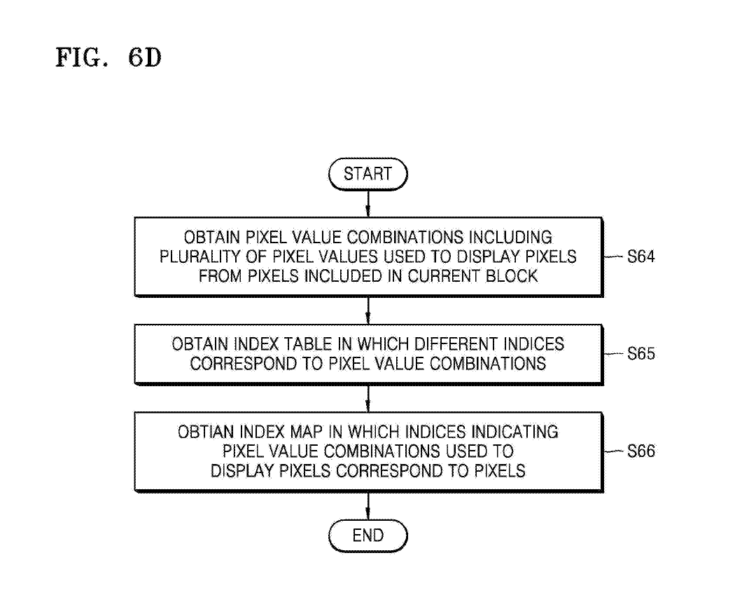

FIG. 6A is a block diagram of an image encoding apparatus 70 for encoding a screen image according to an embodiment.

As shown in FIG. 6A, the image encoding apparatus 70 may include an encoding mode determiner 71, a pixel value combination obtainer 72, a reference pixel value combination obtainer 73, an index table obtainer 74, and an index map obtainer 75. However, the image encoding apparatus 70 may include more elements than those illustrated in FIG. 6A or may include fewer elements than those illustrated in FIG. 6A.

The encoding mode determiner 71 may determine an encoding mode used to encode an input image. For example, the encoding mode determiner 71 may determine an encoding method based on a distortion ratio according to the encoding method. The encoding mode determiner 71 according to an embodiment may determine which method is more efficient to encode an input image from among a lossless method and a lossy method. The lossless method may include an interleaved pulse code modulation (PCM) mode.

According to an embodiment, the following embodiment will be explained on the assumption that encoding is performed in an interleaved PCM mode. However, the embodiment is exemplary and it should not be construed as being limited thereto.

The image encoding apparatus 70 may generate information indicating whether the image encoding apparatus 70 operates in an interleaved PCM mode to encode a received input image. For example, when the image encoding apparatus operates in an interleaved PCM mode, the image encoding apparatus 70 may set a value of an interleaved PCM mode flag to 1.

The image encoding apparatus 70 according to an embodiment may perform encoding only in an interleaved PCM mode. However, the embodiment is exemplary and it should not be construed as being limited thereto.

The image encoding apparatus 70 according to another embodiment may perform encoding by using a general lossy method.

The pixel value combination obtainer 72 according to an embodiment may obtain pixel value combinations including a plurality of pixel values used to display a pixel from pixels included in a current block that is encoded.

There may be a plurality of pixel values used to display a pixel. For example, in order to display a first pixel, a red pixel value, a green pixel value, and a blue pixel value of the first pixel may be required. Alternatively, in order to display a second pixel, a luminance value and chrominance values of the second pixel may be required.

Accordingly, the pixel value combination obtainer 72 may obtain pixel value combinations used to display pixels included in a current block and may store the pixel value combinations in a first buffer (not shown). For example, the pixel value combination obtainer 72 may store a first pixel value combination including a red pixel value, a green pixel value, and a blue pixel value required to display a first pixel and a second pixel value combination including a red pixel value, a green pixel value, and a blue pixel value required to display a second pixel in the first buffer. The first pixel and the second pixel may be pixels included in the current block. The pixel value combination obtainer 72 may obtain pixel value combinations of all pixels included in the current block and may store the pixel value combinations in the first buffer.

The reference pixel value combination obtainer 73 according to an embodiment may obtain a reference pixel value combination including a plurality of reference pixel values used to display a reference pixel from each reference pixel included in a reference block encoded prior to the current block. A method performed by the reference pixel value obtainer 73 to obtain a reference pixel value combination may correspond to an operation of the pixel value combination obtainer 72. Also, the reference pixel value combination obtainer 73 may store the obtained reference pixel value combination in a second buffer (not shown).

The index table obtainer 74 according to an embodiment may obtain an index table in which different indices correspond to pixel value combinations. The index table obtainer 74 according to an embodiment may obtain an index table by using a pixel value combination and a reference pixel value combination.

An index table according to an embodiment may refer to a table in which indices correspond to pixel value combinations used to display a current block. For example, when RGB value combinations for displaying 9 pixels constituting a current block include a first combination (having RGB values of 255, 255, and 255), a second combination (having RGB values of 0, 0, and 0), and a third combination (having RGB values of 0, 0, and 255), an index 0, an index 1, and an index 2 may be respectively applied to the first combination, the second combination, and the third combination.

In order to obtain an index table, the index table obtainer 74 according to an embodiment may use a pixel value combination stored in the first buffer and a reference pixel value combination stored in the second buffer. For example, the index table obtainer 74 may store a pixel value combination, which is not stored in the second buffer and is stored in the first buffer, in the second buffer, may delete a reference pixel value combination, which is not stored in the first buffer and is stored in the second buffer, from the second buffer, and may update reference pixel value combinations stored in the second buffer. The index table obtainer 74 may obtain an index table by assigning different indices to the updated reference pixel combinations stored in the second buffer.

The index map obtainer 75 according to an embodiment may obtain an index map in which indices indicating pixel value combinations used to display pixels correspond to pixels included in a current block. For example, an index map may be obtained so that indices indicating pixel value combinations of pixels correspond to all pixels included in a current block.

FIG. 6B is a flowchart of a method of encoding a screen image according to an embodiment.

In operation S61, the image encoding apparatus 70 according to an embodiment may obtain pixel value combinations including a plurality of pixel values used to display pixels from pixels included in a current block.

In operation S62, the image encoding apparatus 70 according to an embodiment may obtain an index table in which different indices correspond to the pixel value combinations.

In operation S63, the image encoding apparatus 70 according to an embodiment may obtain an index map in which indices indicating pixel value combinations used to display pixels correspond to the pixels included in the current block.

FIG. 6C is a block diagram of an image decoding apparatus 80 for decoding a screen image according to an embodiment.

As shown in FIG. 6C, the image decoding apparatus 80 may include a decoding mode determiner 81, a pixel value combination obtainer 82, a reference pixel value combination obtainer 83, an index table obtainer 84, an index map obtainer 85, and a decoder 86. However, the image decoding apparatus 80 may include more elements than those illustrated in FIG. 6C or may include fewer elements than those illustrated in FIG. 6C.

The decoding mode determiner 81 may receive a bitstream and may determine whether to perform decoding by using a method according to the present invention.

For example, the decoding mode determiner 81 may determine a decoding method based on a distortion ratio according to the decoding method. The decoding mode determiner 81 according to an embodiment may determine which method is more efficient to decode an input image from among a lossless method and a lossy method. The lossless method may include an interleaved PCM mode.

According to an embodiment, the following embodiment will be explained on the assumption that decoding is performed in an interleaved PCM mode. However, the embodiment is exemplary and it should not be construed as being limited thereto.

The decoding mode determiner 81 may determine whether the image decoding apparatus 80 operates in an interleaved PCM mode from a received bitstream. For example, when a value of an interleaved PCM mode flag is 1, the image decoding apparatus 80 may operate in an interleaved PCM mode.

The image decoding apparatus 80 according to an embodiment may perform decoding only in an interleaved PCM mode. However, the embodiment is exemplary and it should not be construed as being limited thereto.

When a value of an interleaved PCM mode flag is 0, decoding may be performed by using a general lossy method.

The pixel value combination obtainer 82 according to an embodiment may obtain pixel value combinations including a plurality of pixel values used to display pixels form pixels included in a current block that is decoded.

There may be a plurality of pixel values used to display a pixel. For example, in order to display a first pixel, a red pixel value, a green pixel value, and a blue pixel value of the first pixel may be required. Alternatively, in order to display a second pixel, a luminance value and chrominance values of the second pixel may be required.

Accordingly, the pixel value combination obtainer 82 may obtain pixel value combinations used to display pixels included in a current block and may store the pixel value combinations in a first buffer (not shown). For example, the pixel value combination obtainer 82 may store a first pixel value combination including a red pixel value, a green pixel value, and a blue pixel value required to display a first pixel and a second pixel value combination including a red pixel value, a green pixel value, and a blue pixel value required to display a second pixel in the first buffer. The first pixel and the second pixel may be pixels included in the current block. The pixel value combination obtainer 82 may obtain pixel value combinations of all pixels included in the current block and may store the pixel value combinations in the first buffer.

The reference pixel value combination obtainer 83 according to an embodiment may obtain a reference pixel value combination including a plurality of reference pixel values used to display a reference pixel from each reference pixel included in a reference block encoded prior to the current block. A method performed by the reference pixel value obtainer 83 to obtain a reference pixel value combination may correspond to an operation of the pixel value combination obtainer 82. Also, the reference pixel value combination obtainer 83 may store the obtained reference pixel value combination in a second buffer (not shown).

The index table obtainer 84 according to an embodiment may obtain an index table in which different indices correspond to pixel value combinations. The index table obtainer 84 according to an embodiment may obtain an index table by using a pixel value combination and a reference pixel value combination.

An index table according to an embodiment may refer to a table in which indices correspond to pixel value combinations used to display a current block. For example, when RGB value combinations for displaying 9 pixels constituting a current block include a first combination (having RGB values of 255, 255, and 255), a second combination (having RGB values of 0, 0, and 0), and a third combination (having RGB values of 0, 0, and 255), an index 0, an index 1, and an index 2 may be respectively applied to the first combination, the second combination, and the third combination.

In order to obtain an index table, the index table obtainer 84 according to an embodiment may use a pixel value combination stored in the first buffer and a reference pixel value combination stored in the second buffer. For example, the index table obtainer 84 may store a pixel value combination, which is not stored in the second buffer and is stored in the first buffer, in the second buffer, may delete a reference pixel value combination, which is not stored in the first buffer and is stored in the second buffer, from the second buffer, and may update reference pixel value combinations stored in the second buffer. The index table obtainer 84 may obtain an index table by assigning different indices to the updated reference pixel combinations stored in the second buffer.

The index map obtainer 85 according to an embodiment may obtain an index map in which indices indicating pixel value combinations used to display pixels correspond to pixels included in a current block. For example, an index map may be obtained so that indices indicating pixel value combinations of pixels correspond to all pixels included in a current block.

The decoder 86 according to an embodiment may decode the current block by using the index table obtained from the index table obtainer 84 and the index map obtained from the index map obtainer 85.

The decoder 86 according to an embodiment may decode the current block by using a counter value indicating the number of added pixel value combinations as well as the index table and the index map.

A pixel value combination may refer to a combination of a plurality of pixel values used to display a pixel.

When there is one pixel value combination of pixels constituting a current block is 1 and encoding is performed in an interleaved PCM mode, the image encoding apparatus 70 according to an embodiment may set a value of an interleaved PCM mode flag to 1 and may store the pixel value combination in the first buffer. The image encoding apparatus 70 may transmit data stored in the first buffer, the interleaved PCM mode flag, and the number of pixel value combinations stored in the first buffer.

The image decoding apparatus 80 according to an embodiment checks that the value of the interleaved PCM mode flag is 1 by decoding the interleaved PCM mode flag and parses the number of the pixel value combinations. Since the number of the pixel value combinations is 1, the image decoding apparatus 80 may obtain a plurality of pixel values from the pixel value combinations stored in the first buffer and may display the current block with pixels having the same value.

When there are two pixel value combinations of pixels constituting a current block and encoding is performed in an interleaved PCM mode, the image encoding apparatus 70 according to an embodiment may set a value of an interleaved PCM mode flag to 1. The image encoding apparatus 70 may store the number of pixel value combinations stored in the first buffer and two pixel value combinations in the first buffer. The image encoding apparatus 70 generates an index map according to a scan order of the pixels included in the current block. The image encoding apparatus 70 may transmit data stored in the first buffer, the interleaved PCM mode flag, and the number of the pixel value combinations stored in the first buffer.

The image decoding apparatus 80 according to an embodiment checks that the value of the interleaved PCM mode flag is 1 by decoding the interleaved PCM mod flag and parses the number of the pixel value combinations. Since the number of the pixel value combinations is 2, the image decoding apparatus 80 may decode two pixel value combinations. The image decoding apparatus 80 may decode an index map, may decode pixel values according to a scan order by using the decoded index map, and may decode the current block.

The image encoding apparatus 70 according to an embodiment may perform encoding in an interleaved PCM mode by using reference pixel value combinations.

When pixel value combinations of a current block are included in reference pixel value combinations, the image encoding apparatus 70 according to an embodiment may set a value of an interleaved PCM mode flag to 1 and may set a counter value indicating the number of pixel value combinations that are newly added to 0. The image encoding apparatus may encode an index map by using only the reference pixel value combinations. The image encoding apparatus 70 according to an embodiment may encode and transmit the interleaved PCM mode flag, the counter value, and the index map. In this case, the image encoding apparatus 70 may omit encoding the pixel value combinations.

The image decoding apparatus 890 according to an embodiment may check that the value of the interleaved PCM mode flag is 1 (enable) by parsing the interleaved PCM mode flag and may check that the counter value is 0 by parsing the counter value. The image decoding apparatus 80 may decode the current block by using the reference pixel value combinations.

When pixel value combinations and reference pixel value combinations of the current block are the same, encoding and decoding may be performed in the same manner as that described when pixel value combinations of the current block are included in reference pixel value combinations.

When reference pixel value combinations are included in pixel value combinations of a current block, the image encoding apparatus 70 according to an embodiment may set a value of an interleaved PCM mode flag to 1 and may set a counter value indicating the number of pixel value combinations that are newly added to the number of added pixel value combinations. The image encoding apparatus may obtain an index table and an index map. The image encoding apparatus 70 according to an embodiment may encode and transmit the interleaved PCM mode flag, the counter value, the index table, and the index map.

The image decoding apparatus 80 according to an embodiment may check that the value of the interleaved PCM mode flag is 1 (enable) by parsing the interleaved PCM mode flag and may check that the counter value is not 0 by parsing the counter value. The image decoding apparatus 80 may decode the current block by using the index table and the index map that are obtained through decoding.

When only some of reference pixel value combinations are included in pixel value combinations of a current block, the image encoding apparatus 70 according to an embodiment may set a value of an interleaved PCM mode flag to 1. The image encoding apparatus 70 may obtain an index table by excluding non-included reference pixel value combinations and adding newly added pixel value combinations. The image encoding apparatus 70 may obtain an index map by using the index table. The image encoding apparatus 70 according to an embodiment may encode and transmit the interleaved PCM mode flag, the index table, and the index map.

The image decoding apparatus 80 according to an embodiment may check that the value of the interleaved PCM mode flag is 1 (enable) by parsing the interleaved PCM mode flag. The image decoding apparatus 80 may decode the current block by using the index table and the index map that are obtained through decoding.

The interleaved PCM mode flag and the counter value in the above embodiment are not essential elements and may be omitted if necessary.

FIG. 6D is a flowchart of a method of decoding a screen image according to an embodiment.

In operation S64, the image decoding apparatus 80 according to an embodiment may obtain pixel value combinations including a plurality of pixel values used to display pixels from pixels included in a current block.

In operation S65, the image decoding apparatus 80 according to an embodiment may obtain an index table in which different indices correspond to the pixel value combinations.

In operation S66, the image decoding apparatus 80 according to an embodiment ma obtain an index map in which indices indicating pixel value combinations used to display pixels correspond to the pixels included in the current block.

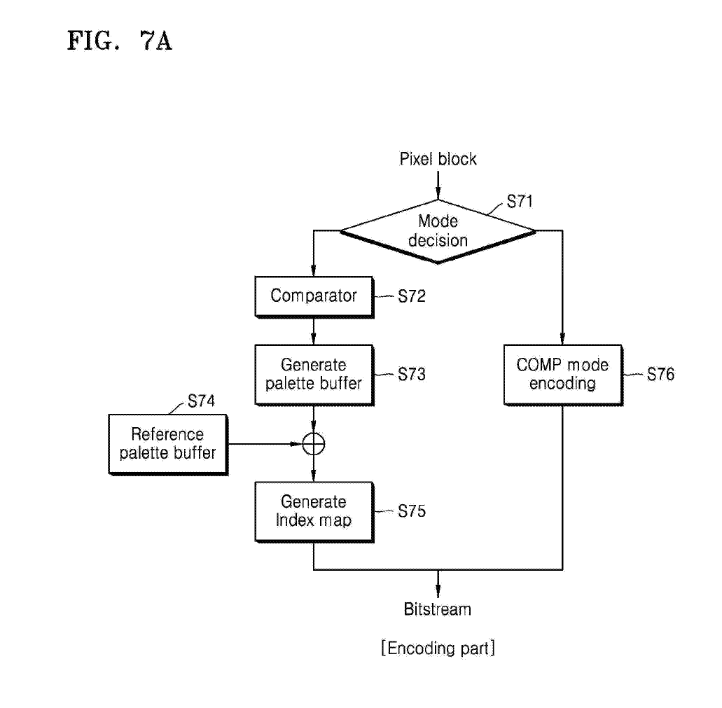

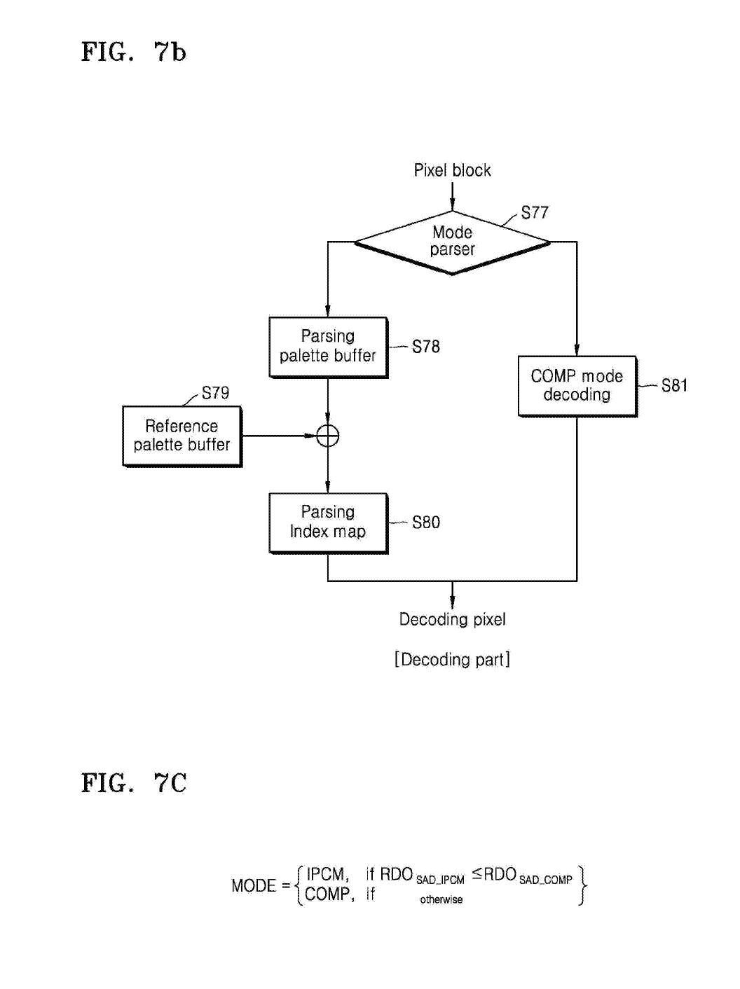

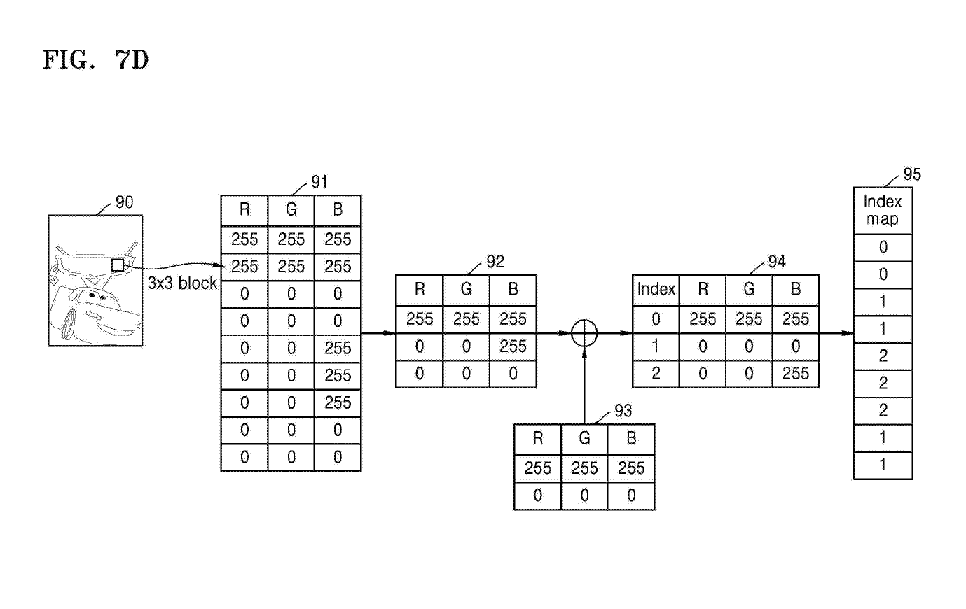

FIG. 7A is a flowchart of a method of encoding a screen image according to an embodiment.

In operation S71, the image encoding apparatus 70 according to an embodiment may determine an encoding mode used to encode an input image. For example, the image encoding apparatus 70 may determine an encoding method based on a distortion ratio according to the encoding method. The image encoding apparatus 70 according to an embodiment may determine which method is more efficient to encode an input image from among a lossless method and a lossy method. The lossless method may include an interleaved PCM mode.

In operation S72, the image encoding apparatus 70 according to an embodiment may obtain pixel value combinations including a plurality of pixel values used to display pixels from pixels included in a current block that is encoded.

In operation S73, the image encoding apparatus 70 according to an embodiment may store the pixel value combinations obtained in operation S72 in a first buffer.

In operation S74, the image encoding apparatus 70 according to an embodiment may obtain reference pixel value combinations including a plurality of reference pixel values used to display reference pixels from reference pixels included in a reference block that is encoded prior to the current block.

Also, although not shown in FIG. 7A, the image encoding apparatus 70 according to an embodiment may obtain an index table by using the pixel value combinations stored in operation S73 and the reference pixel value combinations obtained in operation S74.

In operation S75, the image encoding apparatus 70 according to an embodiment may obtain an index map in which indices indicating pixel value combinations used to display pixels correspond to the pixels included in the current block. The index map according to an embodiment may be obtained so that indices indicating pixel value combinations of pixels correspond to all pixels included in the current block.

In operation S76, the image encoding apparatus 70 according to an embodiment may encode the current block by using a lossy encoding method.

FIG. 7B is a flowchart of a method of decoding a screen image according to an embodiment.

In operation S77, the image decoding apparatus 80 according to an embodiment may receive a bitstream and may determine whether to perform decoding by using a method according to the present invention.

For example, the image decoding apparatus 80 may determine a decoding method based on a distortion ratio according to the decoding method. The image decoding apparatus 80 according to an embodiment may determine which method is more efficient to decode the received bitstream from among a lossless method and a lossy method. The lossless method may include an interleaved PCM mode.

In operation S78, the image decoding apparatus 80 according to an embodiment may obtain pixel value combinations including a plurality of pixel values used to display pixels from pixels included in a current block that is decoded. The image decoding apparatus 80 according to an embodiment may parse the received bitstream and may obtain pixel value combinations used to decode the current block stored in a first buffer.

In operation S79, the image decoding apparatus 80 according to an embodiment may obtain reference pixel value combinations including a plurality of reference pixel values used to display reference pixels from reference pixels included in a reference block that is decoded prior to the current block. The image decoding apparatus 80 according to an embodiment may obtain reference pixel value combinations by parsing the received bitstream. The reference pixel value combinations may be stored in a second buffer.

Also, although not shown in FIG. 7B, the image decoding apparatus 80 according to an embodiment may obtain an index table by using the pixel value combinations obtained in operation S78 and the reference pixel value combinations obtained in operation S79. Alternatively, the image decoding apparatus 80 according to an embodiment may obtain an index table by parsing the received bitstream.

In operation S80, the image decoding apparatus 80 according to an embodiment may obtain an index map in which indices indicating pixel combinations used to display pixels correspond to the pixels included in the current block. The index map may be obtained so that indices indicating pixel value combinations of pixels correspond to all pixels included in the current block. The image decoding apparatus 80 according to an embodiment may obtain an index map by parsing the received bitstream.

In operation S81, the image decoding apparatus 80 according to an embodiment may decode the current block by using a lossy decoding method.

FIG. 7C is a diagram for explaining a method of determining a method of encoding a screen image according to an embodiment.

As shown in FIG. 7C, the image encoding apparatus 70 may determine an encoding method used to encode a current block according to a distortion ratio according to the encoding method.

For example, the image encoding apparatus 70 may perform encoding by using an encoding method with a lower rate-distortion (RDO) value according to a SAD. The image encoding apparatus 70 according to an embodiment may perform encoding by using a method with a lower distortion ratio from among an interleaved PCM mode and a general lossy compression mode.

FIG. 7D is a diagram for explaining a method of encoding a screen image according to an embodiment.

A size of a current block included in a current image may be 3×3. Accordingly, the number of pixels constituting the current block may be 9. A pixel value table 91 shows RGB values used to display pixels constituting the current block according to pixels. For example, as shown in FIG. 7D, a first pixel and a second pixel each have RGB values of 255, 255, and 255, a third pixel, a fourth pixel, an eighth pixel, and a ninth pixel each have RGB values of 0, 0, and 0, and a fifth pixel, a sixth pixel, and a seventh pixel each have RGB vales of 0, 0, and 255.

The image encoding apparatus 70 according to an embodiment may obtain a pixel value combination table 92 by extracting pixel value combinations from the pixel value table 91. For example, the image encoding apparatus 70 may obtain the pixel value combination table 92 by extracting pixel value combinations from the pixel value table 91 not to have repeated pixel value combinations.

For example, as shown in FIG. 7D, a first combination having RGB values of 255, 255, and 255, a second combination having RGB values of 0, 0, and 255, and a third combination having RGB values of 0, 0, and 0 may be included in the pixel value combination table 92. The first combination, the second combination, and the third combination may indicate all pixels in the pixel value table 91 without repetition.

The image encoding apparatus 70 according to an embodiment may store the pixel value combination table 92 in a first buffer (not shown).

The image encoding apparatus 70 according to an embodiment may obtain a reference pixel value combination table 93 for a reference block encoded prior to the current block by referring to a method of obtaining the pixel value combination table 92. For example, the reference pixel value combination table 93 may store RGB value combinations of pixels constituting a reference block encoded prior to the current block without repetition.

For example, pixel value combinations of a reference block encoded prior to the current block may include a first combination having RGB values of 255, 255, and 255 and a third combination having RGB values of 0, 0, and 0.

The image encoding apparatus 70 according to an embodiment may store the reference pixel value combination table 93 in a second buffer (not shown).

The image encoding apparatus 70 according to an embodiment may obtain an index table 94. The index table may refer to a table in which different indices correspond to pixel value combinations included in the pixel value combination table 92.

For example, the index table may be obtained so that indices 0, 1, and 2 respectively correspond to the first combination, the second combination, and the third combination included in the pixel value combination table.

The image encoding apparatus 70 according to an embodiment may obtain the index table 94 by using the pixel value combination table 92 and the reference pixel value combination table 93.

In order to obtain the index table 94, the image encoding apparatus 70 according to an embodiment may obtain the index table 94 including both the ‘second combination’ that is a pixel value combination included in the pixel value combination table 92 and not included in the reference pixel value combination table 93 and the ‘first combination and the third combination’ that are pixel value combinations included in pixel value combination table 92 and the reference pixel value combination table 93.

In order to obtain the index table 94, the image encoding apparatus 70 according to an embodiment may obtain the index table 94 by adding the ‘second combination’ that is a pixel value combination included in the pixel value combination table 92 and not include in the reference pixel value combination table 93 to the reference pixel value combination table 93 and by excluding a combination included in the reference pixel value combination table 93 and not included in the pixel value combination table 92.

Since the reference pixel value combination table 93 is used to obtain the index table 94, the number of encoded bits may be reduced. An object to be encoded may be the index table 94 and an index map 95. Accordingly, when the reference pixel combination table 93 used to encode the reference block encoded prior to the current block is used, the number of encoded bits may be reduced.

The image encoding apparatus 70 according to an embodiment may obtain the index map 95 by using the index table 94. An index map may refer to a table in which indices indicating pixel value combinations correspond to pixels included in a current block. The image decoding apparatus 80 may obtain a pixel by using an index corresponding to a plurality of pixel values for displaying the pixel.

For example, the index map 95 may assign an index 0 to the first pixel and the second pixel, an index 1 to the third pixel, the fourth pixel, the eighth pixel, and the ninth pixel, and an index 2 to the fifth pixel through the seventh pixel. Since the index 0 indicates 255, 255, and 255, the index 1 indicates 0, 0, and 0, and the index 2 indicates 0, 0, and 255, RGB values for indicating pixels included in the current block may be obtained by using only the index table 94 and the index map 95. Accordingly, the image decoding apparatus 80 may reconstruct the current block when the image encoding apparatus 70 according to an embodiment encodes and transmits the index table 94 and the index map 95.

It will be understood by one of ordinary skill in the art that the description of the encoding method made with reference to FIGS. 6A through 7D may apply to a decoding method corresponding to the encoding method and it will be understood by one of ordinary skill in the art that the description of the decoding method made with reference to FIGS. 6A through 7D may apply to an encoding method corresponding to the decoding method.

FIG. 8 is a block diagram of a video encoding apparatus 100 based on coding units according to a tree structure according to an embodiment.

The video encoding apparatus 100 involving video prediction based on coding units according to a tree structure includes a coding unit determiner 120 and an outputter 130. Hereinafter, for convenience of description, the video encoding apparatus 100 involving video prediction based on coding units according to a tree structure according to an embodiment is referred to as ‘the video encoding apparatus 100’.

The coding unit determiner 120 may split a current picture based on a largest coding unit (LCU) that is a coding unit having a maximum size for a current picture of an image. If the current picture is larger than the LCU, image data of the current picture may be split into the at least one LCU. The LCU according to an embodiment may be a data unit having a size of 32×32, 64×64, 128×128, 256×256, etc., wherein a shape of the data unit is a square having a width and length in squares of 2.

A coding unit according to an embodiment may be characterized by a maximum size and a depth. The depth denotes the number of times the coding unit is spatially split from the LCU, and as the depth deepens, deeper coding units according to depths may be split from the LCU to a smallest coding unit (SCU). A depth of the LCU is an uppermost depth and a depth of the SCU is a lowermost depth. Since a size of a coding unit corresponding to each depth decreases as the depth of the LCU deepens, a coding unit corresponding to an upper depth may include a plurality of coding units corresponding to lower depths.

As described above, the image data of the current picture is split into the LCUs according to a maximum size of the coding unit, and each of the LCUs may include deeper coding units that are split according to depths. Since the LCU according to an embodiment is split according to depths, the image data of the space domain included in the LCU may be hierarchically classified according to depths.

A maximum depth and a maximum size of a coding unit, which limit the total number of times a height and a width of the LCU are hierarchically split, may be predetermined.

The coding unit determiner 120 encodes at least one split region obtained by splitting a region of the LCU according to depths, and determines a depth to output a finally encoded image data according to the at least one split region. In other words, the coding unit determiner 120 determines a final depth by encoding the image data in the deeper coding units according to depths, according to the LCU of the current picture, and selecting a depth having the least encoding error. The determined final depth and the encoded image data according to the determined depth are output to the outputter 130.

The image data in the LCU is encoded based on the deeper coding units corresponding to at least one depth equal to or below the maximum depth, and results of encoding the image data are compared based on each of the deeper coding units. A depth having the least encoding error may be selected after comparing encoding errors of the deeper coding units. At least one final depth may be selected for each LCU.

The size of the LCU is split as a coding unit is hierarchically split according to depths, and as the number of coding units increases. Also, even if coding units correspond to the same depth in one LCU, it is determined whether to split each of the coding units corresponding to the same depth to a lower depth by measuring an encoding error of the image data of the each coding unit, separately. Accordingly, even when image data is included in one LCU, the encoding errors may differ according to regions in the one LCU, and thus the final depths may differ according to regions in the image data. Thus, one or more final depths may be determined in one LCU, and the image data of the LCU may be divided according to coding units of at least one final depth.

Accordingly, the coding unit determiner 120 according to an embodiment may determine coding units having a tree structure included in the LCU. The ‘coding units having a tree structure’ according to an embodiment include coding units corresponding to a depth determined to be the final depth, from among all deeper coding units included in the LCU. A coding unit of a final depth may be hierarchically determined according to depths in the same region of the LCU, and may be independently determined in different regions. Similarly, a final depth in a current region may be independently determined from a final depth in another region.

A maximum depth according to an embodiment is an index related to the number of splitting times from a LCU to an SCU. A first maximum depth according to an embodiment may denote the total number of splitting times from the LCU to the SCU. A second maximum depth according to an embodiment may denote the total number of depth levels from the LCU to the SCU. For example, when a depth of the LCU is 0, a depth of a coding unit, in which the LCU is split once, may be set to 1, and a depth of a coding unit, in which the LCU is split twice, may be set to 2. Here, if the SCU is a coding unit in which the LCU is split four times, 5 depth levels of depths 0, 1, 2, 3, and 4 exist, and thus the first maximum depth may be set to 4, and the second maximum depth may be set to 5.

Prediction encoding and transformation may be performed according to the LCU. The prediction encoding and the transformation are also performed based on the deeper coding units according to a depth equal to or depths less than the maximum depth, according to the LCU.

Since the number of deeper coding units increases whenever the LCU is split according to depths, encoding, including the prediction encoding and the transformation, is performed on all of the deeper coding units generated as the depth deepens. For convenience of description, the prediction encoding and the transformation will now be described based on a coding unit of a current depth, in a LCU.

The video encoding apparatus 100 according to an embodiment may variously select a size or shape of a data unit for encoding the image data. In order to encode the image data, operations, such as prediction encoding, transformation, and entropy encoding, are performed, and at this time, the same data unit may be used for all operations or different data units may be used for each operation.

For example, the video encoding apparatus 100 may select not only a coding unit for encoding the image data, but also a data unit different from the coding unit so as to perform the prediction encoding on the image data in the coding unit.

In order to perform prediction encoding in the LCU, the prediction encoding may be performed based on a coding unit corresponding to a final depth, i.e., based on a coding unit that is no longer split to coding units corresponding to a lower depth. Hereinafter, the coding unit that is no longer split and becomes a basis unit for prediction encoding will now be referred to as a ‘prediction unit’. A partition obtained by splitting the prediction unit may include a prediction unit or a data unit obtained by splitting at least one of a height and a width of the prediction unit. A partition is a data unit where a prediction unit of a coding unit is split, and a prediction unit may be a partition having the same size as a coding unit.

For example, when a coding unit of 2N×2N (where N is a positive integer) is no longer split and becomes a prediction unit of 2N×2N, and a size of a partition may be 2N×2N, 2N×N, N×2N, or N×N. Examples of a partition mode include symmetrical partitions that are obtained by symmetrically splitting a height or width of the prediction unit, partitions obtained by asymmetrically splitting the height or width of the prediction unit, such as 1:n or n:1, partitions that are obtained by geometrically splitting the prediction unit, and partitions having arbitrary shapes.

A prediction mode of the prediction unit may be at least one of an intra mode, a inter mode, and a skip mode. For example, the intra mode or the inter mode may be performed on the partition of 2N×2N, 2N×N, N×2N, or N×N. Also, the skip mode may be performed only on the partition of 2N×2N. The encoding is independently performed on one prediction unit in a coding unit, thereby selecting a prediction mode having a least encoding error.

The video encoding apparatus 100 according to an embodiment may also perform the transformation on the image data in a coding unit based not only on the coding unit for encoding the image data, but also based on a data unit that is different from the coding unit. In order to perform the transformation in the coding unit, the transformation may be performed based on a data unit having a size smaller than or equal to the coding unit. For example, the data unit for the transformation may include a data unit for an intra mode and a data unit for an inter mode.

The transformation unit in the coding unit may be recursively split into smaller sized regions in the similar manner as the coding unit according to the tree structure according to an embodiment. Thus, residual image data in the coding unit may be divided according to the transformation unit having the tree structure according to transformation depths.

A transformation depth indicating the number of splitting times to reach the transformation unit by splitting the height and width of the coding unit may also be set in the transformation unit according to an embodiment. For example, in a current coding unit of 2N×2N, a transformation depth may be 0 when the size of a transformation unit is 2N×2N, may be 1 when the size of the transformation unit is N×N, and may be 2 when the size of the transformation unit is N/2×N/2. In other words, the transformation unit having the tree structure may be set according to the transformation depths.

Splitting information according to coding units corresponding to a depth requires not only information about the depth, but also about information related to prediction encoding and transformation. Accordingly, the coding unit determiner 120 not only determines a depth having a least encoding error, but also determines a partition mode in a prediction unit, a prediction mode according to prediction units, and a size of a transformation unit for transformation.

Coding units according to a tree structure in a LCU and methods of determining a prediction unit/partition, and a transformation unit according to an embodiment, will be described in detail below with reference to FIGS. 9 through 19.

The coding unit determiner 120 may measure an encoding error of deeper coding units according to depths by using Rate-Distortion Optimization based on Lagrangian multipliers.

The outputter 130 outputs the image data of the LCU, which is encoded based on the at least one depth determined by the coding unit determiner 120, and information about the splitting information according to the depth, in bitstreams.

The encoded image data may be obtained by encoding the residual image data of an image.

The splitting information according to the depth may include information about the depth, about the partition mode in the prediction unit, the prediction mode, and the splitting of the transformation unit.

The information about the final depth may be defined by using splitting information according to depths, which indicates whether encoding is performed on coding units of a lower depth instead of a current depth. If the current depth of the current coding unit is the depth, image data in the current coding unit is encoded and output, and thus the splitting information may be defined not to split the current coding unit to a lower depth. Alternatively, if the current depth of the current coding unit is not the depth, the encoding is performed on the coding unit of the lower depth, and thus the splitting information may be defined to split the current coding unit to obtain the coding units of the lower depth.

If the current depth is not the depth, encoding is performed on the coding unit that is split into the coding unit of the lower depth. Since at least one coding unit of the lower depth exists in one coding unit of the current depth, the encoding is repeatedly performed on each coding unit of the lower depth, and thus the encoding may be recursively performed for the coding units having the same depth.

Since the coding units having a tree structure are determined for one LCU, and at least one splitting information is determined for a coding unit of a depth, at least one splitting information may be determined for one LCU. Also, a depth of the image data of the LCU may be different according to locations since the image data is hierarchically split according to depths, and thus a depth and splitting information may be set for the image data.

Accordingly, the outputter 130 according to an embodiment may assign corresponding encoding information about a depth and an encoding mode to at least one of the coding unit, the prediction unit, and a minimum unit included in the LCU.

The minimum unit according to an embodiment is a square data unit obtained by splitting the SCU constituting the lowermost depth by 4. Alternatively, the minimum unit according to an embodiment may be a maximum square data unit that may be included in all of the coding units, prediction units, partition units, and transformation units included in the LCU.

For example, the encoding information output by the outputter 130 may be classified into encoding information according to deeper coding units, and encoding information according to prediction units. The encoding information according to the deeper coding units may include the information about the prediction mode and about the size of the partitions. The encoding information according to the prediction units may include information about an estimated direction of an inter mode, about a reference image index of the inter mode, about a motion vector, about a chroma component of an intra mode, and about an interpolation method of the intra mode.

Information about a maximum size of the coding unit defined according to pictures, slices, or GOPs, and information about a maximum depth may be inserted into a header of a bitstream, a sequence parameter set, or a picture parameter set.

Information about a maximum size of the transformation unit permitted with respect to a current video, and information about a minimum size of the transformation unit may also be output through a header of a bitstream, a sequence parameter set, or a picture parameter set. The outputter 130 may encode and output reference information, prediction information, and slice type information related to the prediction.

In the video encoding apparatus 100 according to a simplest embodiment, the deeper coding unit may be a coding unit obtained by dividing a height or width of a coding unit of an upper depth, which is one layer above, by two. In other words, when the size of the coding unit of the current depth is 2N×2N, the size of the coding unit of the lower depth is N×N. Also, the coding unit with the current depth having a size of 2N×2N may include a maximum of 4 of the coding units with the lower depth.

Accordingly, the video encoding apparatus 100 may form the coding units having the tree structure by determining coding units having an optimum shape and an optimum size for each LCU, based on the size of the LCU and the maximum depth determined considering characteristics of the current picture. Also, since encoding may be performed on each LCU by using any one of various prediction modes and transformations, an optimum encoding mode may be determined considering characteristics of the coding unit of various image sizes.

Thus, if an image having a high resolution or a large data amount is encoded in a conventional macroblock, the number of macroblocks per picture excessively increases. Accordingly, the number of pieces of compressed information generated for each macroblock increases, and thus it is difficult to transmit the compressed information and data compression efficiency decreases. However, by using the video encoding apparatus 100, image compression efficiency may be increased since a coding unit is adjusted while considering characteristics of an image while increasing a maximum size of a coding unit while considering a size of the image.

The video encoding apparatus 10, 40, or 70 may include the video encoding apparatuses 100 as many as the number of layers to encode single layer images for each layer of a multilayer video.

When the video encoding apparatus 100 encodes first layer images, the coding unit determiner 120 may determine a prediction unit for prediction between images for each coding unit according to a tree structure for each LCU and perform the prediction between images for each prediction unit.

When the video encoding apparatus 100 encodes second layer images, the coding unit determiner 120 may determine a prediction unit and a coding unit according to a tree structure for each LCU and perform inter prediction for each prediction unit.

The video encoding apparatus 100 may encode a luminance difference to compensate for a luminance difference between the first layer image and the second layer image. However, whether to perform luminance may be determined according to the coding mode of a coding unit. For example, luminance compensation may be performed only for a prediction unit having a size of 2N×2N.

FIG. 9 is a block diagram of a video decoding apparatus 200 based on coding units having a tree structure according to various embodiments.

The video decoding apparatus 200 that involves video prediction based on coding units having a tree structure according to an embodiment includes a receiver 210, an image data and encoding information extractor 220, and an image data decoder 230. For convenience of explanation, the video decoding apparatus 200 that involves video prediction based on coding units having a tree structure according to an embodiment is simply referred to as the ‘video decoding apparatus 200’.

Definitions of various terms, such as a coding unit, a depth, a prediction unit, a transformation unit, and information about various pieces of splitting information, for decoding operations of the video decoding apparatus 200 are identical to those described with reference to FIG. 8 and the video encoding apparatus 100.

The receiver 210 receives and parses a bitstream of an encoded video. The image data and encoding information extractor 220 extracts encoded image data for each coding unit from the parsed bitstream, wherein the coding units have a tree structure according to each LCU, and outputs the extracted image data to the image data decoder 230. The image data and encoding information extractor 220 may extract information about a maximum size of a coding unit of a current picture, from a header about the current picture, a sequence parameter set, or a picture parameter set.

Also, the image data and encoding information extractor 220 extracts a final depth and splitting information for the coding units having a tree structure according to each LCU, from the parsed bitstream. The extracted final depth and splitting information are output to the image data decoder 230. In other words, the image data in a bit string is split into the LCU so that the image data decoder 230 decodes the image data for each LCU.

The depth and splitting information according to the LCU may be set for at least one piece of depth information corresponding to the depth, and splitting information according to the depth may include information about a partition mode of a corresponding coding unit corresponding to the depth, information about a prediction mode, and splitting information of a transformation unit. Also, splitting information according to depths may be extracted as the information about a depth.

The depth and splitting information according to each LCU extracted by the image data and encoding information extractor 220 is a depth and splitting information determined to generate a minimum encoding error when an encoder, such as the video encoding apparatus 100, repeatedly performs encoding for each deeper coding unit according to depths according to each LCU. Accordingly, the video decoding apparatus 200 may reconstruct an image by decoding the image data according to a depth and an encoding mode that generates the minimum encoding error.

Since the depth and the encoding information about an encoding mode according to an embodiment may be assigned to a predetermined data unit from among a corresponding coding unit, a prediction unit, and a minimum unit, the image data and encoding information extractor 220 may extract the depth and the splitting information according to the predetermined data units. If the depth and the splitting information of a corresponding LCU are recorded according to predetermined data units, the predetermined data units to which the same depth and splitting information are assigned may be inferred to be the data units included in the same LCU.

The image data decoder 230 reconstructs the current picture by decoding the image data in each LCU based on the splitting information and the encoding information according to the LCUs. In other words, the image data decoder 230 may decode the encoded image data based on the extracted information about the partition mode, the prediction mode, and the transformation unit for each coding unit from among the coding units having the tree structure included in each LCU. A decoding process may include a prediction including intra prediction and motion compensation, and an inverse transformation.

The image data decoder 230 may perform intra prediction or motion compensation according to a partition and a prediction mode of each coding unit, based on the information about the partition mode and the prediction mode of the prediction unit of the coding unit according to depths.

In addition, the image data decoder 230 may read information about a transformation unit according to a tree structure for each coding unit so as to perform inverse transformation based on transformation units for each coding unit, for inverse transformation for each LCU. Via the inverse transformation, a pixel value of the space domain of the coding unit may be reconstructed.

The image data decoder 230 may determine a final depth of a current LCU by using splitting information according to depths. If the splitting information indicates that image data is no longer split in the current depth, the current depth is the depth. Accordingly, the image data decoder 230 may decode encoded data in the current LCU by using the information about the partition mode of the prediction unit, the information about the prediction mode, and the size information of the transformation unit for each coding unit corresponding to the depth.

In other words, data units containing the encoding information including the same splitting information may be gathered by observing the encoding information set assigned for the predetermined data unit from among the coding unit, the prediction unit, and the minimum unit, and the gathered data units may be considered to be one data unit to be decoded by the image data decoder 230 in the same encoding mode. As such, the current coding unit may be decoded by obtaining the information about the encoding mode for each coding unit.

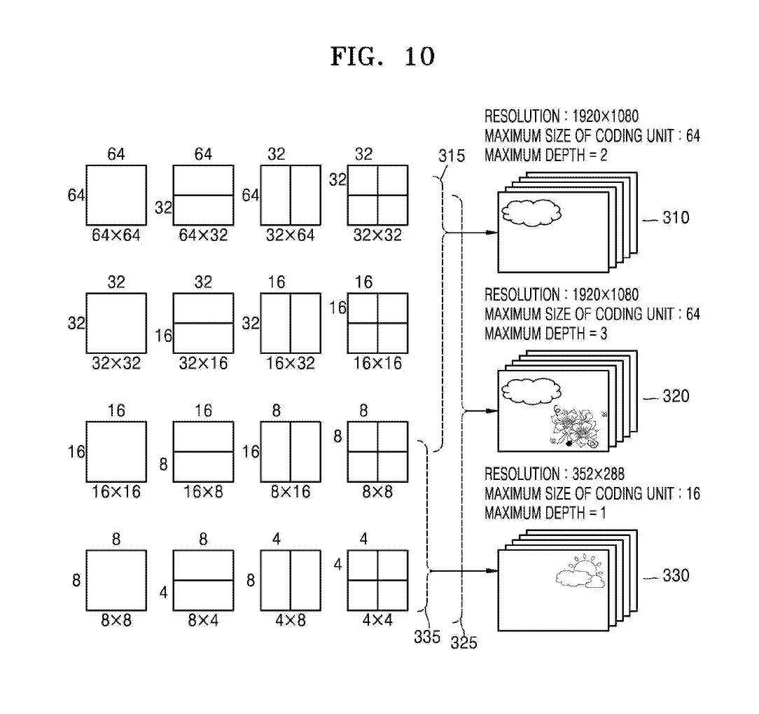

Furthermore, the video decoding apparatus 10 described with reference to FIG. 10 may include the video decoding apparatus 200 as many as the number of viewpoints to the first and second layer images by decoding received first and second layer image streams to reconstruct.

When the first layer image stream is received, the image data decoder 230 of the video decoding apparatus 200 may split samples of the first layer images extracted from the first layer image stream by coding units according to a tree structure of the LCU. The image data decoder 230 may reconstruct the first layer images by performing motion compensation for each prediction unit for prediction between images for each coding unit according to a tree structure of the samples of the first layer images.

When the second layer image stream is received, the image data decoder 230 of the video decoding apparatus 200 may split samples of the second layer images extracted from the second layer image stream by coding units according to a tree structure of the LCU. The image data decoder 230 may reconstruct the second layer images by performing motion compensation for each prediction unit for prediction between images for each coding unit according to a tree structure of the samples of the second layer images.

The extractor 220 may obtain information related to a luminance error from the bitstream to compensate for a luminance difference between the first layer image and the second layer image. However, whether to perform luminance may be determined according to the coding mode of a coding unit. For example, luminance compensation may be performed only for a prediction unit having a size of 2N×2N.

As a result, the video decoding apparatus 200 may obtain information about a coding unit that generates a minimum encoding error by performing recursively performing encoding for each LCU in an encoding process, and use the information for decoding of a current picture. In other words, decoding of coded image data of coding units according to a tree structure determined to be an optimal coding unit for each LCU may be available.

Thus, even for an image of a high resolution or an image having an excessively large data amount, the image may be reconstructed by efficiently decoding the image data according to a coding mode and the size of a coding unit adaptively determined to the characteristics of an image, by using optimal splitting information transmitted from a coding end.

FIG. 10 is a diagram for explaining a concept of coding units according to various embodiments.

A size of a coding unit may be expressed by width×height, and may be 64×64, 32×32, 16×16, and 8×8. A coding unit of 64×64 may be split into partitions of 64×64, 64×32, 32×64, or 32×32, and a coding unit of 32×32 may be split into partitions of 32×32, 32×16, 16×32, or 16×16, a coding unit of 16×16 may be split into partitions of 16×16, 16×8, 8×16, or 8×8, and a coding unit of 8×8 may be split into partitions of 8×8, 8×4, 4×8, or 4×4.

In video data 310, a resolution is 1920×1080, a maximum size of a coding unit is 64, and a maximum depth is 2. In video data 320, a resolution is 1920×1080, a maximum size of a coding unit is 64, and a maximum depth is 3. In video data 330, a resolution is 352×288, a maximum size of a coding unit is 16, and a maximum depth is 1. The maximum depth shown in FIG. 10 denotes a total number of splits from a LCU to a minimum decoding unit.

If a resolution is high or a data amount is large, a maximum size of a coding unit may be large so as to not only increase encoding efficiency but also to accurately reflect characteristics of an image. Accordingly, the maximum size of the coding unit of the video data 310 and 320 having a higher resolution than the video data 330 may be 64.

Since the maximum depth of the video data 310 is 2, coding units 315 of the vide data 310 may include a LCU having a long axis size of 64, and coding units having long axis sizes of 32 and 16 since depths are deepened to two layers by splitting the LCU twice. Since the maximum depth of the video data 330 is 1, coding units 335 of the video data 330 may include a LCU having a long axis size of 16, and coding units having a long axis size of 8 since depths are deepened to one layer by splitting the LCU once.

Since the maximum depth of the video data 320 is 3, coding units 325 of the video data 320 may include a LCU having a long axis size of 64, and coding units having long axis sizes of 32, 16, and 8 since the depths are deepened to 3 layers by splitting the LCU three times. As a depth deepens, detailed information may be precisely expressed.

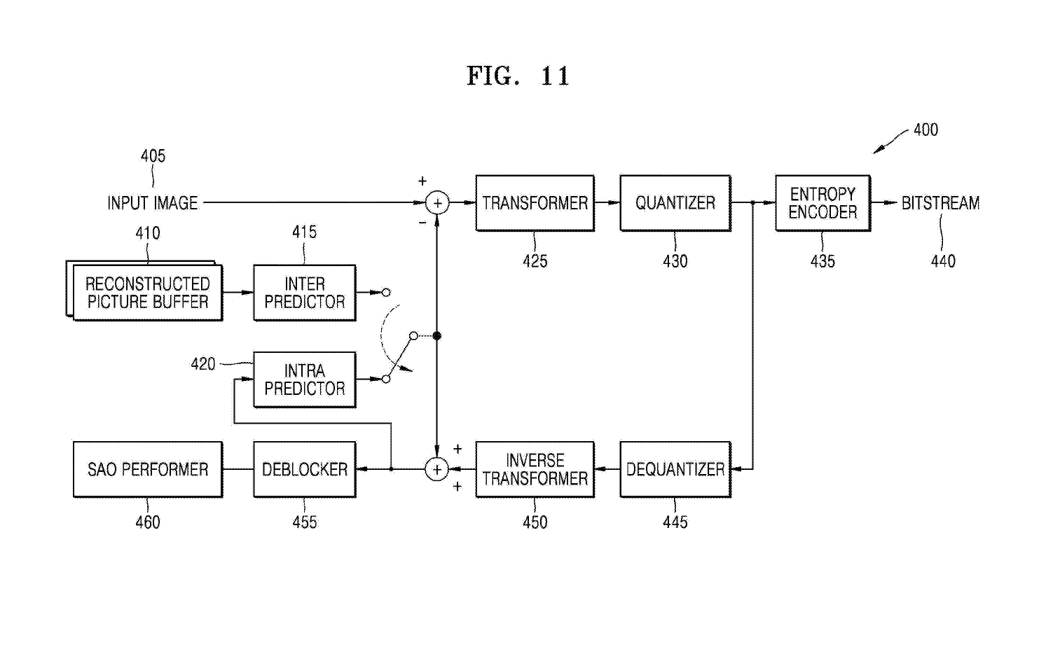

FIG. 11 is a block diagram of an image encoder 400 based on coding units according to various embodiments.

The image encoder 400 according to an embodiment performs operations necessary for encoding image data in the coding unit determiner 120 of the video encoding apparatus 100. In other words, an intra predictor 420 performs intra prediction on coding units in an intra mode according to prediction units, from among a current frame 405, and an inter predictor 415 performs inter prediction on coding units in an inter mode by using a current image 405 and a reference image obtained from a reconstructed picture buffer 410 according to prediction units. The current image 405 may be split into LCUs and then the LCUs may be sequentially encoded. In this regard, the LCUs that are to be split into coding units having a tree structure may be encoded.

Remaining image data is generated by removing prediction data regarding coding units of each mode that is output from the intra predictor 420 or the inter predictor 415 from data regarding encoded coding units of the current image 405, and is output as a quantized transformation coefficient according to transformation units through a transformer 425 and a quantizer 430. The quantized transformation coefficient is reconstructed as the residual image data in a space domain through a dequantizer 445 and an inverse transformer 450. The reconstructed residual image data in the space domain is added to prediction data for coding units of each mode that is output from the intra predictor 420 or the inter predictor and thus is reconstructed as data in a space domain for coding units of the current image 405. The reconstructed data in the space domain is generated as reconstructed images through a de-blocker 455 and an SAO performer 460 and the reconstructed images are stored in the reconstructed picture buffer 410. The reconstructed images stored in the reconstructed picture buffer 410 may be used as reference images for inter prediction of another image. The transformation coefficient quantized by the transformer 425 and the quantizer 430 may be output as a bitstream 440 through an entropy encoder 435.

In order for the image encoder 400 according to an embodiment to be applied in the video encoding apparatus 100, all elements of the image encoder 400, i.e., the inter predictor 415, the intra predictor 420, the transformer 425, the quantizer 430, the entropy encoder 435, the dequantizer 445, the inverse transformer 450, the de-blocker 455, and the SAO performer 460, perform operations based on each coding unit among coding units having a tree structure according to each LCU.

Specifically, the intra predictor 420 and the inter predictor 415 may determine a partition mode and a prediction mode of each coding unit among the coding units having a tree structure in consideration of a maximum size and a maximum depth of a current LCU, and the transformer 425 may determine whether to split a transformation unit having a quad tree structure in each coding unit among the coding units having a tree structure.

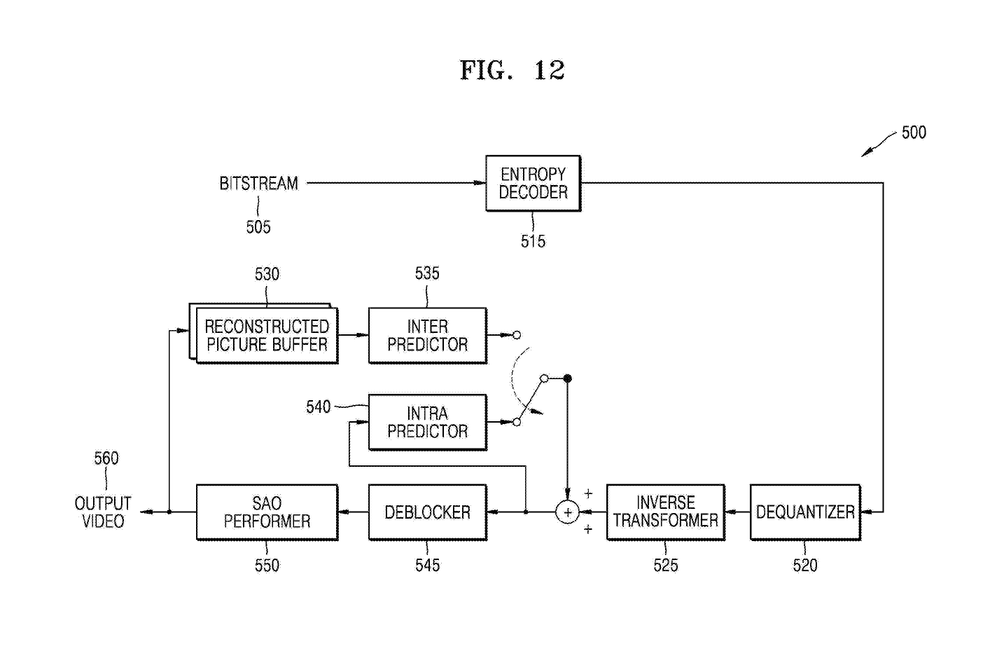

FIG. 12 is a block diagram of an image decoder 500 based on coding units according to various embodiments.

An entropy decoder 515 parses encoded image data to be decoded and information about encoding required for decoding from a bitstream 505. The encoded image data is a quantized transformation coefficient from which residual image data is reconstructed by a dequantizer 520 and an inverse transformer 525.

An intra predictor 540 performs intra prediction on coding units in an intra mode according to each prediction unit. An inter predictor 535 performs inter prediction on coding units in an inter mode from among the current image 405 for each prediction unit by using a reference image obtained from a reconstructed picture buffer 530.

Prediction data and residual image data regarding coding units of each mode, which passed through the intra predictor 540 or the inter predictor 535, are summed, and thus data in a space domain regarding coding units of the current image 405 may be reconstructed, and the reconstructed data in the space domain may be output as a reconstructed image 560 through a de-blocker 545 and an SAO performer 550. Reconstructed images stored in the reconstructed picture buffer 530 may be output as reference images.

In order to decode the image data in the image data decoder 230 of the video decoding apparatus 200, operations after the entropy decoder 515 of the image decoder 500 according to an embodiment may be performed.

In order for the image decoder 500 to be applied in the video decoding apparatus 200 according to an embodiment, all elements of the image decoder 500, i.e., the entropy decoder 515, the dequantizer 520, the inverse transformer 525, the intra predictor 540, the inter predictor 535, the de-blocker 545, and the SAO performer 550 may perform operations based on each of coding units having a tree structure for each LCU.

In particular, the intra predictor 540 and the inter predictor 535 may determine a partition mode and a prediction mode for each of the coding units having a tree structure, and the inverse transformer 525 may determine whether to split a transformation unit having a quad tree structure for each of the coding units.

The encoding operation of FIG. 10 and the decoding operation of FIG. 11 are descriptions of video stream encoding and decoding operations in a single layer, respectively. Thus, when the image encoding apparatus 10, 40, or 70 encodes a video stream of two or more layers, the image encoder 400 may be included for each layer. Similarly, when the image decoding apparatus 16, 21, or 80 decodes a video stream of two or more layers, the image decoder 500 may be included for each layer.

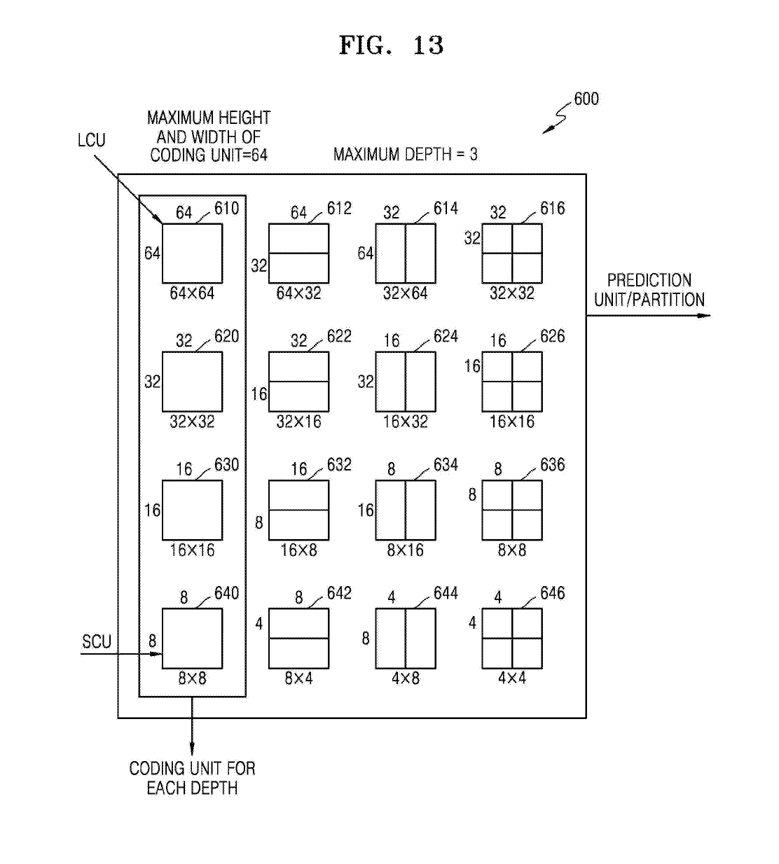

FIG. 13 is a diagram illustrating deeper coding units according to depths and partitions according to various embodiments.

The video encoding apparatus 100 according to an embodiment and the video decoding apparatus 200 according to an embodiment use hierarchical coding units so as to consider characteristics of an image. A maximum height, a maximum width, and a maximum depth of coding units may be adaptively determined according to the characteristics of the image, or may be differently set by a user. Sizes of deeper coding units according to depths may be determined according to the predetermined maximum size of the coding unit.

In a hierarchical structure 600 of coding units according to an embodiment, the maximum height and the maximum width of the coding units are each 64, and the maximum depth is 3. In this case, the maximum depth refers to a total number of times the coding unit is split from the LCU to the SCU. Since a depth deepens along a vertical axis of the hierarchical structure 600, a height and a width of the deeper coding unit are each split. Also, a prediction unit and partitions, which are bases for prediction encoding of each deeper coding unit, are shown along a horizontal axis of the hierarchical structure 600.

In other words, a coding unit 610 is a LCU in the hierarchical structure 600, wherein a depth is 0 and a size, i.e., a height by width, is 64×64. The depth deepens along the vertical axis, and a coding unit 620 having a size of 32×32 and a depth of 1, a coding unit 630 having a size of 16×16 and a depth of 2, and a coding unit 640 having a size of 8×8 and a depth of 3. The coding unit 640 having a size of 8×8 and a depth of 3 is an SCU.

The prediction unit and the partitions of a coding unit are arranged along the horizontal axis according to each depth. In other words, if the coding unit 610 having a size of 64×64 and a depth of 0 is a prediction unit, the prediction unit may be split into partitions include in the encoding unit 610, i.e. a partition 610 having a size of 64×64, partitions 612 having the size of 64×32, partitions 614 having the size of 32×64, or partitions 616 having the size of 32×32.

Similarly, a prediction unit of the coding unit 620 having the size of 32×32 and the depth of 1 may be split into partitions included in the coding unit 620, i.e. a partition 620 having a size of 32×32, partitions 622 having a size of 32×16, partitions 624 having a size of 16×32, and partitions 626 having a size of 16×16.

Similarly, a prediction unit of the coding unit 630 having the size of 16×16 and the depth of 2 may be split into partitions included in the coding unit 630, i.e. a partition having a size of 16×16 included in the coding unit 630, partitions 632 having a size of 16×8, partitions 634 having a size of 8×16, and partitions 636 having a size of 8×8.

Similarly, a prediction unit of the coding unit 640 having the size of 8×8 and the depth of 3 may be split into partitions included in the coding unit 640, i.e. a partition having a size of 8×8 included in the coding unit 640, partitions 642 having a size of 8×4, partitions 644 having a size of 4×8, and partitions 646 having a size of 4×4.

In order to determine a depth of the LCU 610, the coding unit determiner 120 of the video encoding apparatus 100 performs encoding for coding units corresponding to each depth included in the LCU 610.

A number of deeper coding units according to depths including data in the same range and the same size increases as the depth deepens. For example, four coding units corresponding to a depth of 2 are required to cover data that is included in one coding unit corresponding to a depth of 1. Accordingly, in order to compare encoding results of the same data according to depths, the coding unit corresponding to the depth of 1 and four coding units corresponding to the depth of 2 are each encoded.

In order to perform encoding for a current depth from among the depths, a least encoding error may be selected for the current depth by performing encoding for each prediction unit in the coding units corresponding to the current depth, along the horizontal axis of the hierarchical structure 600. Alternatively, the minimum encoding error may be searched for by comparing the least encoding errors according to depths, by performing encoding for each depth as the depth deepens along the vertical axis of the hierarchical structure 600. A depth and a partition having the minimum encoding error in the coding unit 610 may be selected as the depth and a partition mode of the coding unit 610.

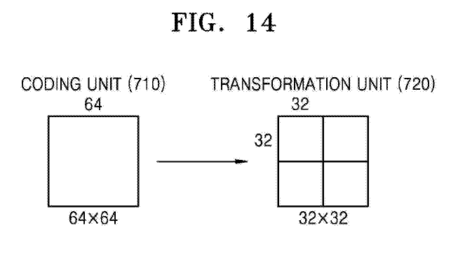

FIG. 14 is a diagram for explaining a relationship between a coding unit 710 and transformation units 720 according to various embodiments.

The video encoding apparatus 100 according to an embodiment or the video decoding apparatus 200 according to an embodiment encodes or decodes an image according to coding units having sizes smaller than or equal to a LCU for each LCU. Sizes of transformation units for transformation during encoding may be selected based on data units that are not larger than a corresponding coding unit.

For example, in the video encoding apparatus 100 according to an embodiment or the video decoding apparatus 200 according to an embodiment, if a size of the coding unit 710 is 64×64, transformation may be performed by using the transformation units 720 having a size of 32×32.

Also, data of the coding unit 710 having the size of 64×64 may be encoded by performing the transformation on each of the transformation units having the size of 32×32, 16×16, 8×8, and 4×4, which are smaller than 64×64, and then a transformation unit having the least coding error may be selected.

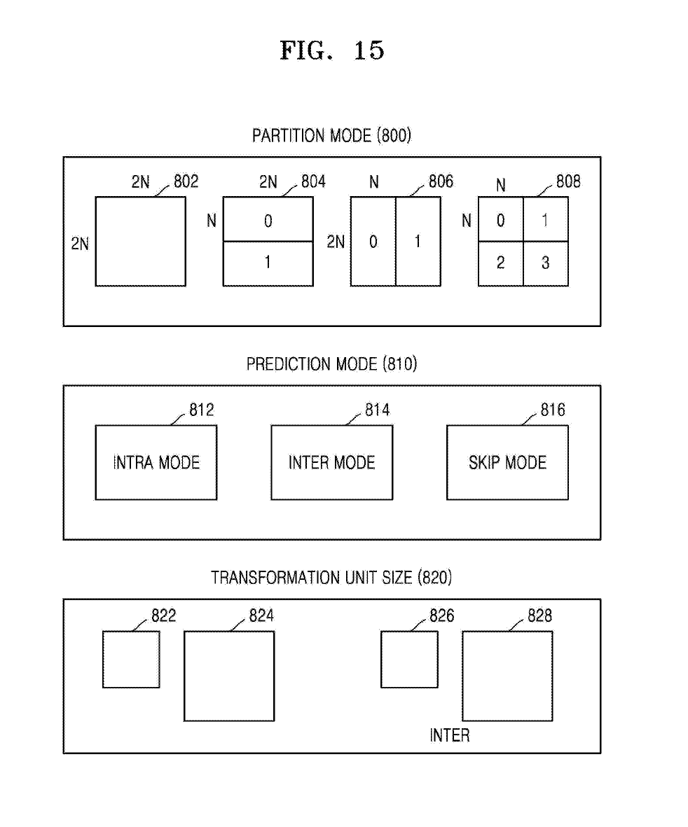

FIG. 15 is a diagram for explaining encoding information of coding units corresponding to a depth according to various embodiments.

The outputter 130 of the video encoding apparatus 100 according to an embodiment may encode and transmit information 800 about a partition mode, information 810 about a prediction mode, and information 820 about a transformation unit size for each coding unit corresponding to a depth, as splitting information.

The information 800 indicates information about a mode of a partition obtained by splitting a prediction unit of a current coding unit, wherein the partition is a data unit for prediction encoding the current coding unit. For example, a current coding unit CU_0 having a size of 2N×2N may be split into any one of a partition 802 having a size of 2N×2N, a partition 804 having a size of 2N×N, a partition 806 having a size of N×2N, and a partition 808 having a size of N×N. Here, the information 800 about the partition mode is set to indicate one of the partition 804 having a size of 2N×N, the partition 806 having a size of N×2N, and the partition 808 having a size of N×N.

The information 810 indicates a prediction mode of each partition. For example, the information 810 may indicate a mode of prediction encoding performed on a partition indicated by the information 800, i.e., an intra mode 812, an inter mode 814, or a skip mode 816.

The information 820 indicates a transformation unit to be based on when transformation is performed on a current coding unit. For example, the transformation unit may be a first intra transformation unit 822, a second intra transformation unit 824, a first inter transformation unit 826, or a second inter transformation unit 828.

The image data and encoding information extractor 220 of the video decoding apparatus 200 according to an embodiment may extract and use the information 800, 810, and 820 for decoding, according to each deeper coding unit.

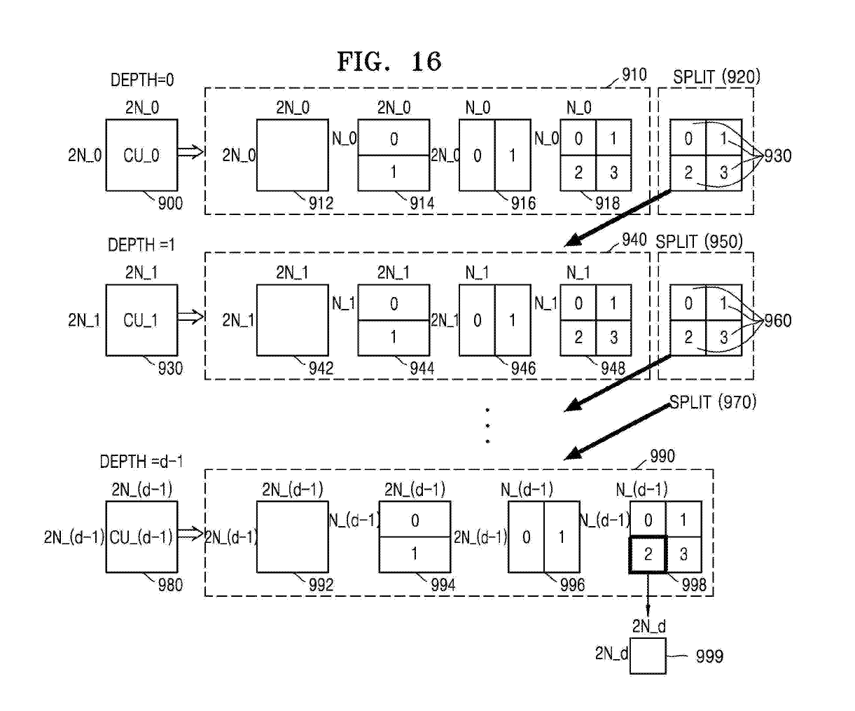

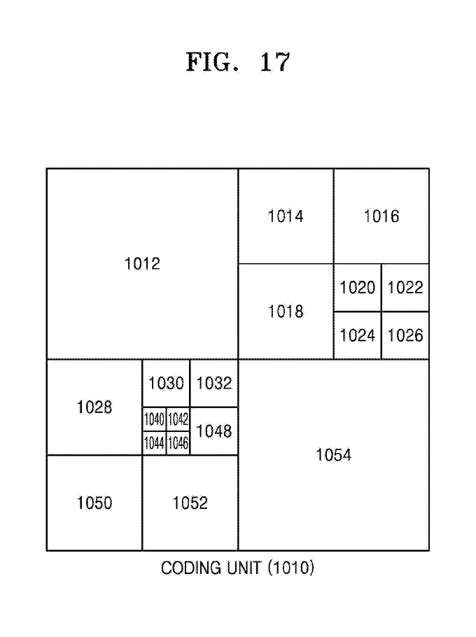

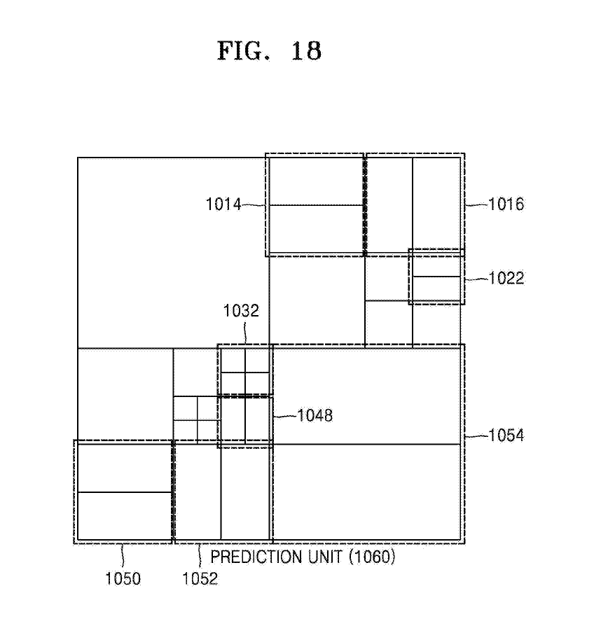

FIG. 16 is a diagram of deeper coding units according to depths according to various embodiments.

Splitting information may be used to indicate a change of a depth. The spilt information indicates whether a coding unit of a current depth is split into coding units of a lower depth.

A prediction unit 910 for prediction encoding a coding unit 900 having a depth of 0 and a size of 2N_0×2N_0 may include partitions of a partition mode 912 having a size of 2N_0×2N_0, a partition mode 914 having a size of 2N_0×N_0, a partition mode 916 having a size of N_0×2N_0, and a partition mode 918 having a size of N_0×N_0. FIG. 16 only illustrates the partition modes 912 through 918 which are obtained by symmetrically splitting the prediction unit 910, but a partition mode is not limited thereto, and the partitions of the prediction unit 910 may include asymmetrical partitions, partitions having a predetermined shape, and partitions having a geometrical shape.

Prediction encoding is repeatedly performed on one partition having a size of 2N_0×2N_0, two partitions having a size of 2N_0×N_0, two partitions having a size of N_0×2N_0, and four partitions having a size of N_0×N_0, according to each partition mode. The prediction encoding in an intra mode and an inter mode may be performed on the partitions having the sizes of 2N_0×2N_0, N_0×2N_0, 2N_0×N_0, and N_0×N_0. The prediction encoding in a skip mode is performed only on the partition having the size of 2N_0×2N_0.

If an encoding error is smallest in one of the partition modes 912 through 916, the prediction unit 910 may not be split into a lower depth.

If the encoding error is the smallest in the partition mode 918, a depth is changed from 0 to 1 to split the partition mode 918 in operation 920, and encoding is repeatedly performed on coding units 930 having a depth of 2 and a size of N_0×N_0 to search for a minimum encoding error.

A prediction unit 940 for prediction encoding the coding unit 930 having a depth of 1 and a size of 2N_1×2N_1 (=N_0×N_0) may include partitions of a partition mode 942 having a size of 2N_1×2N_1, a partition mode 944 having a size of 2N_1×N_1, a partition mode 946 having a size of N_1×2N_1, and a partition mode 948 having a size of N_1×N_1.

If an encoding error is the smallest in the partition mode 948, a depth is changed from 1 to 2 to split the partition mode 948 in operation 950, and encoding is repeatedly performed on coding units 960, which have a depth of 2 and a size of N_2×N_2 to search for a minimum encoding error.

When a maximum depth is d, split operation according to each depth may be performed up to when a depth becomes d−1, and splitting information may be encoded as up to when a depth is one of 0 to d−2. In other words, when encoding is performed up to when the depth is d−1 after a coding unit corresponding to a depth of d−2 is split in operation 970, a prediction unit 990 for prediction encoding a coding unit 980 having a depth of d−1 and a size of 2N_(d−1)×2N_(d−1) may include partitions of a partition mode 992 having a size of 2N_(d−1)×2N_(d−1), a partition mode 994 having a size of 2N_(d−1)×N_(d−1), a partition mode 996 having a size of N_(d−1)×2N_(d−1), and a partition mode 998 having a size of N_(d−1)×N_(d−1).

Prediction encoding may be repeatedly performed on one partition having a size of 2N_(d−1)×2N_(d−1), two partitions having a size of 2N_(d−1)×N_(d−1), two partitions having a size of N_(d−1)×2N_(d−1), four partitions having a size of N_(d−1)×N_(d−1) from among the partition modes 992 through 998 to search for a partition mode having a minimum encoding error.

Even when the partition mode 998 has the minimum encoding error, since a maximum depth is d, a coding unit CU_(d−1) having a depth of d−1 is no longer split to a lower depth, and a depth for the coding units constituting a current LCU 900 is determined to be d−1 and a partition mode of the current LCU 900 may be determined to be N_(d−1)×N_(d−1). Also, since the maximum depth is d and an SCU 980 having a lowermost depth of d−1 is no longer split to a lower depth, splitting information for the SCU 980 is not set.

A data unit 999 may be a ‘minimum unit’ for the current LCU. A minimum unit according to an embodiment may be a square data unit obtained by splitting an SCU 980 by 4. By performing the encoding repeatedly, the video encoding apparatus 100 according to an embodiment may select a depth having the least encoding error by comparing encoding errors according to depths of the coding unit 900 to determine a depth, and set a corresponding partition mode and a prediction mode as an encoding mode of the depth.

As such, the minimum encoding errors according to depths are compared in all of the depths of 1 through d, and a depth having the least encoding error may be determined as a depth. The depth, the partition mode of the prediction unit, and the prediction mode may be encoded and transmitted as splitting information. Also, since a coding unit is split from a depth of 0 to a depth, only splitting information of the depth is set to 0, and splitting information of depths excluding the depth is set to 1.

The image data and encoding information extractor 220 of the video decoding apparatus 200 according to an embodiment may extract and use the information about the depth and the prediction unit of the coding unit 900 to decode the partition 912. The video decoding apparatus 200 according to an embodiment may determine a depth, in which splitting information is 0, as a depth by using splitting information according to depths, and use the splitting information of the corresponding depth for decoding.

FIGS. 17, 18, and 19 are diagrams for explaining a relationship between coding units 1010, prediction units 1060, and transformation units 1070 according to various embodiments.

The coding units 1010 are coding units having a tree structure, corresponding to depths determined by the video encoding apparatus 100, in a LCU. The prediction units 1060 are partitions of prediction units of each of the coding units 1010, and the transformation units 1070 are transformation units of each of the coding units 1010.

When a depth of a LCU is 0 in the coding units 1010, depths of coding units 1012 and 1054 are 1, depths of coding units 1014, 1016, 1018, 1028, 1050, and 1052 are 2, depths of coding units 1020, 1022, 1024, 1026, 1030, 1032, and 1048 are 3, and depths of coding units 1040, 1042, 1044, and 1046 are 4.

In the prediction units 1060, some encoding units 1014, 1016, 1022, 1032, 1048, 1050, 1052, and 1054 are obtained by splitting the coding units in the encoding units 1010. In other words, partition modes in the coding units 1014, 1022, 1050, and 1054 have a size of 2N×N, partition modes in the coding units 1016, 1048, and 1052 have a size of N×2N, and a partition mode of the coding unit 1032 has a size of N×N. Prediction units and partitions of the coding units 1010 are smaller than or equal to each coding unit.

Transformation or inverse transformation is performed on image data of the coding unit 1052 in the transformation units 1070 in a data unit that is smaller than the coding unit 1052. Also, the coding units 1014, 1016, 1022, 1032, 1048, 1050, 1052 and 1054 in the transformation units 1070 are different from those in the prediction units 1060 in terms of sizes and shapes. In other words, the video encoding and decoding apparatuses 100 and 200 according to an embodiment may perform intra prediction, motion estimation, motion compensation, transformation, and inverse transformation individually on a data unit in the same coding unit.

Accordingly, encoding is recursively performed on each of coding units having a hierarchical structure in each region of a LCU to determine an optimum coding unit, and thus coding units having a recursive tree structure may be obtained. Encoding information may include splitting information about a coding unit, information about a partition mode, information about a prediction mode, and information about a size of a transformation unit. Table 1 shows the encoding information that may be set by the video encoding and decoding apparatuses 100 and 200 according to an embodiment.

TABLE 1

| Splitting information 0 | | | | | |
|---|---|---|---|---|---|
| (Encoding on Coding Unit having Size of 2N × 2N and Current Depth of d) | | | | | |
| | | | Size of Transformation Unit | | |
| | Partition mode | | Splitting | Splitting | |
| | Symmetrical | Asymmetrical | information 0 of | information 1 of | |
| Prediction | Partition | Partition | Transformation | Transformation | Splitting |
| Mode | mode | mode | Unit | Unit | information 1 |
| Intra | 2N × 2N | 2N × nU | 2N × 2N | N × N | Repeatedly Encode |
| Inter | 2N × N | 2N × nD | | (Symmetrical | Coding Units |
| Skip | N × 2N | nL × 2N | | Type) | Having Lower |
| (Only | N × N | nR × 2N | | N/2 × N/2 | Depth of |
| 2N × 2N) | | | | (Asymmetrical | d + 1 |
| | | | | Type) | |

The outputter 130 of the video encoding apparatus 100 according to an embodiment may output the encoding information about the coding units having a tree structure, and the image data and encoding information extractor 220 of the video decoding apparatus 200 according to an embodiment may extract the encoding information about the coding units having a tree structure from a received bitstream.

Splitting information indicates whether a current coding unit is split into coding units of a lower depth. If splitting information of a current depth d is 0, a depth, in which a current coding unit is no longer split into a lower depth, is a depth, and thus information about a partition mode, prediction mode, and a size of a transformation unit may be defined for the depth. If the current coding unit is further split according to the splitting information, encoding is independently performed on four split coding units of a lower depth.

A prediction mode may be one of an intra mode, an inter mode, and a skip mode. The intra mode and the inter mode may be defined in all partition modes, and the skip mode is defined only in a partition mode having a size of 2N×2N.

The information about the partition mode may indicate symmetrical partition modes having sizes of 2N×2N, 2N×N, N×2N, and N×N, which are obtained by symmetrically splitting a height or a width of a prediction unit, and asymmetrical partition modes having sizes of 2N×nU, 2N×nD, nL×2N, and nR×2N, which are obtained by asymmetrically splitting the height or width of the prediction unit. The asymmetrical partition modes having the sizes of 2N×nU and 2N×nD may be respectively obtained by splitting the height of the prediction unit in 1:3 and 3:1, and the asymmetrical partition modes having the sizes of nL×2N and nR×2N may be respectively obtained by splitting the width of the prediction unit in 1:3 and 3:1

The size of the transformation unit may be set to be two types in the intra mode and two types in the inter mode. In other words, if splitting information of the transformation unit is 0, the size of the transformation unit may be 2N×2N, which is the size of the current coding unit. If splitting information of the transformation unit is 1, the transformation units may be obtained by splitting the current coding unit. Also, if a partition mode of the current coding unit having the size of 2N×2N is a symmetrical partition mode, a size of a transformation unit may be N×N, and if the partition mode of the current coding unit is an asymmetrical partition mode, the size of the transformation unit may be N/2×N/2.

The encoding information about coding units having a tree structure may include at least one of a coding unit corresponding to a depth, a prediction unit, and a minimum unit. The coding unit corresponding to the depth may include at least one of a prediction unit and a minimum unit containing the same encoding information.

Accordingly, it is determined whether adjacent data units are included in the same coding unit corresponding to the depth by comparing encoding information of the adjacent data units. Also, a corresponding coding unit corresponding to a depth is determined by using encoding information of a data unit, and thus a distribution of depths in a LCU may be determined.

Accordingly, if a current coding unit is predicted based on encoding information of adjacent data units, encoding information of data units in deeper coding units adjacent to the current coding unit may be directly referred to and used.

Alternatively, if a current coding unit is predicted based on encoding information of adjacent data units, data units adjacent to the current coding unit are searched using encoded information of the data units, and the searched adjacent coding units may be referred for predicting the current coding unit.

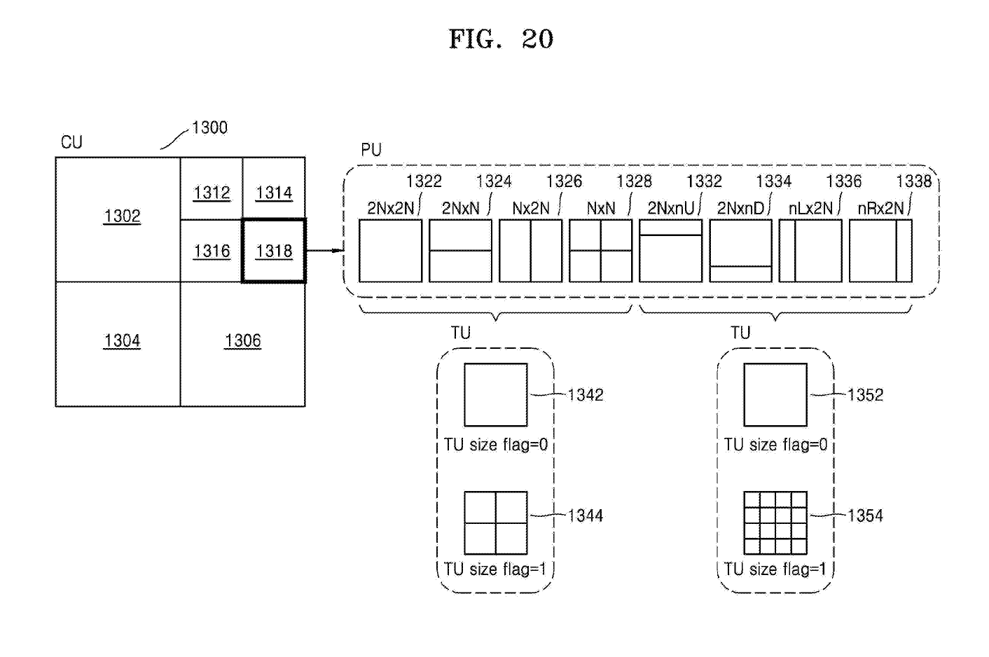

FIG. 20 is a diagram for explaining a relationship between a coding unit, a prediction unit, and a transformation unit, according to encoding mode information of Table 1.

A LCU 1300 includes coding units 1302, 1304, 1306, 1312, 1314, 1316, and 1318 of depths. Here, since the coding unit 1318 is a coding unit of a depth, splitting information may be set to 0. Information about a partition mode of the coding unit 1318 having a size of 2N×2N may be set to be one of a partition mode 1322 having a size of 2N×2N, a partition mode 1324 having a size of 2N×N, a partition mode 1326 having a size of N×2N, a partition mode 1328 having a size of N×N, a partition mode 1332 having a size of 2N×nU, a partition mode 1334 having a size of 2N×nD, a partition mode 1336 having a size of nL×2N, and a partition mode 1338 having a size of nR×2N.

Splitting information (TU size flag) of a transformation unit is a type of a transformation index. The size of the transformation unit corresponding to the transformation index may be changed according to a prediction unit type or partition mode of the coding unit.

For example, when the partition mode is set to be symmetrical, i.e. the partition mode 1322, 1324, 1326, or 1328, a transformation unit 1342 having a size of 2N×2N is set if a TU size flag of a transformation unit is 0, and a transformation unit 1344 having a size of N×N is set if a TU size flag is 1.

When the partition mode is set to be asymmetrical, i.e., the partition mode 1332, 1334, 1336, or 1338, a transformation unit 1352 having a size of 2N×2N is set if a TU size flag is 0, and a transformation unit 1354 having a size of N/2×N/2 is set if a TU size flag is 1.

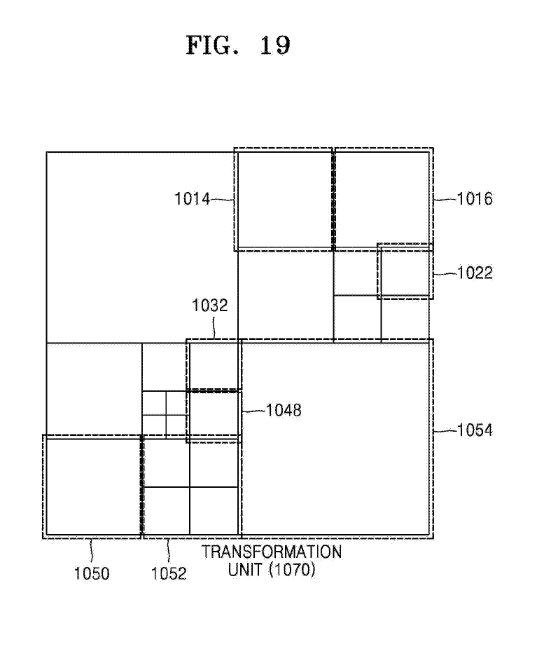

Although the TU size flag described with reference to FIG. 19 is a flag having a value or 0 or 1, but the TU size flag is not limited to 1 bit, and a transformation unit may be hierarchically split having a tree structure while the TU size flag increases from 0. Splitting information (TU size flag) of a transformation unit may be an example of a transformation index.

In this case, the size of a transformation unit that has been actually used may be expressed by using a TU size flag of a transformation unit according to an embodiment, together with a maximum size and minimum size of the transformation unit. The video encoding apparatus 100 is capable of encoding maximum transformation unit size information, minimum transformation unit size information, and a maximum TU size flag. The result of encoding the maximum transformation unit size information, the minimum transformation unit size information, and the maximum TU size flag may be inserted into an SPS. The video decoding apparatus 200 may decode video by using the maximum transformation unit size information, the minimum transformation unit size information, and the maximum TU size flag.

For example, (a) if the size of a current coding unit is 64×64 and a maximum transformation unit size is 32×32, (a-1) then the size of a transformation unit may be 32×32 when a TU size flag is 0, (a-2) may be 16×16 when the TU size flag is 1, and (a-3) may be 8×8 when the TU size flag is 2.

As another example, (b) if the size of the current coding unit is 32×32 and a minimum transformation unit size is 32×32, (b-1) then the size of the transformation unit may be 32×32 when the TU size flag is 0. Here, the TU size flag cannot be set to a value other than 0, since the size of the transformation unit cannot be less than 32×32.

As another example, (c) if the size of the current coding unit is 64×64 and a maximum TU size flag is 1, then the TU size flag may be 0 or 1. Here, the TU size flag cannot be set to a value other than 0 or 1.

Thus, if it is defined that the maximum TU size flag is ‘MaxTransformSizeIndex’, a minimum transformation unit size is ‘MinTransformSize’, and a transformation unit size is ‘RootTuSize’ when the TU size flag is 0, then a current minimum transformation unit size ‘CurrMinTuSize’ that can be determined in a current coding unit, may be defined by Equation (1):

CurrMinTuSize=max(MinTransformSize,RootTuSize/(2̂MaxTransformSizeIndex)) (1)

Compared to the current minimum transformation unit size ‘CurrMinTuSize’ that can be determined in the current coding unit, a transformation unit size ‘RootTuSize’ when the TU size flag is 0 may denote a maximum transformation unit size that can be selected in the system. In Equation (1), ‘RootTuSize/(2̂MaxTransformSizeIndex)’ denotes a transformation unit size when the transformation unit size ‘RootTuSize’, when the TU size flag is 0, is split a number of times corresponding to the maximum TU size flag, and ‘MinTransformSize’ denotes a minimum transformation size. Thus, a smaller value from among ‘RootTuSize/(2̂MaxTransformSizeIndex)’ and ‘MinTransformSize’ may be the current minimum transformation unit size ‘CurrMinTuSize’ that can be determined in the current coding unit.

According to an embodiment, the maximum transformation unit size RootTuSize may vary according to the type of a prediction mode.

For example, if a current prediction mode is an inter mode, then ‘RootTuSize’ may be determined by using Equation (2) below. In Equation (2), ‘MaxTransformSize’ denotes a maximum transformation unit size, and ‘PUSize’ denotes a current prediction unit size.

RootTuSize=min(MaxTransformSize,PUSize) (2)

That is, if the current prediction mode is the inter mode, the transformation unit size ‘RootTuSize’, when the TU size flag is 0, may be a smaller value from among the maximum transformation unit size and the current prediction unit size.

If a prediction mode of a current partition unit is an intra mode, ‘RootTuSize’ may be determined by using Equation (3) below. In Equation (3), ‘PartitionSize’ denotes the size of the current partition unit.

RootTuSize=min(MaxTransformSize,PartitionSize) (3)

That is, if the current prediction mode is the intra mode, the transformation unit size ‘RootTuSize’ when the TU size flag is 0 may be a smaller value from among the maximum transformation unit size and the size of the current partition unit.

However, the current maximum transformation unit size ‘RootTuSize’ that varies according to the type of a prediction mode in a partition unit is just an example and the embodiments are not limited thereto.

According to the video encoding method based on coding units having a tree structure as described with reference to FIGS. 8 through 20, image data of the space domain is encoded for each coding unit of a tree structure. According to the video decoding method based on coding units having a tree structure, decoding is performed for each LCU to reconstruct image data of the space domain. Thus, a picture and a video that is a picture sequence may be reconstructed. The reconstructed video may be reproduced by a reproducing apparatus, stored in a storage medium, or transmitted through a network

The present invention may be embodied in a general purpose digital computer by running a program from a computer-readable medium. Examples of the computer-readable medium include storage media such as magnetic storage media (e.g., read only memories (ROMs), floppy discs, or hard discs), optically readable media (e.g., compact disk-read only memories (CD-ROMs), or digital versatile disks (DVDs)), etc.

For convenience of description, the above-described video encoding method and/or video encoding method will be referred to as a ‘video encoding method of the present invention’. In addition, the above-described video decoding method and/or video decoding method will be referred to as a ‘video decoding method of the present invention’.

Also, the above-described video encoding apparatus 10, 40, or 70, the video encoding apparatus 100, or the video encoding apparatus including the image encoder 400 will be referred to as a ‘video encoding apparatus of the present invention’. In addition, the above-described video decoding apparatus 16, 21, or 80, the video decoding apparatus 200, or the video decoding apparatus including the image decoder 500 will be referred to as a ‘video decoding apparatus of the present invention’.

A computer-readable recording medium storing a program, e.g., a disc 26000 according to an embodiment will now be described in detail.

FIG. 21 is a diagram of a physical structure of the disc 26000 in which a program is stored according to various embodiments. The disc 26000, which is a storage medium, may be a hard drive, a compact disc-read only memory (CD-ROM) disc, a Blu-ray disc, or a digital versatile disc (DVD). The disc 26000 includes a plurality of concentric tracks Tr that are each divided into a specific number of sectors Se in a circumferential direction of the disc 26000. In a specific region of the disc 26000, a program that executes the quantization parameter determination method, the video encoding method, and the video decoding method described above may be assigned and stored.

A computer system embodied using a storage medium that stores a program for executing the video encoding method and the video decoding method as described above will now be described with reference to FIG. 22.

FIG. 22 is a diagram of a disc drive 26800 for recording and reading a program by using the disc 26000. A computer system 26700 may store a program that executes at least one of a video encoding method and a video decoding method of the present invention, in the disc 26000 via the disc drive 26800. To run the program stored in the disc 26000 in the computer system 26700, the program may be read from the disc 26000 and be transmitted to the computer system 26700 by using the disc drive 26700.

The program that executes at least one of a video encoding method and a video decoding method of the present invention may be stored not only in the disc 26000 illustrated in FIG. 21 or 22 but also in a memory card, a ROM cassette, or a solid state drive (SSD).

A system to which the video encoding method and a video decoding method described above are applied will be described below.

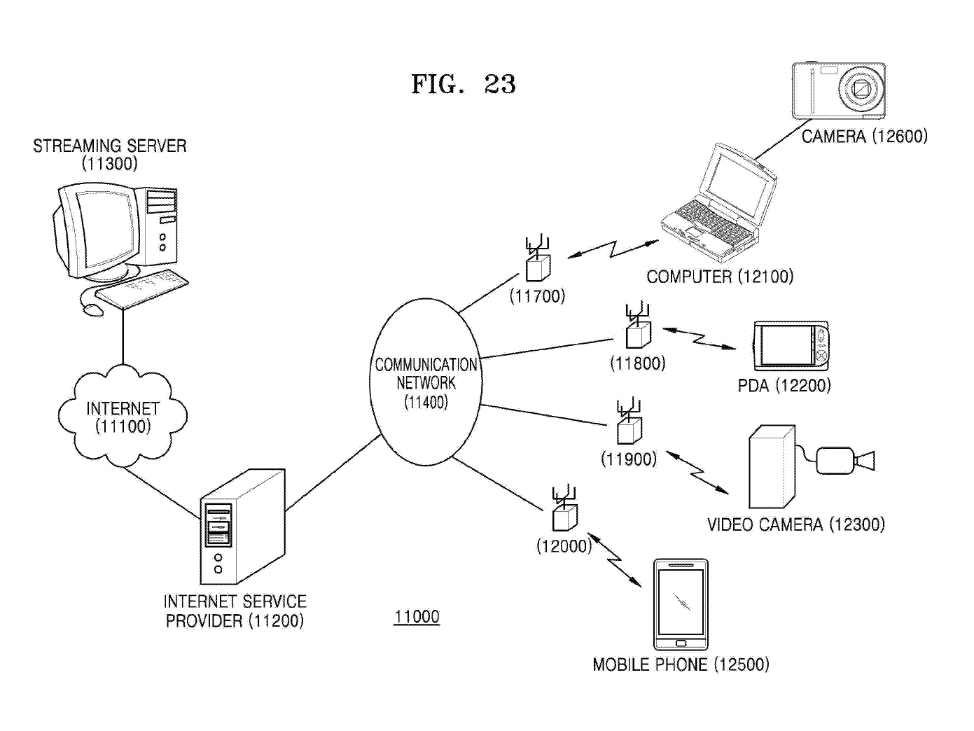

FIG. 23 is a diagram of an overall structure of a content supply system 11000 for providing a content distribution service. A service area of a communication system is divided into predetermined-sized cells, and wireless base stations 11700, 11800, 11900, and 12000 are installed in these cells, respectively.

The content supply system 11000 includes a plurality of independent devices. For example, the plurality of independent devices, such as a computer 12100, a personal digital assistant (PDA) 12200, a video camera 12300, and a mobile phone 12500, are connected to the Internet 11100 via an internet service provider 11200, a communication network 11400, and the wireless base stations 11700, 11800, 11900, and 12000.

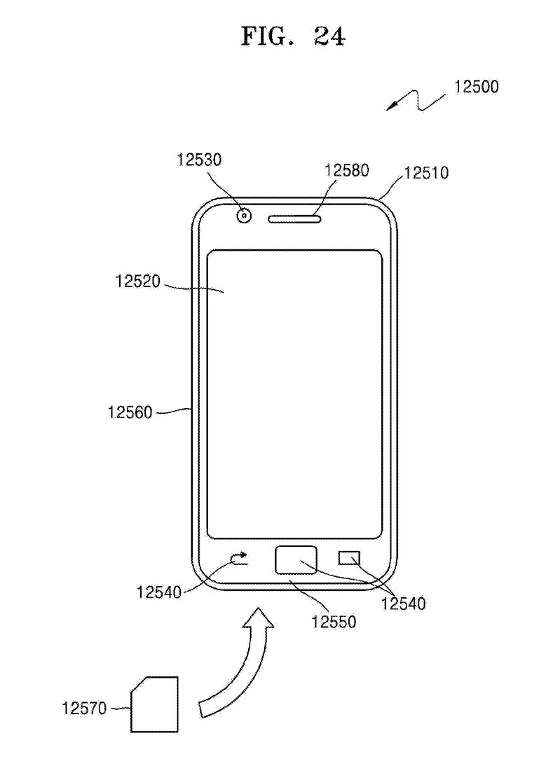

However, the content supply system 11000 is not limited to as illustrated in FIG. 24, and devices may be selectively connected thereto. The plurality of independent devices may be directly connected to the communication network 11400, not via the wireless base stations 11700, 11800, 11900, and 12000.

The video camera 12300 is an imaging device, e.g., a digital video camera, which is capable of capturing video images. The mobile phone 12500 may employ at least one communication method from among various protocols, e.g., Personal Digital Communications (PDC), Code Division Multiple Access (CDMA), Wideband-Code Division Multiple Access (W-CDMA), Global System for Mobile Communications (GSM), and Personal Handyphone System (PHS).

The video camera 12300 may be connected to a streaming server 11300 via the wireless base station 11900 and the communication network 11400. The streaming server 11300 allows content received from a user via the video camera 12300 to be streamed via a real-time broadcast. The content received from the video camera 12300 may be encoded using the video camera 12300 or the streaming server 11300. Video data captured by the video camera 12300 may be transmitted to the streaming server 11300 via the computer 12100.

Video data captured by a camera 12600 may also be transmitted to the streaming server 11300 via the computer 12100. The camera 12600 is an imaging device capable of capturing both still images and video images, similar to a digital camera. The video data captured by the camera 12600 may be encoded using the camera 12600 or the computer 12100. Software that performs encoding and decoding video may be stored in a computer-readable recording medium, e.g., a CD-ROM disc, a floppy disc, a hard disc drive, an SSD, or a memory card, which may be accessible by the computer 12100.

If video data is captured by a camera built in the mobile phone 12500, the video data may be received from the mobile phone 12500.

The video data may also be encoded by a large scale integrated circuit (LSI) system installed in the video camera 12300, the mobile phone 12500, or the camera 12600.

The content supply system 11000 may encode content data recorded by a user using the video camera 12300, the camera 12600, the mobile phone 12500, or another imaging device, e.g., content recorded during a concert, and transmit the encoded content data to the streaming server 11300. The streaming server 11300 may transmit the encoded content data in a type of a streaming content to other clients that request the content data.

The clients are devices capable of decoding the encoded content data, e.g., the computer 12100, the PDA 12200, the video camera 12300, or the mobile phone 12500. Thus, the content supply system 11000 allows the clients to receive and reproduce the encoded content data. Also, the content supply system 11000 allows the clients to receive the encoded content data and decode and reproduce the encoded content data in real time, thereby enabling personal broadcasting.

Encoding and decoding operations of the plurality of independent devices included in the content supply system 11000 may be similar to those of a video encoding apparatus and a video decoding apparatus of the present invention.

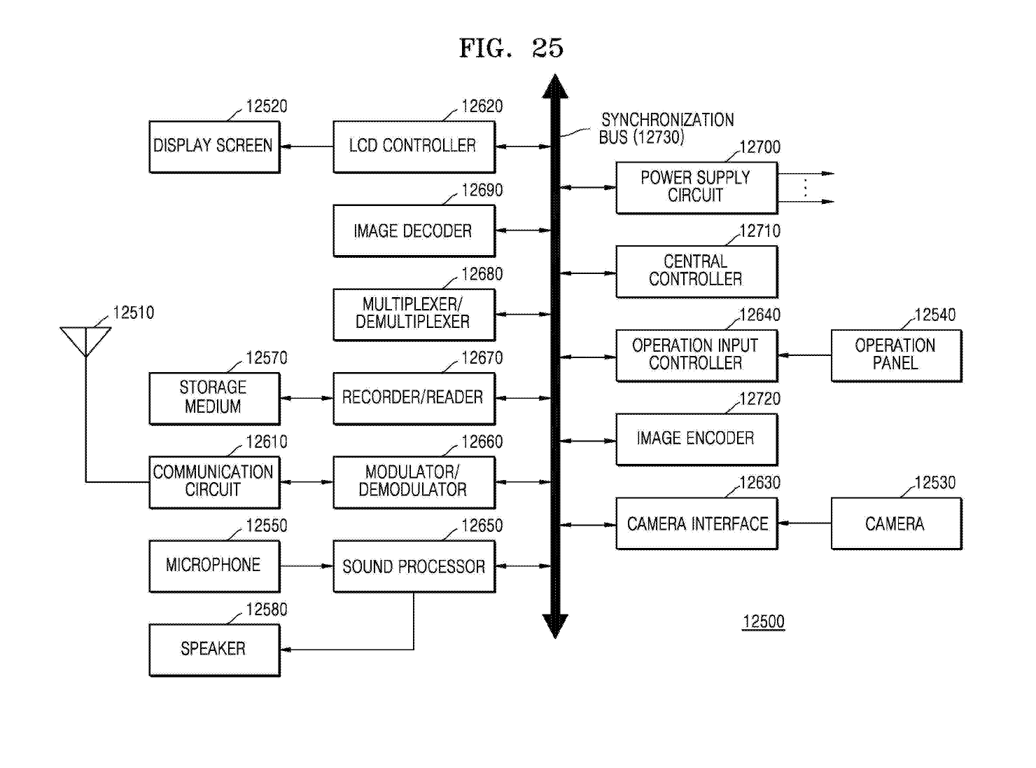

The mobile phone 12500 included in the content supply system 11000 according to an embodiment will now be described in greater detail with referring to FIGS. 24 and 25.

FIG. 24 illustrates an external structure of the mobile phone 12500 to which a video encoding method and a video decoding method are applied according to various embodiments. The mobile phone 12500 may be a smart phone, the functions of which are not limited and a large number of the functions of which may be changed or expanded.

The mobile phone 12500 includes an internal antenna 12510 via which a radio-frequency (RF) signal may be exchanged with the wireless base station 12000 of FIG. 21, and includes a display screen 12520 for displaying images captured by a camera 12530 or images that are received via the antenna 12510 and decoded, e.g., a liquid crystal display (LCD) or an organic light-emitting diode (OLED) screen. The mobile phone 12500 includes an operation panel 12540 including a control button and a touch panel. If the display screen 12520 is a touch screen, the operation panel 12540 further includes a touch sensing panel of the display screen 12520. The mobile phone 12500 includes a speaker 12580 for outputting voice and sound or another type of sound outputter, and a microphone 12550 for inputting voice and sound or another type sound inputter. The mobile phone 12500 further includes the camera 12530, such as a charge-coupled device (CCD) camera, to capture video and still images. The mobile phone 12500 may further include a storage medium 12570 for storing encoded/decoded data, e.g., video or still images captured by the camera 12530, received via email, or obtained according to various ways; and a slot 12560 via which the storage medium 12570 is loaded into the mobile phone 12500. The storage medium 12570 may be a flash memory, e.g., a secure digital (SD) card or an electrically erasable and programmable read only memory (EEPROM) included in a plastic case.

FIG. 25 illustrates an internal structure of the mobile phone 12500 according to an embodiment. To systemically control parts of the mobile phone 12500 including the display screen 12520 and the operation panel 12540, a power supply circuit 12700, an operation input controller 12640, an image encoder 12720, a camera interface 12630, an LCD controller 12620, an image decoder 12690, a multiplexer/demultiplexer 12680, a recorder/reader 12670, a modulator/demodulator 12660, and a sound processor 12650 are connected to a central controller 12710 via a synchronization bus 12730.

If a user operates a power button and sets from a ‘power off’ state to a ‘power on’ state, the power supply circuit 12700 supplies power to all the parts of the mobile phone 12500 from a battery pack, thereby setting the mobile phone 12500 in an operation mode.

The central controller 12710 includes a central processing unit (CPU), a ROM, and a RAM.

While the mobile phone 12500 transmits communication data to the outside, a digital signal is generated by the mobile phone 12500 under control of the central controller 12710. For example, the sound processor 12650 may generate a digital sound signal, the image encoder 12720 may generate a digital image signal, and text data of a message may be generated via the operation panel 12540 and the operation input controller 12640. When a digital signal is transmitted to the modulator/demodulator 12660 under control of the central controller 12710, the modulator/demodulator 12660 modulates a frequency band of the digital signal, and a communication circuit 12610 performs digital-to-analog conversion (DAC) and frequency conversion on the frequency band-modulated digital sound signal. A transmission signal output from the communication circuit 12610 may be transmitted to a voice communication base station or the wireless base station 12000 via the antenna 12510.

For example, when the mobile phone 12500 is in a conversation mode, a sound signal obtained via the microphone 12550 is transformed into a digital sound signal by the sound processor 12650, under control of the central controller 12710. The digital sound signal may be transformed into a transformation signal via the modulator/demodulator 12660 and the communication circuit 12610, and may be transmitted via the antenna 12510.

When a text message, e.g., email, is transmitted in a data communication mode, text data of the text message is input via the operation panel 12540 and is transmitted to the central controller 12710 via the operation input controller 12640. Under control of the central controller 12710, the text data is transformed into a transmission signal via the modulator/demodulator 12660 and the communication circuit 12610 and is transmitted to the wireless base station 12000 via the antenna 12510.

To transmit image data in the data communication mode, image data captured by the camera 12530 is provided to the image encoder 12720 via the camera interface 12630. The captured image data may be directly displayed on the display screen 12520 via the camera interface 12630 and the LCD controller 12620.

A structure of the image encoder 12720 may correspond to that of the above-described video encoding method of the present invention. The image encoder 12720 may transform the image data received from the camera 12530 into compressed and encoded image data based on the above-described video encoding method of the present invention, and then output the encoded image data to the multiplexer/demultiplexer 12680. During a recording operation of the camera 12530, a sound signal obtained by the microphone 12550 of the mobile phone 12500 may be transformed into digital sound data via the sound processor 12650, and the digital sound data may be transmitted to the multiplexer/demultiplexer 12680.

The multiplexer/demultiplexer 12680 multiplexes the encoded image data received from the image encoder 12720, together with the sound data received from the sound processor 12650. A result of multiplexing the data may be transformed into a transmission signal via the modulator/demodulator 12660 and the communication circuit 12610, and may then be transmitted via the antenna 12510.

While the mobile phone 12500 receives communication data from the outside, frequency recovery and ADC are performed on a signal received via the antenna 12510 to transform the signal into a digital signal. The modulator/demodulator 12660 modulates a frequency band of the digital signal. The frequency-band modulated digital signal is transmitted to the video decoding unit 12690, the sound processor 12650, or the LCD controller 12620, according to the type of the digital signal.

In the conversation mode, the mobile phone 12500 amplifies a signal received via the antenna 12510, and obtains a digital sound signal by performing frequency conversion and ADC on the amplified signal. A received digital sound signal is transformed into an analog sound signal via the modulator/demodulator 12660 and the sound processor 12650, and the analog sound signal is output via the speaker 12580, under control of the central controller 12710.

When in the data communication mode, data of a video file accessed at an Internet website is received, a signal received from the wireless base station 12000 via the antenna 12510 is output as multiplexed data via the modulator/demodulator 12660, and the multiplexed data is transmitted to the multiplexer/demultiplexer 12680.

To decode the multiplexed data received via the antenna 12510, the multiplexer/demultiplexer 12680 demultiplexes the multiplexed data into an encoded video data stream and an encoded audio data stream. Via the synchronization bus 12730, the encoded video data stream and the encoded audio data stream are provided to the video decoding unit 12690 and the sound processor 12650, respectively.

A structure of the image decoder 12690 may correspond to that of the above-described video decoding method of the present invention. The image decoder 12690 may decode the encoded video data to obtain reconstructed video data and provide the reconstructed video data to the display screen 12520 via the LCD controller 12620, by using the above-described video decoding method of the present invention.

Thus, the data of the video file accessed at the Internet website may be displayed on the display screen 12520. At the same time, the sound processor 12650 may transform audio data into an analog sound signal, and provide the analog sound signal to the speaker 12580. Thus, audio data contained in the video file accessed at the Internet website may also be reproduced via the speaker 12580.

The mobile phone 12500 or another type of communication terminal may be a transceiving terminal including both a video encoding apparatus and a video decoding apparatus according to an embodiment, may be a transceiving terminal including only the video encoding apparatus, or may be a transceiving terminal including only the video decoding apparatus.

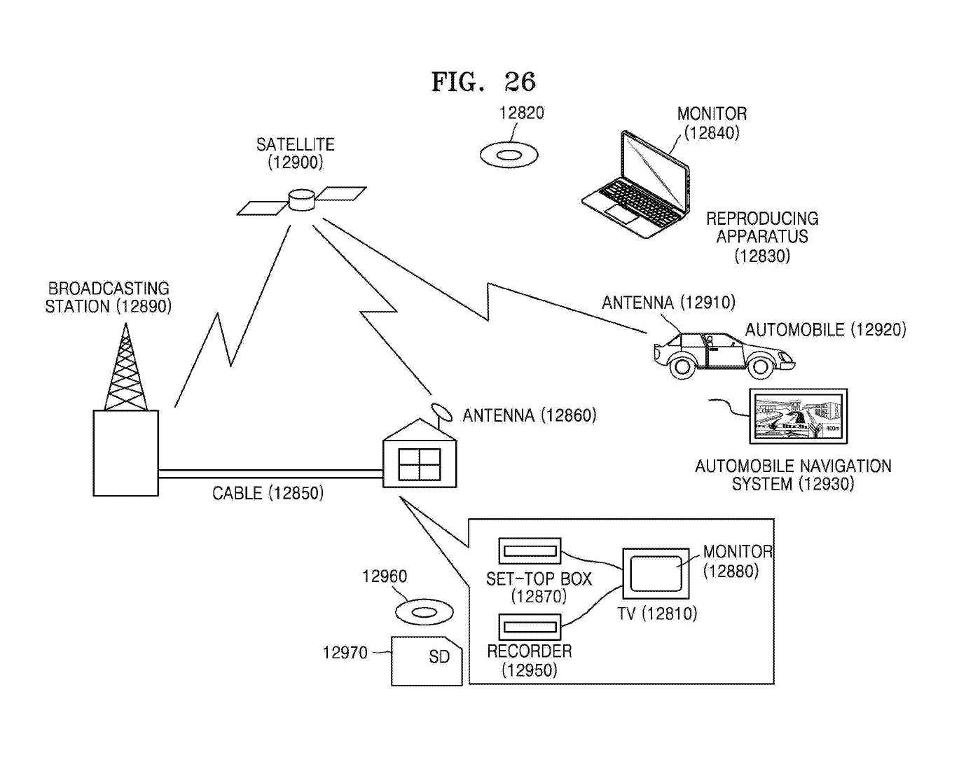

A communication system of the present invention is not limited to the communication system described above with reference to FIG. 24. For example, FIG. 26 illustrates a digital broadcasting system employing a communication system according to various embodiments. The digital broadcasting system according to an embodiment of FIG. 26 may receive a digital broadcast transmitted via a satellite or a terrestrial network by using a video encoding apparatus and a video decoding apparatus of the present invention.

Specifically, a broadcasting station 12890 transmits a video data stream to a communication satellite or a broadcasting satellite 12900 by using radio waves. The broadcasting satellite 12900 transmits a broadcast signal, and the broadcast signal is transmitted to a satellite broadcast receiver via a household antenna 12860. In every house, an encoded video stream may be decoded and reproduced by a TV receiver 12810, a set-top box 12870, or another device.

When a video decoding apparatus according to an embodiment is implemented in a reproducing apparatus 12830, the reproducing apparatus 12830 may parse and decode an encoded video stream recorded on a storage medium 12820, such as a disc or a memory card to reconstruct digital signals. Thus, the reconstructed video signal may be reproduced, for example, on a monitor 12840.

In the set-top box 12870 connected to the antenna 12860 for a satellite/terrestrial broadcast or a cable antenna 12850 for receiving a cable television (TV) broadcast, a video decoding apparatus according to an embodiment may be installed. Data output from the set-top box 12870 may also be reproduced on a TV monitor 12880.

As another example, a video decoding apparatus of the present invention may be installed in the TV receiver 12810 instead of the set-top box 12870.

An automobile 12920 that has an appropriate antenna 12910 may receive a signal transmitted from the satellite 12800 or the wireless base station 11700 of FIG. 21. A decoded video may be reproduced on a display screen of an automobile navigation system 12930 installed in the automobile 12920.

A video signal may be encoded by a video encoding apparatus of the present invention and may then be stored in a storage medium. Specifically, an image signal may be stored in a DVD disc 12960 by a DVD recorder or may be stored in a hard disc by a hard disc recorder 12950. As another example, the video signal may be stored in an SD card 12970. If the hard disc recorder 12950 includes a video decoding apparatus of the present invention according to an embodiment, a video signal recorded on the DVD disc 12960, the SD card 12970, or another storage medium may be reproduced on the TV monitor 12880.

The automobile navigation system 12930 may not include the camera 12530 of FIG. 32, and the camera interface 12630 and the image encoder 12720 of FIG. 26. For example, the computer 12100 and the TV receiver 12810 may not include the camera 12530, the camera interface 12630, and the image encoder 12720 of FIG. 26.

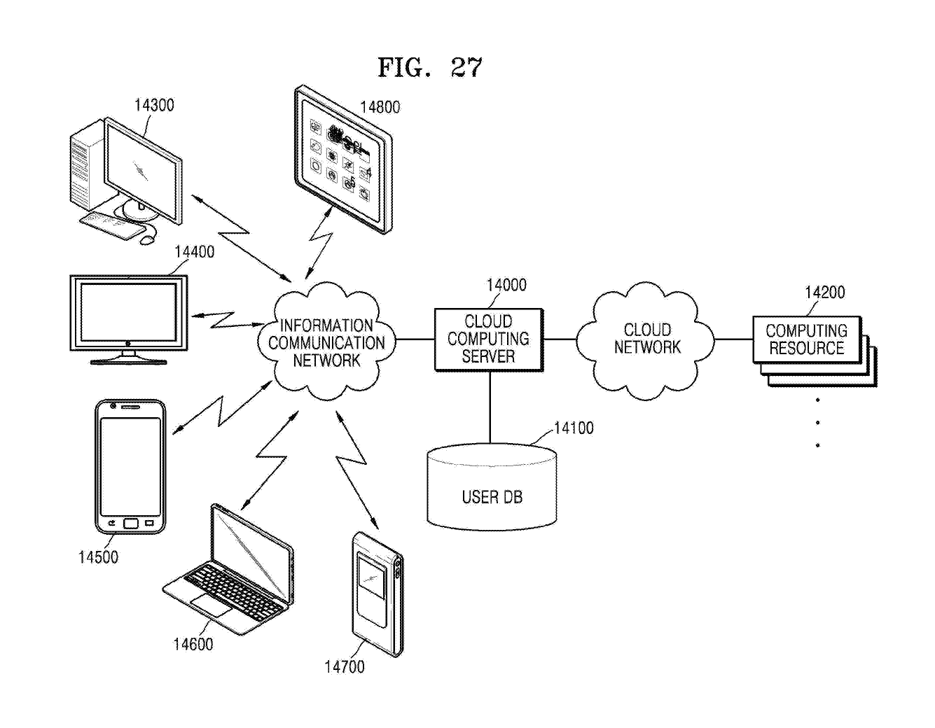

FIG. 27 is a diagram illustrating a network structure of a cloud computing system using a video encoding apparatus and a video decoding apparatus according to various embodiments.

The cloud computing system of the present invention may include a cloud computing server 14000, a user database (DB) 14100, a plurality of computing resources 14200, and a user terminal.

The cloud computing system provides an on-demand outsourcing service of the plurality of computing resources 14200 via a data communication network, e.g., the Internet, in response to a request from the user terminal. Under a cloud computing environment, a service provider provides users with desired services by combining computing resources at data centers located at physically different locations by using virtualization technology. A service user does not have to install computing resources, e.g., an application, a storage, an operating system (OS), and security, into his/her own terminal in order to use them, but may select and use desired services from among services in a virtual space generated through the virtualization technology, at a desired point in time.

A user terminal of a specified service user is connected to the cloud computing server 14000 via a data communication network including the Internet and a mobile telecommunication network. User terminals may be provided cloud computing services, and particularly video reproduction services, from the cloud computing server 14000. The user terminals may be various types of electronic devices capable of being connected to the Internet, e.g., a desktop PC 14300, a smart TV 14400, a smart phone 14500, a notebook computer 14600, a portable multimedia player (PMP) 14700, a tablet PC 14800, and the like.

The cloud computing server 14000 may combine the plurality of computing resources 14200 distributed in a cloud network and provide user terminals with a result of combining. The plurality of computing resources 14200 may include various data services, and may include data uploaded from user terminals. As described above, the cloud computing server 14000 may provide user terminals with desired services by combining video database distributed in different regions according to the virtualization technology.

User information about users who have subscribed for a cloud computing service is stored in the user DB 14100. The user information may include logging information, addresses, names, and personal credit information of the users. The user information may further include indexes of videos. Here, the indexes may include a list of videos that have already been reproduced, a list of videos that are being reproduced, a pausing point of a video that was being reproduced, and the like.

Information about a video stored in the user DB 14100 may be shared between user devices. For example, when a video service is provided to the notebook computer 14600 in response to a request from the notebook computer 14600, a reproduction history of the video service is stored in the user DB 14100. When a request to reproduce this video service is received from the smart phone 14500, the cloud computing server 14000 searches for and reproduces this video service, based on the user DB 14100. When the smart phone 14500 receives a video data stream from the cloud computing server 14000, a process of reproducing video by decoding the video data stream is similar to an operation of the mobile phone 12500 described above with reference to FIG. 24.

The cloud computing server 14000 may refer to a reproduction history of a desired video service, stored in the user DB 14100. For example, the cloud computing server 14000 receives a request to reproduce a video stored in the user DB 14100, from a user terminal. If this video was being reproduced, then a method of streaming this video, performed by the cloud computing server 14000, may vary according to the request from the user terminal, i.e., according to whether the video will be reproduced, starting from a start thereof or a pausing point thereof. For example, if the user terminal requests to reproduce the video, starting from the start thereof, the cloud computing server 14000 transmits streaming data of the video starting from a first frame thereof to the user terminal. If the user terminal requests to reproduce the video, starting from the pausing point thereof, the cloud computing server 14000 transmits streaming data of the video starting from a frame corresponding to the pausing point, to the user terminal.

In this case, the user terminal may include the above-described video decoding apparatus of the present invention. As another example, the user terminal may include the above-described video encoding apparatus of the present invention. Alternatively, the user terminal may include both the video decoding apparatus and the video encoding apparatus of the present invention as described above.

Various applications of the video encoding method, the video decoding method, the video encoding apparatus, and the video decoding apparatus have been described above with reference to FIGS. 21 through 27. However, the methods of storing the video encoding method and the video decoding method in a storage medium or the methods of implementing the video encoding apparatus and the video decoding apparatus in a device, according to various embodiments, are not limited to the embodiments described above with reference to FIGS. 21 through 27.

While this invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

1. A screen image encoding method comprising:
obtaining and storing one or more candidate blocks, which are spatially co-located with a current block, from images encoded prior to a current image;
determining whether a reference block used to encode the current block exists in the stored one or more candidate blocks; and
encoding at least one of index information indicating the reference block, prediction information used to encode the current block from the reference block, and information about the current block, based on a result of the determining.

2. The screen image encoding method of claim 1, wherein the encoding comprises, when a substitute candidate block that is the same as the current block exists in the stored one or more candidate blocks, omitting the encoding of the information about the current block and encoding index information indicating the substitute candidate block.

3. The screen image encoding method of claim 1, wherein the encoding comprises:
when the reference block used to encode the current block exists in the stored one or more candidate blocks,
encoding the index information indicating the reference block; and
encoding the prediction information used to decode the current block from the reference block.

4. The screen image encoding method of claim 1, wherein the encoding comprises,
when the reference block used to encode the current block does not exist in the stored one or more candidate blocks,
encoding the information about the current block.

5. The screen image encoding method of claim 1, wherein the determining whether the reference block exists comprises:
determining a candidate block representative value of each of the one or more candidate blocks based on a pixel value included in the candidate block;
determining a current block representative value of the current block based on a pixel value included in the current block; and
when a difference between the candidate block representative value and the current block representative value is equal to or less than a preset critical value, determining the candidate block as the reference block.

6. The screen image encoding method of claim 1, wherein the determining whether the reference block exists comprises:
obtaining a sum of absolute difference (SAD) between each of the one or more candidate blocks and the candidate block and the current block; and
determining a candidate block having a SAD that is equal to or less than a preset critical value as the reference block.

7. The screen image encoding method of claim 1, wherein the obtaining and storing of the one or more candidate blocks comprises storing the obtained one or more candidate blocks in a candidate block buffer,
wherein the screen image encoding method further comprises,
when a number of the candidate blocks stored in the candidate block buffer is equal to or greater than a preset number, deleting a candidate block determined by using a preset method from the candidate block buffer.

8. The screen image encoding method of claim 7, wherein the deleting of the candidate block determined by using the preset method from the candidate block buffer comprises,
when a number of the candidate blocks stored in the candidate block buffer is equal to or greater than a preset number, deleting a candidate block corresponding to a pre-determined index from the candidate block buffer.

9. A screen image decoding method comprising:
obtaining and storing one or more candidate blocks, which are spatially co-located with a current block, from images encoded prior to a current image;
receiving information about whether a reference block used to decode the current block exists in the stored one or more candidate blocks; and
decoding the current block by using at least one of index information indicating the reference block, prediction information used to decode the current block from the reference block, and information about the current block, based on the received information.

10. The screen image decoding method of claim 9, wherein the decoding comprises:
when a substitute candidate block that is capable of being replaced with the current block exists in the stored one or more candidate blocks, omitting the decoding of the information about the current block and decoding index information indicating the substitute the candidate block; and
decoding the current block by using the index information.

11. The screen image decoding method of claim 9, wherein the decoding comprises:
when the reference block used to decode the current block exists in the stored one or more candidate blocks,
decoding the index information indicating the reference block;
decoding the prediction information used to decode the current block from the reference block; and
decoding the current block by using the index information and the prediction information.

12. The screen image decoding method of claim 9, wherein the decoding comprises,
when the reference block used to decode the current block does not exist in the stored one or more candidate blocks,
obtaining the current block by decoding the information about the current block.

13. The screen image decoding method of claim 9, wherein the obtaining and storing of the one or more candidate blocks comprises storing the obtained one or more candidate blocks in a candidate block buffer,
wherein the screen image decoding method comprises,
when a number of the candidate blocks stored in the candidate block buffer is equal to or greater than a preset number, deleting a candidate block determined by using a preset method from the candidate block buffer.

14. An image encoding apparatus comprising:
a candidate block buffer configured to store one or more candidate blocks, which are spatially co-located with a current block, from images encoded prior to a current image; and
an encoder configured to determine whether a reference block used to encode the current block exists in the one or more candidate blocks and to encode at least one of index information indicating the reference block, prediction information used to encode the current block from the reference block, and information about the current block, based on a result of the determining.

15. An image decoding apparatus comprising:
a candidate block buffer configured to store one or more candidate blocks, which are spatially co-located with a current block, from images decoded prior to a current image; and
a decoder configured to receive information about whether a reference block used to decode the current block exists in the one or more candidate blocks, and to decode the current block by using at least one of index information indicating the reference block, prediction information used to decode the current block from the reference block, and information about the current block, based on the received information.
